(19) United States
(12) Patent Application Publication
(10) Pub. No.: US 2020/0184403 A1
(43) Pub. Date: Jun. 11, 2020

(54) ENGINEERED CRY6A INSECTICIDAL PROTEINS

(71) Applicant: DOW AGROSCIENCES LLC, INDIANAPOLIS, IN (US)

(72) Inventors: TIMOTHY D HEY, ZIONSVILLE, IN (US); XIAOPING XU, JINFENGQU (CN); TODD P GLANCY, FAIRMOUNT, IN (US); DIAA ALABED, CARMEL, IN (US); SARAH E WORDEN, FILLMORE, IN (US); XUELIN WANG, WESTFIELD, IN (US); CARLA AUSMUS, PASADENA, MD (US); SHAO-CHING HUNG, MIDLAND, MI (US)

(73) Assignee: DOW AGROSCIENCES LLC, INDIANAPOLIS, IN (US)

(21) Appl. No.: 16/799,496

(22) Filed: Feb. 24, 2020

Related U.S. Application Data
(63) Continuation of application No. 15/232,878, filed on Aug. 10, 2016, now abandoned.
(60) Provisional application No. 62/205,797, filed on Aug. 17, 2015.

(51) Int. Cl. G06Q 10/06

(52) U.S. Cl. CPC G06Q 10/06393

(57) ABSTRACT

Engineered and modified Cry6Aa insecticidal toxins, polynucleotides encoding such toxins, use of such toxins to control pests, and transgenic plants that produce such toxins are disclosed.

### CROSS-REFERENCE TO RELATED APPLICATIONS

This application claims priority from, and benefit of, U.S. Provisional Application 62/205,797 filed on Aug. 17, 2015. The entire contents of this application is hereby incorporated by reference into this application.

### REFERENCE TO SEQUENCE LISTING SUBMITTED ELECTRONICALLY

The official copy of the sequence listing is submitted electronically via EFS-Web as an ASCII formatted sequence listing with a file named “77095_DIG1000v2_ST25, created on Jul. 18, 2016, and having a size of 411 kilobytes, and is filed concurrently with the specification. The sequence listing contained in this ASCII formatted document is part of the specification, and is incorporated herein by reference in its entirety.

### TECHNICAL FIELD

The present invention relates generally to the field of molecular biology as applied to agricultural sciences. More particularly, certain embodiments concern methods for the use of DNA segments as diagnostic probes and templates for insecticidal protein expression. Methods of making and using the claimed nucleic acid segments in the development of plant incorporated protectants in transgenic plant cells and plants are disclosed.

### BACKGROUND OF THE DISCLOSURE

Insects and other pests cost farmers billions of dollars annually in crop losses and in the expense of controlling insect pests. The losses caused by pests in agricultural production environments include decrease in crop yield, reduced crop quality, and increased harvesting costs.

Coleopterans are a significant group of agricultural pests that cause extensive damage to crops each year. Examples of coleopteran pests include but are not limited to: Colorado potato beetle (CPB), corn rootworm, alfalfa weevil, boll weevil, and Japanese beetle. The Colorado potato beetle is an economically important pest that feeds on the leaves of potato, eggplant, tomato, pepper, tobacco, and other plants in the nightshade family. The Colorado potato beetle is a problematic defoliator of potatoes, in part, because it has developed resistance to many classes of insecticides.

The western corn rootworm (WCR), Diabrotica virgifera virgifera LeConte, is one of the most devastating coleopterans in North America and is a particular concern in corn-growing areas of the Midwestern United States. Approximately 9.3 million acres of U.S. corn are infested with corn rootworm species complex each year. The northern corn rootworm (NCR), Diabrotica barberi Smith and Lawrence, is a closely-related species that co-inhabits much of the same range as WCR. There are several other related subspecies of Diabrotica that are significant pests in the Americas: the Mexican corn rootworm (MCR), D. virgifera zeae Krysan and Smith; the southern corn rootworm (SCR), D. undecimpunctata howardi Barber; D. balteata LeConte; D. undecimpunctata tenella; D. speciosa Germar; and D. u. undecimpunctata Mannerheim. The United States Department of Agriculture has estimated that corn rootworms cause $1 billion in lost revenue each year, including 800 million in yield loss and 200 million in treatment costs.

Both WCR and NCR eggs are deposited in the soil during the summer. The insects remain in the egg stage throughout the winter. The larvae hatch in late May or early June and begin to feed on corn roots. Corn rootworms go through three larval instars. After feeding for several weeks, the larvae molt into the pupal stage. They pupate in the soil, and then emerge from the soil as adults in July and August.

Most of the rootworm damage in corn is caused by larval feeding. Newly hatched rootworms initially feed on fine corn root hairs and burrow into root tips. As the larvae grow larger, they feed on and burrow into primary roots. When corn rootworms are abundant, larval feeding often results in the pruning of roots all the way to the base of the corn stalk. Severe root injury interferes with the roots' ability to transport water and nutrients into the plant, reduces plant growth, and results in reduced grain production, thereby often drastically reducing overall yield. Severe root injury also often results in lodging of corn plants, which makes harvest more difficult and further decreases yield. Furthermore, feeding by adults on the corn reproductive tissues can result in pruning of silks at the ear tip. If this “silk clipping” is severe enough during pollen shed, pollination may be disrupted. In addition, members of the genus Diabrotica attack cucurbit crops (cucumbers, melons, squash, etc.) and many vegetable and field crops in commercial production as well as those being grown in home gardens.

Control of corn rootworms has been attempted by crop rotation, chemical insecticides, biopesticides such as the spore-forming gram-positive bacterium, Bacillus thuringiensis (B.t.), transgenic plants that express B.t. toxins, and a combination thereof. Crop rotation suffers from the disadvantage of placing unwanted restrictions upon the use of farmland. Moreover, oviposition of some rootworm species may occur in soybean fields, thereby compromising the effectiveness of crop rotation practiced with corn and soybean.

Chemical insecticides are the most heavily relied upon strategy for achieving corn rootworm control. Chemical insecticide use is an imperfect corn rootworm control strategy; high populations of larvae, heavy rains, and improper application of the insecticide(s) may all result in inadequate corn rootworm control. Furthermore, the continual use of insecticides may select for insecticide-resistant rootworm strains, as well as raise significant environmental concerns due to their toxicity to non-target species.

Damage to plants caused by nematodes is also a prevalent and serious economic problem. Nematodes cause wide-spread and serious damage in many plant species. Many genera of nematodes are known to cause such damage. Plant-parasitic nematodes include members of the Phylum Nematoda, Orders Tylenchida and Dorylaimide. In the Order Tylenchida, the plant-parasitic nematodes are found in two Super Families: Tylenchoidea and Criconematoidea. There are more than 100,000 described species of nematodes.

Chemical pesticides have provided an effective method of pest control; however, the public has become concerned about the amount of residual chemicals that might be found in food, ground water, and the environment. Stringent new restrictions on the use of chemical pesticides and the elimination of some effective pesticides from the marketplace could limit economical and effective options for controlling costly pests. Thus, there is an urgent need to identify new pest control agents and compositions.

Regular use of chemical pesticides for the control of unwanted insect pests can select for chemical resistant strains. Chemical resistance occurs in many species of economically important insects and has also occurred in nematodes of sheep, goats, and horses. For example, an accepted methodology for control of nematodes has centered around the drug benzimidazole and its congeners. The use of these drugs on a wide scale has led to many instances of resistance among nematode populations (Prichard, R. K. et al). The development of pesticide resistance necessitates a continuing search for new control agents having different modes of action.

At the present time there is a need to have more effective means to control the many coleopterans and nematodes that cause considerable damage to susceptible hosts and crops. Advantageously, such effective means would employ highly selective biological toxins. Several B.t. Cry proteins have been shown to be nematicidal, these include Cry5B, Cry6A, Cry14A and Cry21A (Wei et al., 2003; Aroian and Li (2010).

B.t. is a soil-borne bacterium that produces pesticidal crystal proteins known as delta endotoxins or Cry proteins. Cry proteins are oral intoxicants that function by acting on midgut cells of susceptible insects. Some Cry toxins have been shown to have activity against nematodes. An extensive list of delta endotoxins is maintained and regularly updated at the Bacillus thuringiensis Toxin Nomenclature web site maintained by Neil Crickmore. (See http://www.lifesci.sussex.ac.uk/home/Neil_Crickmore/Bt/toxins2.html and Crickmore et al. 1998, page 808). Cry toxins, including members of the Cry1B, Cry1I, Cry2A, Cry3, Cry7A, Cry8, Cry9D, Cry14, Cry18, Cry22, Cry23, Cry34, Cry35, Cry36, Cry37, Cry43, Cry55, Cyt1A, and Cyt2C (Frankenhuyzen, 2009) families have insecticidal activity against coleopteran insects.

Some B.t. toxins which are active against corn rootworm and other coleopterans are now known. Cry6Aa has reported activity against coleopteran and nematode pests (U.S. Pat. Nos. 5,186,934; 6,632,792 B2; U.S. Pat. No. 2011/0225681; U.S. Pat. No. 2011/0239334 A1; and Wei et al., 2003). For example, U.S. Pat. No. 4,849,217 discloses various isolates, including PS52A1 and PS86A1, as having activity against alfalfa weevils. U.S. Pat. No. 5,208,017 discloses PS86A1 as a having activity against Western corn rootworm. U.S. Pat. Nos. 5,427,786 and 5,186,934 each disclose B.t. isolates and toxins active against coleopterans. Specifically disclosed in these patents is the isolate known as PS86A1 and a coleopteran-active toxin obtainable therefrom known as 86A1. Toxin 86A1 is now also known as Cry6A (CryVIA). The wild-type Cry6Aa toxin is about 54.1 kDa. A Cry6B toxin is also known. This toxin can be obtained from the PS69D1 isolate. Cry6Aa is recognized as a new mode of action against western corn rootworm, complementing Cry3Aa and Cry34Ab1/Cry35Ab1 (Li et al, 2013) making it a pyramid partner in an integrated insect resistance management program (U.S. Pat. No. 2013/0167269 A1 and US 2013/0263331 A1).

The full length Cry6A and Cry6B toxins are known to have activity against nematodes. The PS69D1 isolate has been reported to have activity against nematodes (U.S. Pat. Nos. 4,948,734; 5,093,120; 5,262,399; and 5,439,881). A generic formula for the amino acid sequence of CryVI toxins has been disclosed in WO 92/19739, which also teaches that the full length toxin has activity against nematodes. The PS52A1 and PS69D1 isolates are disclosed therein. U.S. Pat. Nos. 5,262,159 and 5,468,636 also disclose a generic formula for toxins having activity against aphids.

Cry6A toxin is known to inhibit the growth of certain coleopterans and can be activated by enzymatically cleaving to yield an amino terminal core toxin that is lethal to coleopterans, such as the western corn rootworm (U.S. Pat. No. 6,831,062 B2). In addition, truncated Cry6A is active against nematodes. U.S. Pat. No. 6,831,062 describes Cry6A truncated holotoxins and fusion proteins and fusion genes. Thompson et al disclosed the insecticidally active peptide fragments identified as being residues 12-390 and 12-443 depending on the cleavage site. The large fragment, from approximately residues 12-390 or 12-443 resulting from trypsin, or other proteolytic digestion, are called the core fragments or toxins. The trypsin treatment of Cry6Aa, produced from recombinant B.t., increased activity against WCR (U.S. Pat. Nos. 5,874,288; 6,831,062 B2; and 6,303,364 B1).

Although production of the currently-deployed Cry proteins in transgenic plants can provide robust protection against the aforementioned pests, thereby protecting grain yield, adult pests have emerged in artificial infestation trials, indicating less than complete larval insect control. Additionally, development of resistant insect populations threatens the long-term durability of Cry proteins in insect pest control. Coleopteran insects have developed resistance in the field to Cry proteins (Gassman et al. PLoS ONE July 2011 | Volume 6 | Issue 7 | e22629). Insect resistance to B.t. Cry proteins can develop through several mechanisms (Heckel et al., 2007; Pigott and Ellar, 2007). Multiple receptor protein classes for Cry proteins have been identified within insects, and multiple examples exist within each receptor class. Resistance to a particular Cry protein may develop, for example, by means of a mutation within the toxin-binding portion of a cadherin domain of a receptor protein. A further means of resistance may be mediated through a protoxin-processing protease.

While native Cry6Aa naturally expressed in B.t. strains has shown good efficacy against WCR and certain nematodes, its use as an effective plant incorporated protectant has not been demonstrated due to its susceptibility to proteolysis when expressed in plant cells. Therefore, engineering Cry6A toxins to be more resistant to proteolysis when expressed in plant cells would be highly desirable for use in recombinant plants, especially corn, as a plant-incorporated protectant.

### BRIEF SUMMARY OF THE DISCLOSURE

The present invention includes engineered Cry6A based insecticidal protein toxins, including variants and analogs that in part, were designed to limit loss of an important carboxy terminal peptide (CTP). Other embodiments of the invention include nucleic acids encoding the claimed insecticidal toxins, methods of controlling pests using the toxins expressed from the claimed nucleic acid sequences, methods of producing the toxins in transgenic host cells, and transgenic plant seeds comprising such nucleic acids, and plants that express the toxins.

Modified Cry6Aa insecticidal proteins of the invention comprise modifications chosen from the group consisting of a modified proteolysis-susceptible region (residues 390-451 of SEQ ID NO:1), increased affinity of the CTP for the core protein, and addition of sub-cellular transit peptides. A preferred group of Cry6Aa variant insecticidal proteins is SEQ ID NO:35, SEQ ID NO:37, SEQ ID NO:39, SEQ ID NO:41, SEQ ID NO:43, SEQ ID NO:45, SEQ ID NO:47, SEQ ID NO:49, SEQ ID NO:64, SEQ ID NO:66, SEQ ID NO:68, SEQ ID NO:70, SEQ ID NO:72, SEQ ID NO:74, SEQ ID NO:76, SEQ ID NO:78, SEQ ID NO:80, SEQ ID NO:82, SEQ ID NO:84, SEQ ID NO:86, SEQ ID NO:88, SEQ ID NO:90, SEQ ID NO:92, SEQ ID NO:94, SEQ ID NO:96, SEQ ID NO:98, SEQ ID NO:100, SEQ ID NO:102, SEQ ID NO:104, SEQ ID NO:106, SEQ ID NO:108, SEQ ID NO:110, SEQ ID NO:112, SEQ ID NO:114, SEQ ID NO:116, SEQ ID NO:118, SEQ ID NO:120, SEQ ID NO:132, SEQ ID NO:136, SEQ ID NO:138, and SEQ ID NO:140. A more preferred group of variants is SEQ ID NO:110, SEQ ID NO:112, SEQ ID NO:114, SEQ ID NO:116, SEQ ID NO:118, SEQ ID NO:120, SEQ ID NO:128, SEQ ID NO:132, and SEQ ID NO:144. A more highly preferred group of variants is SEQ ID NO:110, SEQ ID NO:116, SEQ ID NO:118, SEQ ID NO:120, SEQ ID NO:132. An even more preferred group of variants is SEQ ID NO:116, SEQ ID NO:118, SEQ ID NO:120. And the most preferred variant is SEQ ID NO:116.

A preferred group of nucleic acid sequences that encode Cry6Aa variant insecticidal proteins is SEQ ID NO:34, SEQ ID NO:36, SEQ ID NO:38, SEQ ID NO:40, SEQ ID NO:42, SEQ ID NO:44, SEQ ID NO:46, SEQ ID NO:48, SEQ ID NO:63, SEQ ID NO:65, SEQ ID NO:67, SEQ ID NO:69, SEQ ID NO:71, SEQ ID NO:73, SEQ ID NO:75, SEQ ID NO:77, SEQ ID NO:79, SEQ ID NO:81, SEQ ID NO:83, SEQ ID NO:85, SEQ ID NO:87, SEQ ID NO:89, SEQ ID NO:91, SEQ ID NO:93, SEQ ID NO:95, SEQ ID NO:97, SEQ ID NO:99, SEQ ID NO:101, SEQ ID NO:103, SEQ ID NO:105, SEQ ID NO:107, SEQ ID NO:109, SEQ ID NO:111, SEQ ID NO:113, SEQ ID NO:115, SEQ ID NO:117, SEQ ID NO:119, SEQ ID NO:131, SEQ ID NO:135, SEQ ID NO:137, SEQ ID NO:139, SEQ ID NO:141, SEQ ID NO:142, and SEQ ID NO:143. A more preferred group of nucleic acids is SEQ ID NO:109, SEQ ID NO:111, SEQ ID NO:113, SEQ ID NO:115, SEQ ID NO:117, SEQ ID NO:119, SEQ ID NO:127, and SEQ ID NO:131. A more highly preferred group of nucleic acids is SEQ ID NO:109, SEQ ID NO:115, SEQ ID NO:117, SEQ ID NO:119, SEQ ID NO:131, and 139. An even more preferred group of nucleic acids is SEQ ID NO:115, SEQ ID NO:117, SEQ ID NO:119, and SEQ ID NO:139. And the most preferred nucleic acid is SEQ ID NO:115.

In another embodiment the invention provides a plant comprising an engineered Cry6Aa insecticidal polypeptide disclosed herein.

In another embodiment the invention provides a method for controlling plant pest populations and damage to plants by delivering an insecticidally effective amount of an insecticidal protein of the invention in a plant tissue such that an insect pest ingests the insecticidal protein.

In another embodiment the invention provides an isolated nucleic acid that encodes an engineered Cry6Aa insecticidal polypeptide disclosed herein.

In another embodiment the invention provides DNA constructs comprising a nucleotide sequence that encodes an engineered Cry6Aa insecticidal polypeptide operably linked to a promoter that is capable of driving expression in a plant and other regulatory sequences that stabilize messenger RNA. The promoter may be heterologous or native to B.t.

The invention also provides transgenic plants that comprise the DNA construct stably incorporated into its genome and a method for protecting a plant from a pest comprising introducing the construct into said plant.

### BRIEF DESCRIPTION OF THE FIGURES

FIG. 1 is a schematic diagram of DIG-177 (Cry6Aa) samples 1-4 tested as described in Example 3. The diagram shows samples following trypsin digestion with and without disulfide bond reduction.

FIG. 2 is a ribbon 3D structure model of trypsin treated DIG-177 (Cry6Aa) (left) representing residues 12-125, 128-387 and 445-472 of SEQ ID NO:2. FIG. 2 (right), is a ribbon model of residues 12-472 of SEQ ID NO:2, residues missing from the trypsin treated structure (left) have been modeled. The carboxy terminal peptide in both structures is shown in black.

FIG. 3 is a depiction of the structural model comparison of residues 12-472 (left; as from FIG. 2) and the variant DIG-1000 (right). The carboxy terminal peptide (CTP) is shown in black on the left; the CTP and engineered linker are shown in black in DIG-1000 (right).

FIG. 4 shows the SDS-PAGE analysis of DIG-177 and DIG-1000 treated with proteinase K under the conditions described in Example 10. FL refers to untreated, undigested full-length protein; 0-50 are incubation times in minutes.

FIG. 5 is a Western blot maize transient expression analysis of Cry6Aa proteins. Antisera used was specific for DIG-177, Cry6Aa. The protein encoded by the bombarded plasmid DNA is noted: Lane 1, Fluorescent Rainbow Marker (GE Healthcare, Pittsburgh, Pa.); Lane 2, non bombarded embryo control; Lane 3, DIG-177 with TraP8; Lane 4, DIG-177; Lane 5 DIG-1000; Lane 6, DIG-1000 with TraP8; Lane 7, PAT (negative control); Lane 8, YFP (negative control) Lane 9, DIG-177 standard at 0.5 ng/lane; Lane 10, DIG-1000 standard at 1 ng/lane.

FIG. 6 shows the results of the T₁ maize leaf expression Western blot experiments.

### BRIEF DESCRIPTION OF THE SEQUENCES

SEQ ID NO:1 is a DNA sequence comprising full length DIG-177 (Cry6Aa).

SEQ ID NO:2 is the deduced DIG-177 protein sequence.

SEQ ID NO:3 Maize codon optimized version of DIG-177, also known as IRDIG.522.28; encoding the protein identified as SEQ ID NO:2.

SEQ ID NO:4 Maize codon bias version of DIG-177 with an encoded mitochondrial transit peptide, also known as IRDIG.552.60.

SEQ ID NO:5 The polypeptide encoded by SEQ ID NO:4

SEQ ID NO:6 Maize codon optimized version of DIG-177 with an encoded mitochondrial transit peptide; also known as IRDIG.552.61

SEQ ID NO:7 The polypeptide encoded by SEQ ID NO:6

SEQ ID NO:8 Maize codon optimized version of DIG-177 with an encoded combination mitochondrial and chloroplast transit peptide; also known as IRDIG.552.62

SEQ ID NO:9 The polypeptide encoded by SEQ ID NO:8

SEQ ID NO:10 Maize codon optimized version of DIG-177 with an encoded peroxisome transit peptide; also known as IRDIG.552.63

SEQ ID NO:11 The polypeptide encoded by SEQ ID NO:10

SEQ ID NO:12 Maize codon optimized version of DIG-177 with an encoded peroxisome transit peptide; also known as IRDIG.552.64

SEQ ID NO:13 The polypeptide encoded by SEQ ID NO:12

SEQ ID NO:14 Maize codon optimized version of DIG-177 with an encoded peroxisome transit peptide; also known as IRDIG.552.65

SEQ ID NO:15 The polypeptide encoded by SEQ ID NO:14

SEQ ID NO:16 Maize codon optimized version of DIG-177 with an encoded vacuole transit peptide; also known as IRDIG.552.66

SEQ ID NO:17 The polypeptide encoded by SEQ ID NO:16

SEQ ID NO:18 Maize codon optimized version of DIG-177 with an encoded vacuole transit peptide; also known as IRDIG.552.67

SEQ ID NO:19 The polypeptide encoded by SEQ ID NO:18

SEQ ID NO:20 Maize codon optimized version of DIG-177 with an encoded vacuole transit peptide; also known as IRDIG.552.68

SEQ ID NO:21 The polypeptide encoded by SEQ ID NO:20

SEQ ID NO:22 Maize codon optimized version of DIG-177 with an encoded apoplast transit peptide; also known as IRDIG.552.69

SEQ ID NO:23 The polypeptide encoded by SEQ ID NO:22

SEQ ID NO:24 Maize codon optimized version of DIG-177 with an encoded endoplasmic reticulum transit peptides; also known as IRDIG.552.70

SEQ ID NO:25 The polypeptide encoded by SEQ ID NO:24

SEQ ID NO:26 Maize codon optimized version of DIG-177 with an encoded nuclear transit peptide; also known as IRDIG.552.71

SEQ ID NO:27 The polypeptide encoded by SEQ ID NO:26

SEQ ID NO:28 Maize codon optimized version of DIG-177 with an encoded nuclear transit peptide; also known as IRDIG.552.72

SEQ ID NO:29 The polypeptide encoded by SEQ ID NO:28

SEQ ID NO:30 Maize codon optimized version of DIG-177 with an encoded chloroplast transit peptide; also known as IRDIG.552.73

SEQ ID NO:31 The polypeptide encoded by SEQ ID NO:30

SEQ ID NO:32 Maize codon optimized version of DIG-177 with an encoded chloroplast transit peptide; also known as IRDIG.552.74

SEQ ID NO:33 The polypeptide encoded by SEQ ID NO:32

SEQ ID NO:34 DIG-177 coding sequence, encoding the mutation C88>A, also known as DIG-614

SEQ ID NO:35 The polypeptide encoded by SEQ ID NO:34

SEQ ID NO:36 DIG-177 coding sequence, encoding the mutation C88>S, also known as DIG-615

SEQ ID NO:37 The polypeptide encoded by SEQ ID NO:36

SEQ ID NO:38 DIG-177 coding sequence, encoding the mutation C162>A, also known as DIG-616

SEQ ID NO:39 The polypeptide encoded by SEQ ID NO:38

SEQ ID NO:40 DIG-177 coding sequence, encoding the mutation C162>S, also known as DIG-617

SEQ ID NO:41 The polypeptide encoded by SEQ ID NO:40

SEQ ID NO:42 DIG-177 coding sequence, encoding the mutation C451>A, also known as DIG-618

SEQ ID NO:43 The polypeptide encoded by SEQ ID NO:42

SEQ ID NO:44 DIG-177 coding sequence, encoding the mutation C451>S, also known as DIG-619

SEQ ID NO:45 The polypeptide encoded by SEQ ID NO:44

SEQ ID NO:46 DIG-177 coding sequence, encoding the mutations C88>S and C451>S, also known as DIG-983

SEQ ID NO:47 the polypeptide encoded by SEQ ID NO:46

SEQ ID NO:48 DIG-177 coding sequence, encoding the mutations C88>A and C451>A, also known as DIG-984

SEQ ID NO:49 The polypeptide encoded by SEQ ID NO:48

SEQ ID NO:50 LF (Large Fragment); amino acids 12-390 of SEQ ID NO:2

SEQ ID NO:51 CTP 1 (Carboxy terminal peptide 1), amino acids 444-475 of SEQ ID NO:2

SEQ ID NO:52 CTP 2 (Carboxy terminal peptide 2), amino acids or 451-475 of SEQ ID NO:2

SEQ ID NO:53 Encodes a protein of residues 1-443 SEQ ID NO 2, also known as DIG-137

SEQ ID NO:54 The polypeptide encoded by SEQ ID NO:53

SEQ ID NO:55 Encodes a protein of residues 1-432 of SEQ ID NO:2, also known as DIG-138.

SEQ ID NO:56 The polypeptide encoded by SEQ ID NO:55

SEQ ID NO:57 Encodes a protein of residues 1-423 of SEQ ID NO:2, also known as DIG-147

SEQ ID NO:58 The polypeptide encoded by SEQ ID NO:57

SEQ ID NO:59 Encodes a protein of residues 1-400 of SEQ ID NO:2, also known as DIG-148

SEQ ID NO:60 The polypeptide encoded by SEQ ID NO:59

SEQ ID NO:61 Encodes a protein of residues 1-390 of SEQ ID NO:2, also known as DIG-149

SEQ ID NO:62 The polypeptide encoded by SEQ ID NO:61

SEQ ID NO:63 Encodes a protein deleted for amino acid residues 391-395 of SEQ ID NO:2, known as DIG-921

SEQ ID NO:64 The polypeptide encoded by SEQ ID NO:63

SEQ ID NO:65 Encodes a protein deleted for amino acid residues 396-400 of SEQ ID NO:2, known as DIG-922

SEQ ID NO:66 The polypeptide encoded by SEQ ID NO:65

SEQ ID NO:67 Encodes a protein deleted for amino acid residues 401-405 of SEQ ID NO:2, known as DIG-923

SEQ ID NO:68 The polypeptide encoded by SEQ ID NO:67

SEQ ID NO:69 Encodes a protein deleted for amino acid residues 406-410 of SEQ ID NO:2, known as DIG-924

SEQ ID NO:70 The polypeptide encoded by SEQ ID NO:69

SEQ ID NO:71 Encodes a protein deleted for amino acid residues 406-410 of SEQ ID NO:2, known as DIG-925

SEQ ID NO:72 The polypeptide encoded by SEQ ID NO:71

SEQ ID NO:73 Encodes a protein deleted for amino acid residues 416-420 of SEQ ID NO:2, known as DIG-926

SEQ ID NO:74 The polypeptide encoded by SEQ ID NO: 73

SEQ ID NO:75 Encodes a protein deleted for amino acid residues 421-425 of SEQ ID NO:2, known as DIG-927

SEQ ID NO:76 The polypeptide encoded by SEQ ID NO: 75

SEQ ID NO:77 Encodes a protein deleted for amino acid residues 441-445 of SEQ ID NO:2, known as DIG-931

SEQ ID NO:78 The polypeptide encoded by SEQ ID NO: 77

SEQ ID NO:79 Encodes a protein deleted for amino acid residues 391-400 of SEQ ID NO:2, known as DIG-969

SEQ ID NO:80 The polypeptide encoded by SEQ ID NO: 79

SEQ ID NO:81 Encodes a protein deleted for amino acid residues 401-410 of SEQ ID NO:2, known as DIG-970

SEQ ID NO:82 The polypeptide encoded by SEQ ID NO: 81

SEQ ID NO:83 Encodes a protein deleted for amino acid residues 411-420 of SEQ ID NO:2, known as DIG-971

SEQ ID NO:84 The polypeptide encoded by SEQ ID NO: 83

SEQ ID NO:85 Encodes a protein deleted for amino acid residues 421-430 of SEQ ID NO:2, known as DIG-972

SEQ ID NO:86 The polypeptide encoded by SEQ ID NO: 85

SEQ ID NO:87 Encodes a protein deleted for amino acid residues 431-440 of SEQ ID NO:2, known as DIG-973

SEQ ID NO:88 The polypeptide encoded by SEQ ID NO: 87

SEQ ID NO:89 Encodes a protein deleted for amino acid residues 391-405 of SEQ ID NO:2, known as DIG-985

SEQ ID NO:90 The polypeptide encoded by SEQ ID NO: 89

SEQ ID NO:91 Encodes a protein deleted for amino acid residues 406-420 of SEQ ID NO:2, known as DIG-986

SEQ ID NO:92 The polypeptide encoded by SEQ ID NO: 91

SEQ ID NO:93 Encodes a protein deleted for amino acid residues 421-435 of SEQ ID NO:2, known as DIG-987

SEQ ID NO:94 The polypeptide encoded by SEQ ID NO:93

SEQ ID NO:95 Encodes a protein deleted for amino acid residues 429-443 of SEQ ID NO:2, known as DIG-988

SEQ ID NO:96 The polypeptide encoded by SEQ ID NO:95

SEQ ID NO:97 Encodes a protein deleted for amino acid residues 391-410 of SEQ ID NO:2, known as DIG-989

SEQ ID NO:98 The polypeptide encoded by SEQ ID NO:97

SEQ ID NO:99 Encodes a protein deleted for amino acid residues 411-430 of SEQ ID NO:2, known as DIG-990

SEQ ID NO:100 The polypeptide encoded by SEQ ID NO:99

SEQ ID NO:101 Encodes a protein deleted for amino acid residues 424-443 of SEQ ID NO:2, known as DIG-991

SEQ ID NO:102 The polypeptide encoded by SEQ ID NO:101

SEQ ID NO:103 Encodes a protein deleted for amino acid residues 391-415 of SEQ ID NO:2, known as DIG-992

SEQ ID NO:104 The polypeptide encoded by SEQ ID NO:103

SEQ ID NO:105 Encodes a protein deleted for amino acid residues 415-440 of SEQ ID NO:2, known as DIG-993

SEQ ID NO:106 The polypeptide encoded by SEQ ID NO:105

SEQ ID NO:107 Encodes a protein deleted for amino acid residues 419-443 of SEQ ID NO:2, known as DIG-994

SEQ ID NO:108 The polypeptide encoded by SEQ ID NO:107

SEQ ID NO:109 Encodes a protein deleted for amino acid residues 401-443 of SEQ ID NO:2, known as DIG-995

SEQ ID NO:110 The polypeptide encoded by SEQ ID NO:109

SEQ ID NO:111 Encodes a protein deleted for amino acid residues 391-433 of SEQ ID NO:2, known as DIG-996

SEQ ID NO:112 The polypeptide encoded by SEQ ID NO:111

SEQ ID NO:113 Encodes a protein deleted for amino acid residues 391-414 and 425-443 of SEQ ID NO:2, known as DIG-997

SEQ ID NO:114 The polypeptide encoded by SEQ ID NO:113

SEQ ID NO:115 Encodes a DIG-177 variant with a peptide linker replacement for a protease susceptible segment, also known as DIG-1000.

SEQ ID NO:116 The polypeptide encoded by SEQ ID NO:115

SEQ ID NO:117 Encodes a DIG-177 variant with a peptide linker replacement for a protease susceptible segment, also known as DIG-1049

SEQ ID NO:118 The polypeptide encoded by SEQ ID NO:117

SEQ ID NO:119 Encodes a DIG-177 variant with a peptide linker replacement for a protease susceptible segment, also known as DIG-1052

SEQ ID NO:120 The polypeptide encoded by SEQ ID NO:119

SEQ ID NO:121 Encodes a DIG-177 variant with a peptide linker replacement for a protease susceptible segment, also known as DIG-1038

SEQ ID NO:122 The polypeptide encoded by SEQ ID NO:121

SEQ ID NO:123 Encodes a DIG-177 variant with a peptide linker replacement for a protease susceptible segment, also known as DIG-1055

SEQ ID NO:124 The polypeptide encoded by SEQ ID NO:123

SEQ ID NO:125 Encodes a DIG-177 variant with a peptide linker replacement for a protease susceptible segment, also known as DIG-1039

SEQ ID NO:126 The polypeptide encoded by SEQ ID NO:125

SEQ ID NO:127 Encodes a DIG-177 variant with a peptide linker replacement for a protease susceptible segment, also known as DIG-1056

SEQ ID NO:128 The polypeptide encoded by SEQ ID NO:127

SEQ ID NO:129 Encodes a DIG-177 variant with a peptide linker replacement for a protease susceptible segment, also known as DIG-1040

SEQ ID NO:130 The polypeptide encoded by SEQ ID NO:129

SEQ ID NO:131 Encodes a DIG-177 variant with a peptide linker replacement for a protease susceptible segment, also known as DIG-1057

SEQ ID NO:132 The polypeptide encoded by SEQ ID NO:131

SEQ ID NO:133 Encodes a DIG-177 variant with a peptide linker replacement for a protease susceptible segment, also known as DIG-1041

SEQ ID NO:134 The polypeptide encoded by SEQ ID NO:133

SEQ ID NO:135 Encodes a DIG-177 variant with a peptide linker replacement for a protease susceptible segment, also known as DIG-1058

SEQ ID NO:136 The polypeptide encoded by SEQ ID NO:135

SEQ ID NO:137 Maize codon bias version of DIG-1000.

SEQ ID NO:138 The polypeptide encoded by SEQ ID NO:137

SEQ ID NO:139 Maize codon bias version of DIG-1000 with a chloroplast transit peptide

SEQ ID NO:140 The polypeptide encoded by SEQ ID NO:139

SEQ ID NO:141 Maize codon bias version DIG-1036.

SEQ ID NO:142 Highest GC+ERLS maize highest GC version of DIG-1036 with ER Localization Sequence

SEQ ID NO:143 Highest GC+VLS maize highest GC version of DIG-1036 with Vacuole Localization Sequence

SEQ ID NO:144 The polypeptide encoded by DIG-1036 (DIG-1000 minus glycosylation sites: N69>Q; N144>Q; N403>Q; N409>Q)

### DETAILED DESCRIPTION OF THE DISCLOSURE

The present invention is a result of protein engineering studies designed to discover the source and target sites of proteolytic damage to Cry6A toxins produced in plant cells. High-resolution analyses, including determination of the Cry6Aa trypsin-digested crystal structure, have been completed. This work disclosed several surprising molecular details related to how Cry6Aa insecticidal proteins function.

Of these discoveries, it was determined that Cry6Aa belongs to the alpha helical hemolysin family of proteins based on structural identity; other members of this group include HlyE and BLB-B (Eifler et al., 2006; Tzokov et al., 2006; Wallace, et al., 2000; Mueller, et al., 2009; Madegowda et al., 2008).

Two disulfide bonds, between cysteine residues 88 and 451, and between cysteines 402-404 were identified. Most surprisingly, these disulfide bonds were not required for insecticidal activity of full-length Cry6Aa in artificial diet-based WCR bioassays.

A third discovery is related to the insecticidal activity of the trypsin treated toxin. A carboxy terminal peptide (CTP), consisting of either residues 444-475 or 451-475, was found to be disulfide bonded to the core toxin fragment and was found to be required for activity. The small size of the CTP and the labile nature of the disulfide bond likely accounted for it not being identified previously (U.S. Pat. Nos. 5,874,288; 6,831,062; 6,303,364).

The utility of Cry6Aa as a robust transgenic trait in plants (plant incorporated protectant), especially for protection against WCR, is dependent on the intracellular accumulation of active insecticidal protein. Proteolytic cleavage between residues 390-451, in a reducing environment such as in a plant cell, is believed to cause dissociation of the carboxy terminal peptide leading to loss of insecticidal activity.

Several means of preventing the loss of insecticidal activity of plant-expressed Cry6Aa toxins form the basis of this invention. Such means are comprised of either reducing proteolysis in the susceptible region, e.g. the region between residues approximately 390-451, of the subject toxins or minimizing dissolution of the necessary CTP and may be used individually or in combination. They are as follows:
1. Redesign the primary amino acid structure of the susceptible region such that it is not recognized by proteases including shortening the susceptible region to make it less susceptible to proteases.
2. Redirect the expressed Cry6Aa toxin to a sub-cellular or extracellular compartment where it is not accessible to proteases.
3. Down regulate or inhibit proteases in the cellular environment where the subject toxins accumulate.
4. Maintain the association of the CTP to the core protein by redirecting the expressed Cry6Aa to the endoplasmic reticulum, to allow the core-CTP disulfide bond to remain intact. Under such circumstances, the Cry6Aa protein retains insecticidal activity following proteolysis.
5. Increase the affinity between the core protein and CTP, in the event proteolysis occurs, through protein engineering. Such methods are well known in the art of protein engineering and include engineering hydrogen bonds between the core and CTP polypeptides. Another way is to engineer in salt bridges between the non-covalently linked peptides. A third means is to engineer hydrophobic interactions between the CTP and core protein. A fourth method is to engineer new or the existing disulfide bonds such that they are less susceptible to reduction.

By “isolated” applicants mean that the nucleotide or polypeptide molecules have been removed from their native environment and have been placed in a different environment by the hand of man. Thus, isolated nucleotide and polypeptide molecules include DNA or protein molecules that have been purified, concentrated, or otherwise rendered substantially free of Bacillus thuringiensis cellular material. Embodiments of isolated engineered Cry6Aa insecticidal polypeptide or nucleotide molecules can have less than about 30%, less than about 20%, less than about 10%, less than about 9%, less than about 8%, less than about 7%, less than about 6%, less than about 5%, less than about 4%, less than about 3% or less than about 2%, or less than about 1% (by dry weight) of contaminating protein (e.g., from Bacillus thuringiensis). When the isolated engineered Cry6Aa insecticidal polypeptide or nucleotide embodiments is recombinantly produced, then the culture medium material, chemical precursors, and/or non-engineered Cry6Aa insecticidal polypeptide or nucleotide represent less than about 30%, less than about 20%, less than about 10%, less than about 5%, less than about 4%, less than about 3% or less than about 2%, or less than about 1% (by dry weight) of the isolated engineered Cry6Aa insecticidal polypeptide or nucleotide.

Cry6Aa and variants are potential pyramid partners for Cry34Ab1/Cry35Ab and other corn rootworm insecticidal agents due to its potency and unique sequence and structural identity. In addition, it does not compete for binding sites on WCR brush boarder membrane vesicles with Cry34Ab1/Cry35Ab1 or Cry3Aa (Li et al, 2013). Transgenic plants expressing Cry6Aa in the cytosol have not been efficacious; analysis shows that the protein is susceptible to proteolytic processing and possible inactivation as similar to that noted in Example 3. One strategy to limit proteolysis is to direct the recombinant protein to sub cellular compartments (reviewed by Benchabane, 2008) as describe in Example 1. Another strategy to limit proteolysis and possible inactivation is through protein engineering.

Engineered Cry6Aa Insecticidal Toxins.

The invention encompasses insecticidally active engineered Cry6Aa variants thereof. By the term “variant,” applicants intend to include fragments, certain deletion and insertion mutants, substitution and certain fusion or chimeric proteins.

The invention includes DIG-177 insecticidal protein variants having a toxin segment that is 90%, 91%, 92%, 93, 94%, 95%, 96%, 97%, 98%, or 99% identical to amino acids 1 to 475 of SEQ ID NO:2. Variants may be made by making random mutations or the variants may be designed. In the case of designed mutants, there is a high probability of generating variants with similar activity to the native toxin when amino acid identity is maintained in critical regions of the toxin which account for biological activity or are involved in the determination of three-dimensional configuration which ultimately is responsible for the biological activity. A high probability of retaining activity will also occur if substitutions are conservative. Amino acids may be placed in the following classes: non-polar, uncharged polar, basic, and acidic. Conservative substitutions whereby an amino acid of one class is replaced with another amino acid of the same type are least likely to materially alter the biological activity of the variant. Table 1 provides a listing of examples of amino acids belonging to each class.

TABLE 1
Biochemical classes of amino acids

| Class of Amino Acid | Examples of Amino Acids |
|---|---|
| Nonpolar Side Chains | Ala, Val, Leu, Ile, Pro, Met, Phe, Trp |
| Uncharged Polar Side Chains | Gly, Ser, Thr, Cys, Tyr, Asn, Gln |
| Acidic Side Chains | Asp, Glu |
| Basic Side Chains | Lys, Arg, His |
| Beta-branched Side Chains | Thr, Val, Ile |
| Aromatic Side Chains | Tyr, Phe, Trp, His |

In some instances, non-conservative substitutions can also be made. The critical factor is that these substitutions must not significantly detract from the biological activity of the toxin. Variants include polypeptides that differ in amino acid sequence due to mutagenesis. Variant proteins encompassed by the present invention are biologically active, that is they continue to possess the desired biological activity of the native protein, that is, retaining pesticidal activity.

Variant proteins can also be designed that differ at the sequence level but that retain the same or similar overall essential three-dimensional structure, surface charge distribution, and the like. See, for example, U.S. Pat. No. 7,058,515; Larson et al. (2002); Stemmer (1994a, 1994b, 1995) and Crameri et al. (1996a, 1996b, 1997). U.S. Pat. No. 8,513,492 B2.

Nucleic Acids.

Isolated nucleic acids and complements thereof encoding engineered Cry6Aa insecticidal toxins are one aspect of the present invention. The term “isolated” is defined herein above. Because of the redundancy of the genetic code, a variety of different DNA sequences can encode the amino acid sequences disclosed herein. It is well within the skill of a person trained in the art to create these alternative DNA sequences encoding the same, or essentially the same, insecticidal proteins.

Gene Synthesis.

Genes encoding the engineered Cry6Aa insecticidal proteins described herein can be made by a variety of methods well-known in the art. For example, synthetic gene segments and synthetic genes can be made by phosphite tri-ester and phosphoramidite chemistry (Caruthers et al., 1987), and commercial vendors are available to perform gene synthesis on demand. Full-length genes can be assembled in a variety of ways including, for example, by ligation of restriction fragments or polymerase chain reaction assembly of overlapping oligonucleotides (Stewart and Burgin, 2005). Further, terminal gene deletions and additions can be made by PCR amplification using site-specific terminal oligonucleotides.

Nucleic acids encoding engineered Cry6Aa insecticidal proteins can be made for example, by synthetic construction by methods currently practiced by any of several commercial suppliers. (e.g. U.S. Pat. No. 7,482,119). These genes, or portions or variants thereof, may also be constructed synthetically, for example, by use of a gene synthesizer and the design methods of, for example, U.S. Pat. No. 5,380,831. Alternatively, variations of synthetic or naturally occurring genes may be readily constructed using standard molecular biological techniques for making point mutations, additions, and/or deletions. Fragments of these genes can also be made using commercially available exonucleases or endonucleases according to standard procedures. For example, enzymes such as Bal31 or site-directed mutagenesis can be used to systematically cut off nucleotides from the ends of these genes. Also, gene fragments which encode active toxin fragments may be obtained using a variety of restriction enzymes.

Given the amino acid sequence for an engineered Cry6Aa insecticidal protein, a coding sequence can be designed by reverse translating the coding sequence using synonymous codons preferred by the intended host, and then refining the sequence using alternative synonymous codons to remove sequences that might cause problems in transcription, translation, or mRNA stability. Further, synonymous codons may be employed to introduce stop codons in the non-engineered Cry6Aa reading frames (i.e. reading frames 2, 3, 4, 5 and 6) to eliminate spurious long open reading frames.

Quantifying Polypeptide or Nucleic Acid Sequence Identity.

The percent identity of two amino acid sequences or of two nucleic acid sequences is determined by first aligning the sequences for optimal comparison purposes. The percent identity between the two sequences is a function of the number of identical positions shared by the sequences (i.e. percent identity=number of identical positions/total number of positions (e.g. overlapping positions)×100). In one embodiment, the two sequences are the same length. The percent identity between two sequences can be determined using techniques similar to those described below, with or without allowing gaps. In calculating percent identity, typically exact matches are counted.

The determination of percent identity between two sequences can be accomplished using a mathematical algorithm. A nonlimiting example of such an algorithm is that of Altschul et al. (1990), and Karlin and Altschul (1990), modified as in Karlin and Altschul (1993), and incorporated into the BLASTN and BLASTX programs. BLAST searches may be conveniently used to identify sequences homologous (similar) to a query sequence in nucleic or protein databases. BLASTN searches can be performed, (score=100, word length=12) to identify nucleotide sequences having homology to claimed nucleic acid molecules of the invention. BLASTX searches can be performed (score=50, word length=3) to identify amino acid sequences having homology to claimed insecticidal protein molecules of the invention.

Gapped BLAST (Altschul et al., 1997) can be utilized to obtain gapped alignments for comparison purposes. Alternatively, PSI-Blast can be used to perform an iterated search that detects distant relationships between molecules (Altschul et al., 1997). When utilizing BLAST, Gapped BLAST, and PSI-Blast programs, the default parameters of the respective programs can be used. See, www.ncbi.nlm.nih.gov.

A non-limiting example of a mathematical algorithm utilized for the comparison of sequences is the ClustalW algorithm (Thompson et al., 1994). ClustalW compares sequences and aligns the entirety of the amino acid or DNA sequence, and thus can provide data about the sequence conservation of the entire amino acid sequence or nucleotide sequence. The ClustalW algorithm is used in several commercially available DNA/amino acid analysis software packages, such as the ALIGNX module of the Vector NTI Program Suite (Invitrogen, Inc., Carlsbad, Calif.). When aligning amino acid sequences with ALIGNX, one may conveniently use the default settings with a Gap open penalty of 10, a Gap extend penalty of 0.1 and the blosum63mt2 comparison matrix to assess the percent amino acid similarity (consensus) or identity between the two sequences. When aligning DNA sequences with ALIGNX, one may conveniently use the default settings with a Gap open penalty of 15, a Gap extend penalty of 6.6 and the swgapdnamt comparison matrix to assess the percent identity between the two sequences.

Another non-limiting example of a mathematical algorithm utilized for the comparison of sequences is that of Myers and Miller (1988). Such an algorithm is incorporated into the wSTRETCHER program, which is part of the wEMBOSS sequence alignment software package (available at http://emboss.sourceforge.net/). wSTRETCHER calculates an optimal global alignment of two sequences using a modification of the classic dynamic programming algorithm which uses linear space. The substitution matrix, gap insertion penalty and gap extension penalties used to calculate the alignment may be specified. When utilizing the wSTRETCHER program for comparing nucleotide sequences, a Gap open penalty of 16 and a Gap extend penalty of 4 can be used with the scoring matrix file EDNAFULL. When used for comparing amino acid sequences, a Gap open penalty of 12 and a Gap extend penalty of 2 can be used with the EBLOSUM62 scoring matrix file.

A further non-limiting example of a mathematical algorithm utilized for the comparison of sequences is that of Needleman and Wunsch (1970), which is incorporated in the sequence alignment software packages GAP Version 10 and wNEEDLE (http://emboss.sourceforge.net/). GAP Version 10 may be used to determine sequence identity or similarity using the following parameters: for a nucleotide sequence, % identity and % similarity are found using GAP Weight of 50 and Length Weight of 3, and the nwsgapdna. cmp scoring matrix. For amino acid sequence comparison, % identity or % similarity are determined using GAP weight of 8 and length weight of 2, and the BLOSUM62 scoring program.

wNEEDLE reads two input sequences, finds the optimum alignment (including gaps) along their entire length, and writes their optimal global sequence alignment to file. The algorithm explores all possible alignments and chooses the best, using a scoring matrix that contains values for every possible residue or nucleotide match. wNEEDLE finds the alignment with the maximum possible score, where the score of an alignment is equal to the sum of the matches taken from the scoring matrix, minus penalties arising from opening and extending gaps in the aligned sequences. The substitution matrix and gap opening and extension penalties are user-specified. When amino acid sequences are compared, a default Gap open penalty of 10, a Gap extend penalty of 0.5, and the EBLOSUM62 comparison matrix are used. When DNA sequences are compared using wNEEDLE, a Gap open penalty of 10, a Gap extend penalty of 0.5, and the EDNAFULL comparison matrix are used.

Equivalent programs may also be used. By “equivalent program” is intended any sequence comparison program that, for any two sequences in question, generates an alignment having identical nucleotide or amino acid residue matches and an identical percent sequence identity when compared to the corresponding alignment generated by ALIGNX, wNEEDLE, or wSTRETCHER. The % identity is the percentage of identical matches between the two sequences over the reported aligned region (including any gaps in the length) and the % similarity is the percentage of matches between the two sequences over the reported aligned region (including any gaps in the length).

Alignment may also be performed manually by inspection.

Recombinant Hosts.

The insecticidal protein-encoding genes of the subject invention can be introduced into a wide variety of microbial, fungal, or plant hosts. Expression of the insecticidal protein gene results, directly or indirectly, in the intracellular production and maintenance of the pesticidal protein. With suitable microbial hosts, e.g. Pseudomonas, the microbes can be applied to the environment of the pest, where they will proliferate and be ingested. The result is control of the pest. Alternatively, the microbe hosting the pesticidal protein gene can be treated under conditions that prolong the activity of the protein and stabilize the recombinant host cell. The treated cell, which comprises a treated insecticidal polypeptide of the invention that retains the insecticidal activity, can be applied to the environment of the target pest to control for the pest.

Where the B.t. insecticidal protein gene is introduced via a suitable DNA construct, e.g., a vector, into a microbial host, and said host is applied to the environment in a living state, it is essential that certain host microbes be used. Microorganism hosts are selected which are known to occupy the “phytosphere” (phylloplane, phyllosphere, rhizosphere, and/or rhizoplane) of one or more crops of interest. These microorganisms are selected so as to be capable of successfully competing in the particular environment (crop and other insect habitats) with the wild-type indigenous microorganisms, provide for stable maintenance and expression of the gene expressing the polypeptide pesticide, and, desirably, provide for improved protection of the pesticide from environmental degradation and inactivation.

A large number of microorganisms are known to inhabit the phylloplane (the surface of the plant leaves) and/or the rhizosphere (the soil surrounding plant roots) of a wide variety of important crops. These microorganisms include bacteria, algae, and fungi. Of particular interest are microorganisms such as bacteria, e.g. genera Pseudomonas, Erwinia, Serratia, Klebsiella, Xanthomonas, Streptomyces, Rhizobium, Sinorhizobium, Rhodopseudomonas, Methylophilius, Agrobacterium, Acetobacter, Lactobacillus, Arthrobacter, Azotobacter, Leuconostoc, and Alcaligenes. Of particular interest are such phytosphere bacterial species as Pseudomonas syringae, Pseudomonas fluorescens, Serratia marcescens, Acetobacter xylinum, Agrobacterium tumefaciens, Agrobacterium radiobacter, Rhodopseudomonas spheroides, Xanthomonas campestris, Sinorhizobium meliloti (formerly Rhizobium meliloti), Alcaligenes eutrophus, and Azotobacter vinelandii. Of further interest are fungi, particularly yeast, e.g. genera Saccharomyces, Cryptococcus, Kluyveromyces, Sporobolomyces, Rhodotorula, and Aureobasidium, and of particular interest are phytosphere yeast species such as Rhodotorula rubra, R. glutinis, R. marina, R. aurantiaca, Cryptococcus albidus, C. diffluens, C. laurentii, Saccharomyces rosei, S. pretoriensis, S. cerevisiae, Sporobolomyces roseus, S. odorus, Kluyveromyces veronae, and Aureobasidium pollulans. Of particular interest are the pigmented microorganisms.

Isolated Toxin Polypeptides and Compositions of the Invention.

The engineered Cry6Aa insecticidal toxin polypeptides of the invention can be treated or prepared, for example, to make a formulated pesticide composition. Examples of formulated pesticide compositions include protein composition, sprayable protein composition, a bait matrix, or other delivery systems. In one example, B.t. cells or recombinant host cells expressing an engineered Cry6Aa insecticidal protein of the invention are cultured using standard art media and fermentation techniques. Upon completion of the fermentation cycle, the B.t. spores or other recombinant host cells and/or insecticidal protein crystals from the fermentation broth can be isolated by methods known in the art. B.t. spores or recombinant host cells also can be treated prior to being applied or formulated for application to plants. For example, isolated B.t. spores and/or toxin crystals can be chemically treated to prolong insecticidal activity and thereby include a treated polypeptide of the invention. Methods of growing B.t. pesticidal polypeptides in recombinant hosts and then treating the B.t. to prolong pesticidal activity are known and have been published. See, e.g., U.S. Pat. Nos. 4,695,462, and 4,695,455 and Gaertner et al., 1993.

The isolated or treated engineered Cry6Aa insecticidal protein of the invention can be formulated into compositions of finely-divided particulate solids granules, pellets, wettable powders, dusts, aqueous suspensions or dispersions, emulsions, spray, liquid concentrate, or other insecticide formulations. These insecticide formulations are made by combining an engineered Cry6Aa insecticide polypeptide herein with adjuvants, diluents, surfactants, dispersants, inert carriers and other components to facilitate handling and application to control one or more target pests. Such formulation ingredients are known in the art, as are methods of application and methods of determining levels of the B.t. spores and/or isolated engineered Cry6Aa polypeptide crystals that provide desired insecticidal activity.

Methods for Controlling Insect Pests.

When an insect ingests an effective amount of engineered Cry6Aa insecticidal protein disclosed herein, which is delivered via an insecticide composition (e.g., a formulated protein composition (s), sprayable protein composition(s), a bait matrix, transgenic plant expression, or another delivery system), the results are typically death of the insect, or the insects do not feed upon the source which makes the pesticidal protein available to the insects. The term “delivered” or “delivering” herein is meant to include any method of placing or providing on or in plant tissue an insecticidally effective amount of the protein toxin. This includes expressing an insecticidal protein in the cells of the plant, or applying an effective amount to any surface of the plant.

The subject protein insect toxins can be “applied” or provided to contact the target insects in a variety of ways. For example, the engineered Cry6Aa insecticidal protein of the invention can be applied after being formulated with adjuvants, diluents, carriers, etc. to provide compositions in the form of finely-divided particulate solids, granules, pellets, wettable powders, dusts, aqueous suspensions or dispersions, and emulsions. Alternatively, the engineered Cry6Aa insecticidal polypeptide can be delivered by transgenic plants (wherein the protein is produced by and present in the plant) and are well-known in the art. Expression of the toxin genes can also be achieved selectively in specific tissues of the plants, such as the roots, leaves, etc. This can be accomplished via the use of tissue-specific promoters, for example. Spray-on applications are another example and are also known in the art. The subject proteins can be appropriately formulated for the desired end use, and then sprayed (or otherwise applied) onto the plant and/or around the plant/to the vicinity of the plant to be protected—before an infestation is discovered, after target insects are discovered, both before and after, and the like. Bait granules, for example, can also be used and are known in the art.

Transgenic Plants.

The engineered Cry6Aa insecticidal proteins disclosed herein can be used to protect practically any type of plant from damage by an insect pest. Examples of such plants include potato, eggplant, tomato, pepper, tobacco, and other plants in the nightshade family. Other examples of such plants include maize, sunflower, soybean, cotton, canola, rice, sorghum, wheat, barley, vegetables, ornamentals, peppers (including hot peppers), sugar beets, fruit, and turf, to name but a few. Methods for transforming plants are well known in the art, and illustrative transformation methods are described in the Examples.

A preferred embodiment of the subject invention is genetically transformed plants with genes encoding engineered Cry6Aa insecticidal proteins and variants. The transformed plants are resistant to attack by an insect target pest by virtue of the presence of controlling amounts of the subject insecticidal proteins or variants in the cells of the transformed plant. By incorporating functional genetic material that encodes an insecticidal protein of the invention, the adult or larvae die after consuming the plant tissue containing the claimed toxins. Numerous members of the monocotyledonous and dicotyledonous classifications have been transformed. Transgenic agronomic crops as well as fruits and vegetables are of commercial interest. Such crops include but are not limited to maize, rice, soybeans, canola, sunflower, alfalfa, sorghum, wheat, cotton, peanuts, tomatoes, potatoes, and the like. A more preferred group of crops is maize, soybeans, and cotton. The most preferred crop is maize.

Several techniques exist for introducing foreign genetic material into plant cells, and for obtaining plants that stably maintain and express the introduced gene. Such techniques include acceleration of genetic material coated onto microparticles directly into cells (U.S. Pat. Nos. 4,945,050 and 5,141,131). Plants may be transformed using Agrobacterium technology, see U.S. Pat. No. 5,177,010, European Patent No. EP131624B1, European Patent No. EP159418B1, European Patent No. EP176112B1, U.S. Pat. No. 5,149,645, EP120516B1, U.S. Pat. Nos. 5,464,763, 4,693,976, European Patent No. EP116718B1, European Patent No. EP290799B1, European Patent No. EP320500B1, European Patent No. EP604662B1, U.S. Pat. Nos. 7,060,876, 6,037,526, 6,376,234, European Patent No. EP292435B1, U.S. Pat. Nos. 5,231,019, 5,463,174, 4,762,785, 5,608,142, and 5,159,135. Other transformation technology includes WHISKERS™ technology, see U.S. Pat. Nos. 5,302,523 and 5,464,765. Electroporation technology has also been used to transform plants, see WO1987006614, U.S. Pat. Nos. 5,472,869, 5,384,253, WO199209696, U.S. Pat. No. 6,074,877, WO1993021335, and U.S. Pat. No. 5,679,558. In addition to numerous technologies for transforming plants, the type of tissue which is contacted with the foreign genes may vary as well. Such tissue would include but would not be limited to embryogenic tissue, callus tissue type I and type II, hypocotyl, meristem, and the like. Almost all plant tissues may be transformed during dedifferentiation using appropriate techniques within the skill of an artisan.

Genes encoding engineered Cry6Aa insecticidal proteins can be inserted into plant cells using a variety of techniques which are well known in the art as disclosed above. For example, a large number of cloning vectors comprising a marker that permits selection of the transformed microbial cells and a replication system functional in Escherichia coli are available for preparation and modification of foreign genes for insertion into higher plants. Such manipulations may include, for example, the insertion of mutations, truncations, additions, or substitutions as desired for the intended use. The vectors comprise, for example, pBR322, pUC series, M13mp series, pACYC184, etc. Accordingly, the sequence encoding the protein toxins or variants of the invention can be inserted into the vector at a suitable restriction site. The resulting plasmid is used for transformation of E. coli, the cells of which are cultivated in a suitable nutrient medium, then harvested and lysed so that workable quantities of the plasmid are recovered. Sequence analysis, restriction fragment analysis, electrophoresis, and other biochemical-molecular biological methods are generally carried out as methods of analysis. After each manipulation, the DNA sequence used can be cleaved and joined to the next DNA sequence. Each manipulated DNA sequence can be cloned in the same or other plasmids.

The use of T-DNA-containing vectors for the transformation of plant cells has been intensively researched and sufficiently described in European Patent No. EP120516B1; Lee and Gelvin (2008), Fraley et al. (1986), and An et al. (1985), and is well established in the field.

Once the inserted DNA has been integrated into the plant genome, it is relatively stable throughout subsequent generations. The vector used to transform the plant cell normally contains a selectable marker gene encoding a protein that confers on the transformed plant cells tolerance to a herbicide or resistance to an antibiotic, such as phosphinothricin Bialaphos, Kanamycin, Neomycin, G418, Bleomycin, Hygromycin, or a gene which codes for tolerance to glyphosate, methotrexate, imidazolinones, sulfonylureas and triazolopyrimidine herbicides, such as chlorosulfuron, bromoxynil, dalapon and the like. Of further interest are genes conferring tolerance to herbicides such as haloxyfop, quizalofop, diclofop, and the like, as exemplified by AAD genes (US Patent Application No. 20090093366). The individually employed selectable marker gene should accordingly permit the selection of transformed cells while the growth of cells that do not contain the inserted DNA is suppressed by the selective compound.

A large number of techniques are available for inserting DNA into a host plant cell. Those techniques include transformation with T-DNA delivered by Agrobacterium tumefaciens or Agrobacterium rhizogenes as the transformation agent. Additionally, fusion of plant protoplasts with liposomes containing the DNA to be delivered, direct injection of the DNA, biolistics transformation (microparticle bombardment), or electroporation, as well as other possible methods, may be employed.

In a preferred embodiment of the subject invention, plants will be transformed with genes wherein the codon usage of the protein coding region has been optimized for plants. See, for example, U.S. Pat. No. 5,380,831. For example, an engineered Cry6Aa insecticidal toxin of the invention can be optimized for expression in a dicot such as potato, eggplant, tomato, pepper, tobacco, or other plants in the nightshade family. The engineered Cry6Aa insecticidal toxin of the invention can also be optimized for expression in other dicots such as soybean and cotton, or in monocots such as Zea mays (corn). Also, advantageously, plants encoding a truncated toxin may be used. The truncated toxin typically will encode about 55% to about 80% of the full length toxin. Methods for creating synthetic B.t. genes for use in plants are known in the art (Stewart 2007).

Regardless of transformation technique, the gene is preferably incorporated into a gene transfer vector adapted to express the B.t. insecticidal toxin genes and variants in the plant cell by including in the vector a plant promoter. In addition to plant promoters, promoters from a variety of sources can be used efficiently in plant cells to express foreign genes. For example, promoters of bacterial origin, such as the octopine synthase promoter, the nopaline synthase promoter, the mannopine synthase promoter; promoters of viral origin, such as the 35S and 19S promoters of cauliflower mosaic virus (CaMV), and the like may be used. Plant-derived promoters include, but are not limited to ribulose-1,6-bisphosphate (RUBP) carboxylase small subunit (ssu), beta-conglycinin promoter, phaseolin promoter, ADH (alcohol dehydrogenase) promoter, heat-shock promoters, ADF (actin depolymerization factor) promoter, and tissue specific promoters. Promoters may also contain certain enhancer sequence elements that may improve the transcription efficiency. Typical enhancers include but are not limited to ADH1-intron 1 and ADH1-intron 6. Constitutive promoters may be used. Constitutive promoters direct continuous gene expression in nearly all cells types and at nearly all times (e.g. actin, ubiquitin, CaMV 35S). Tissue specific promoters are responsible for gene expression in specific cell or tissue types, such as the leaves or seeds (e.g. zein, oleosin, napin, ACP (Acyl Carrier Protein)), and these promoters may also be used. Promoters may also be used that are active during a certain stage of the plants' development as well as active in specific plant tissues and organs. Examples of such promoters include but are not limited to promoters that are root specific, pollen-specific, embryo specific, corn silk specific, cotton fiber specific, seed endosperm specific, phloem specific, and the like.

Under certain circumstances it may be desirable to use an inducible promoter. An inducible promoter is responsible for expression of genes in response to a specific signal, such as: physical stimulus (e.g. heat shock genes); light (e.g. RUBP carboxylase); hormone (e.g. glucocorticoid); antibiotic (e.g. tetracycline); metabolites; and stress (e.g. drought). Other desirable transcription and translation elements that function in plants may be used, such as 5′ untranslated leader sequences, RNA transcription termination sequences and poly-adenylate addition signal sequences. Numerous plant-specific gene transfer vectors are known to the art.

Target Pests.

The engineered Cry6Aa insecticidal proteins of the invention are particularly suitable for use in control of insect pests. Coleopterans are one important group of agricultural, horticultural, and household pests which cause a large amount of damage each year. This large insect order encompasses foliar- and root-feeding larvae and adults, including members of, for example, the insect families—Chrysomelidae, Coccinellidae, Curculionidae, Dermestidae, Elateridae, Scarabaeidae, Scolytidae, and Tenebrionidae. Included within these families are leaf beetles and leaf miners in the family Chrysomelidae, potato beetles (e.g. Colorado potato beetle (Leptinotarsa decemlineata Say), grape colaspis (Colaspis brunnea Fabricius), cereal leaf beetle (Oulema melanopus Linnaeus), sunflower beetle (Zygogramma exclamationis Fabricius), and beetles in the family Coccinellidae (e.g. Mexican bean beetle (Epilachna varivestis Mulsant)). Further examples are chafers and other beetles in the family Scarabaeidae (e.g. Japanese beetle (Popillia japonica Newman), northern masked chafer (white grub, Cyclocephala borealis Arrow), southern masked chafer (white grub, Cyclocephala immaculata Olivier), European chafer (Rhizotrogus majalis Razoumowsky), white grub (Phyllophaga crinita Burmeister), carrot beetle (Ligyrus gibbosus De Geer), and chafers of the genera Holotrichia spp and Melolontha spp.). Further examples of coleopteran insects are weevils (e.g. boll weevil (Anthonomus grandis Boheman), rice water weevil (Lissorhoptrus oryzophilus Kuschel), granary weevil (Sitophilus grananus Linnaeus), rice weevil (Sitophilus oryzae Linnaeus), and clover leaf weevil (Hypera punctata Fabricius)). Also included are maize billbug (Sphenophorus maidis Chittenden), flea beetles (e.g. corn flea beetle (Chaetocnema pulicara Melsheimer), and crucifer flea beetle (Phyllotreta cruciferae Goeze)), spotted cucumber beetle (Diabrotica undecimpunctata), and rootworms, (e.g. western corn rootworm (Diabrotica virgifera virgifera LeConte), northern corn rootworm (Diabrotica barben Smith & Lawrence), southern corn rootworm (Diabrotica undecimpunctata howardi Barber), the Mexican corn rootworm (D. virgifera zeae Krysan and Smith), D. balteata LeConte, D. undecimpunctata tenella, D. speciosa Germar, and D. u. undecimpunctata Mannerheim). Further examples of coleopteran pests are beetles of the family Rutelinae (shining leaf chafers) such as the genus Anomala (including A. marginata, A. lucicola, A. oblivia and A. orientalis). Additional coleopteran insects are carpet beetles from the family Dermestidae, wireworms from the family Elateridae (e.g. Melanotus spp., Conoderus spp., Limonius spp., Agriotes spp., Ctenicera spp., Aeolus spp.)), bark beetles from the family Scolytidae, and beetles from the family Tenebrionidae (e.g. Eleodes spp). Any genus listed above (and others), generally, can also be targeted as a part of the subject invention by insecticidal compositions including engineered Cry6Aa insecticidal polypeptide alone or in combination with another insecticidal agent. Any additional insects in any of these genera (as targets) are also included within the scope of this invention.

Use of engineered Cry6Aa insecticidal proteins to control coleopteran pests of crop plants is contemplated. In some embodiments, Cry proteins may be economically deployed for control of insect pests that include but are not limited to, for example, rootworms such as western corn rootworm (Diabrotica virgifera virgifera LeConte), northern corn rootworm (Diabrotica barberi Smith & Lawrence), southern corn rootworm (Diabrotica undecimpunctata howardi Barber), the Mexican corn rootworm (D. virgifera zeae Krysan and Smith), D. balteata LeConte, D. undecimpunctata tenella, D. speciosa Germar, and D. u. undecimpunctata Mannerheim, and grubs such as the larvae of Cyclocephala borealis (northern masked chafer), Cyclocephala immaculate (southern masked chafer), and Popillia japonica (Japanese beetle).

Lepidopterans are another important group of agricultural, horticultural, and household pests which cause a very large amount of damage each year. The invention provides use of engineered Cry6Aa insecticidal proteins in combination with other insecticides to control insect pests within this order. This insect order encompasses foliar- and root-feeding larvae and adults, including members of, for example, the insect families Arctiidae, Gelechiidae, Geometridae, Lasiocampidae, Lymantriidae, Noctuidae, Pyralidae, Sesiidae, Sphingidae, Tineidae, and Tortricidae. Lepidopteran insect pests include, but are not limited to: Achoroia grisella, Acleris gloverana, Acleris variana, Adoxophyes orana, Agrotis ipsilon (black cutworm), Alabama argillacea, Alsophila pometaria, Amyelois transitella, Anagasta kuehniella, Anarsia lineatella, Anisota sanatoria, Antheraea pernyi, Anticarsia gemmatalis, Archips sp., Argyrotaenia sp., Athetis mindara, Bombyx mori, Bucculatrix thurberiella, Cadra cautella, Choristoneura sp., Cochylls hospes, Colias eurytheme, Corcyra cephalonica, Cydia latiferreanus, Cydia pomonella, Datana integerrima, Dendrolimus sibericus, Desmia feneralis, Diaphania hyalinata, Diaphania nitidalis, Diatraea grandiosella (southwestern corn borer), Diatraea saccharalis (sugarcane borer), Ennomos subsignaria, Eoreuma loftini, Esphestia elutella, Erannis tilaria, Estigmene acrea, Eulia salubricola, Eupocoellia ambiguella, Eupoecilia ambiguella, Euproctis chrysorrhoea, Euxoa messoria, Galleria mellonella, Grapholita molesta, Harrisina americana, Helicoverpa subflexa, Helicoverpa zea (corn earworm), Heliothis virescens (tobacco budworm), Hemileuca oliviae, Homoeosoma electellum, Hyphantia cunea, Keiferia lycopersicella, Lambdina fiscellaria fiscellaria, Lambdina fiscellaria lugubrosa, Leucoma salicis, Lobesia botrana, Loxagrotis albicosta (western bean cutworm), Loxostege sticticalis, Lymantria dispar, Macalla thyrisalis, Malacosoma sp., Mamestra brassicae, Mamestra configurata, Manduca quinquemaculata, Manduca sexta, Maruca testulalis, Melanchra picta, Operophtera brumata, Orgyia sp., Ostrinia nubilalis (European corn borer), Paleacrita vernata, Papiapema nebris (common stalk borer), Papilio cresphontes, Pectinophora gossypiella, Phryganidia californica, Phyllonorycter blancardella, Pieris napi, Pieris rapae, Plathypena scabra, Platynota flouendana, Platynota stultana, Platyptilia carduidactyla, Plodia interpunctella, Plutella xylostella (diamondback moth), Pontia protodice, Pseudaletia unipuncta (armyworm), Pseudoplasia includens, Sabulodes aegrotata, Schizura concinna, Sitotroga cerealella, Spilonta ocellana, Spodoptera frugiperda (fall armyworm), Spodoptera exigua (beet armyworm), Thaurnstopoea pityocampa, Ensola bisselliella, Trichoplusia ni, (cabbage looper), Udea rubigalis, Xylomyges curiails, and Yponomeuta padella.

Use of the engineered Cry6Aa insecticidal proteins to control parasitic nematodes including, but not limited to, root knot nematode (Meloidogyne incognita) and soybean cyst nematode (Heterodera glycines) is also contemplated.

Anti-Toxin Antibodies.

Antibodies to the toxins disclosed herein, or to equivalent toxins, or fragments of these toxins, can readily be prepared using standard procedures in this art. Such antibodies are useful to purify or detect the presence of the engineered Cry6Aa toxins.

Once the B.t. insecticidal protein has been isolated, antibodies specific for the protein may be raised by conventional methods that are well known in the art. Repeated injections into a host of choice over a period of weeks or months will elicit an immune response and result in significant anti-B.t. toxin serum titers. Preferred hosts are mammalian species and more highly preferred species are rabbits, goats, sheep, and mice. Blood drawn from such immunized animals may be processed by established methods to obtain antiserum (polyclonal antibodies) reactive with the B.t. insecticidal toxin. The antiserum may then be affinity purified by adsorption to the toxin according to techniques known in the art. Affinity purified antiserum may be further purified by isolating the immunoglobulin fraction within the antiserum using procedures known in the art. The resulting material will be a heterogeneous population of immunoglobulins reactive with the B.t. insecticidal toxin.

Anti-B.t. toxin antibodies may also be generated by preparing a semi-synthetic immunogen consisting of a synthetic peptide fragment of the B.t. insecticidal toxin conjugated to an immunogenic carrier. Numerous schemes and instruments useful for making peptide fragments are well known in the art. Many suitable immunogenic carriers such as bovine serum albumin or keyhole limpet hemocyanin are also well known in the art, as are techniques for coupling the immunogen and carrier proteins. Once the semi-synthetic immunogen has been constructed, the procedure for making antibodies specific for the B.t. insecticidal toxin fragment is identical to those used for making antibodies reactive with natural B.t. toxin.

Anti-B.t. toxin monoclonal antibodies (MAbs) are readily prepared using purified B.t. insecticidal protein. Methods for producing MAbs have been practiced for over 20 years and are well known to those of ordinary skill in the art. Repeated intraperitoneal or subcutaneous injections of purified B.t. insecticidal protein in adjuvant will elicit an immune response in most animals Hyperimmunized B-lymphocytes are removed from the animal and fused with a suitable fusion partner cell line capable of being cultured indefinitely. Preferred animals whose B-lymphocytes may be hyperimmunized and used in the production of MAbs are mammals. More preferred animals are rats and mice and most preferred is the BALB/c mouse strain.

Numerous mammalian cell lines are suitable fusion partners for the production of hybridomas. Many such lines are available from the American Type Culture Collection (ATCC, Manassas, Va.) and commercial suppliers. Preferred fusion partner cell lines are derived from mouse myelomas and the HL-1® Friendly myeloma-653 cell line (Ventrex, Portland, Me.) is most preferred. Once fused, the resulting hybridomas are cultured in a selective growth medium for one to two weeks. Two well known selection systems are available for eliminating unfused myeloma cells, or fusions between myeloma cells, from the mixed hybridoma culture. The choice of selection system depends on the strain of mouse immunized and myeloma fusion partner used. The AAT selection system, described by Taggart and Samloff (1983), may be used; however, the HAT (hypoxanthine, aminopterin, thymidine) selection system, described by Littlefield (1964), is preferred because of its compatibility with the preferred mouse strain and fusion partner mentioned above. Spent growth medium is then screened for immunospecific MAb secretion. Enzyme linked immunosorbent assay (ELISA) procedures are best suited for this purpose; though, radioimmunoassays adapted for large volume screening are also acceptable. Multiple screens designed to consecutively pare down the considerable number of irrelevant or less desired cultures may be performed. Cultures that secrete MAbs reactive with the B.t. insecticidal toxin may be screened for cross-reactivity with known B.t. insecticidal toxins. MAbs that preferentially bind to the preferred B.t. insecticidal toxin may be isotyped using commercially available assays. Preferred MAbs are of the IgG class, and more highly preferred MAbs are of the IgG₁ and IgG₂ₐ subisotypes.

Hybridoma cultures that secrete the preferred MAbs may be sub-cloned several times to establish monoclonality and stability. Well known methods for sub-cloning eukaryotic, non-adherent cell cultures include limiting dilution, soft agarose and fluorescence activated cell sorting techniques. After each subcloning, the resultant cultures preferably are re-assayed for antibody secretion and isotype to ensure that a stable preferred MAb-secreting culture has been established.

The anti-B.t. toxin antibodies are useful in various methods of detecting the claimed B.t. insecticidal toxin of the instant invention, and variants or fragments thereof. It is well known that antibodies labeled with a reporting group can be used to identify the presence of antigens in a variety of milieus. Antibodies labeled with radioisotopes have been used for decades in radioimmunoassays to identify, with great precision and sensitivity, the presence of antigens in a variety of biological fluids. More recently, enzyme labeled antibodies have been used as a substitute for radiolabeled antibodies in the ELISA assay. Further, antibodies immunoreactive to the B.t. insecticidal toxin of the present invention can be bound to an immobilizing substance such as a polystyrene well or particle and used in immunoassays to determine whether the B.t. toxin is present in a test sample.

Detection Using Probes.

A further method for identifying the polypeptides and genes of the subject invention is through the use of oligonucleotide probes. These probes are detectable nucleotide sequences. These sequences may be rendered detectable by virtue of an appropriate radioactive label or may be made inherently fluorescent as described in U.S. Pat. No. 6,268,132. As is well known in the art, if the probe molecule and nucleic acid sample hybridize by forming strong base-pairing bonds between the two molecules, it can be reasonably assumed that the probe and sample have substantial sequence homology. Preferably, hybridization is conducted under stringent conditions by techniques well-known in the art, as described, for example, in Keller and Manak (1993). Detection of the probe provides a means for determining in a known manner whether hybridization has occurred. Such a probe analysis provides a rapid method for identifying toxin-encoding genes of the subject invention. The nucleotide segments which are used as probes according to the invention can be synthesized using a DNA synthesizer and standard procedures. These nucleotide sequences can also be used as PCR primers to amplify genes of the subject invention.

Hybridization.

As is well known to those skilled in molecular biology, similarity of two nucleic acids can be characterized by their tendency to hybridize. As used herein the terms “stringent conditions” or “stringent hybridization conditions” are intended to refer to conditions under which a probe will hybridize (anneal) to its target sequence to a detectably greater degree than to other sequences (e.g. at least 2-fold over background). Stringent conditions are sequence-dependent and will be different in different circumstances. By controlling the stringency of the hybridization and/or washing conditions, target sequences that are 100% complementary to the probe can be identified (homologous probing). Alternatively, stringency conditions can be adjusted to allow some mismatching in sequences so that lower degrees of similarity are detected (heterologous probing). Generally, a probe is less than about 1000 nucleotides in length, preferably less than 500 nucleotides in length.

Typically, stringent conditions will be those in which the salt concentration is less than about 1.5 M Na ion, typically about 0.01 to 1.0 M Na ion concentration (or other salts) at pH 7.0 to pH 8.3 and the temperature is at least about 30° C. for short probes (e.g. 10 to 50 nucleotides) and at least about 60° C. for long probes (e.g. greater than 50 nucleotides). Stringent conditions may also be achieved with the addition of destabilizing agents such as formamide Exemplary low stringency conditions include hybridization with a buffer solution of 30% to 35% formamide, 1 M NaCl, 1% SDS (sodium dodecyl sulfate) at 37° C. and a wash in 1× to 2×SSC (20×SSC=3.0 M NaCl/0.3 M trisodium citrate) at 50° C. to 55° C. Exemplary moderate stringency conditions include hybridization in 40% to 45% formamide, 1.0 M NaCl, 1% SDS at 37° C. and a wash in 0.5× to 1×SSC at 55° C. to 60° C. Exemplary high stringency conditions include hybridization in 50% formamide, 1 M NaCl, 1% SDS at 37° C. and a wash in 0.1×SSC at 60° C. to 65° C. Optionally, wash buffers may comprise about 0.1% to about 1% SDS. Duration of hybridization is generally less than about 24 hours, usually about 4 to about 12 hours.

Specificity is typically the function of post-hybridization washes, the critical factors being the ionic strength and temperature of the final wash solution. For DNA/DNA hybrids, the thermal melting point (Tₘ) is the temperature (under defined ionic strength and pH) at which 50% of a complementary target sequence hybridizes to a perfectly matched probe. Tₘ is reduced by about 1° C. for each 1% of mismatching; thus, Tₘ, hybridization conditions, and/or wash conditions can be adjusted to facilitate annealing of sequences of the desired identity. For example, if sequences with >90% identity are sought, the Tₘ can be decreased 10° C. Generally, stringent conditions are selected to be about 5° C. lower than the Tₘ for the specific sequence and its complement at a defined ionic strength and pH. However, highly stringent conditions can utilize a hybridization and/or wash at 1° C., 2° C., 3° C., or 4° C. lower than the Tₘ; moderately stringent conditions can utilize a hybridization and/or wash at 6° C., 7° C., 8° C., 9° C., or 10° C. lower than the Tₘ, and low stringency conditions can utilize a hybridization and/or wash at 11° C., 12° C., 13° C., 14° C., 15° C., or 20° C. lower than the Tₘ.

Tₘ (in ° C.) may be experimentally determined or may be approximated by calculation. For DNA-DNA hybrids, the Tₘ can be approximated from the equation of Meinkoth and Wahl (1984):

Tₘ(° C.)=81.5° C.+16.6(log M)+0.41(% GC)−0.61(% formamide)˜500/L;

where M is the molarity of monovalent cations, % GC is the percentage of guanosine and cytosine nucleotides in the DNA, % formamide is the percentage of formamide in the hybridization solution (w/v), and L is the length of the hybrid in base pairs. Alternatively, the Tₘ is described by the following formula (Beltz et al., 1983).

Tₘ(° C.)=81.5° C.+16.6(log [Na+])+0.41(% GC)˜0.61(% formamide)˜600/L

where [Na+] is the molarity of sodium ions, % GC is the percentage of guanosine and cytosine nucleotides in the DNA, % formamide is the percentage of formamide in the hybridization solution (w:v), and L is the length of the hybrid in base pairs

Using the equations, hybridization and wash compositions, and desired Tₘ, those of ordinary skill will understand that variations in the stringency of hybridization and/or wash solutions are inherently described. If the desired degree of mismatching results in a Tₘ of less than 45° C. (aqueous solution) or 32° C. (formamide solution), it is preferred to increase the SSC concentration so that a higher temperature can be used. An extensive guide to the hybridization of nucleic acids is found in Tijssen (1993) and Ausubel et al. (1995). Also see Sambrook et al. (1989).

Hybridization of immobilized DNA on Southern blots with radioactively labeled gene-specific probes may be performed by standard methods (Sambrook et al., supra.). Radioactive isotopes used for labeling polynucleotide probes may include 32P, 33P, 14C, or 3H. Incorporation of radioactive isotopes into polynucleotide probe molecules may be done by any of several methods well known to those skilled in the field of molecular biology. (See, e.g. Sambrook et al., supra.) In general, hybridization and subsequent washes may be carried out under stringent conditions that allow for detection of target sequences with homology to the claimed insecticidal protein encoding genes. For double-stranded DNA gene probes, hybridization may be carried out overnight at 20° C. to 25° C. below the Tₘ of the DNA hybrid in 6×SSPE, 5×Denhardt's Solution, 0.1% SDS, 0.1 mg/mL denatured DNA (20×SSPE is 3M NaCl, 0.2 M NaHPO₄, and 0.02M EDTA (ethylenediamine tetra-acetic acid sodium salt); 100×Denhardt's Solution is 20 gm/L Polyvinylpyrollidone, 20 gm/L Ficoll type 400 and 20 gm/L Bovine Serum Albumin (fraction V)).

Washes are typically carried out as follows:
Twice at room temperature for 15 minutes in 1×SSPE, 0.1% SDS (low stringency wash).
Once at Tₘ−20° C. for 15 minutes in 0.2×SSPE, 0.1% SDS (moderate stringency wash).

For oligonucleotide probes, hybridization may be carried out overnight at 10° C. to 20° C. below the Tₘ of the hybrid in 6×SSPE, 5×Denhardt's solution, 0.1% SDS, 0.1 mg/mL denatured DNA. Tₘ for oligonucleotide probes may be determined by the following formula (Suggs et al., 1981).

Tₘ(° C.)=2(number of T/A base pairs)+4(number of G/C base pairs)

Washes are typically carried out as follows:
Twice at room temperature for 15 minutes 1×SSPE, 0.1% SDS (low stringency wash).
Once at the hybridization temperature for 15 minutes in 1×SSPE, 0.1% SDS (moderate stringency wash).

Probe molecules for hybridization and hybrid molecules formed between probe and target molecules may be rendered detectable by means other than radioactive labeling. Such alternate methods are intended to be within the scope of this invention.

By the use of the term “genetic material” herein, it is meant to include all genes, nucleic acid, DNA and RNA. The term “dsRNA” refers to double-stranded RNA. For designations of nucleotide residues of polynucleotides, DNA, RNA, oligonucleotides, and primers, and for designations of amino acid residues of proteins, standard IUPAC abbreviations are employed throughout this document. Nucleic acid sequences are presented in the standard 5′ to 3′ direction, and protein sequences are presented in the standard amino (N) terminal to carboxy (C) terminal direction.

Unless specifically indicated or implied, the terms “a”, “an”, and “the” signify “at least one” as used herein.

All percentages are by weight and all solvent mixture proportions are by volume unless otherwise noted. All temperatures are in degrees Celsius.

All patents, patent applications, provisional applications, and publications referred to or cited herein are incorporated by reference in their entirety to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. These examples should not be construed as limiting.

### Example 1

### Transformation of DIG-177 (Wild Type Cry6Aa) with Transit Peptides into Corn

Design of a Plant-Optimized Version of the Coding Sequence for the DIG-177 B.t. Insecticidal Polypeptide.

One skilled in the art of plant molecular biology will understand that multiple DNA sequences may be designed to encode a single amino acid sequence. A common means of increasing the expression of a coding region for a protein of interest is to tailor the coding region in such a manner that its codon composition resembles the overall codon composition of the host in which the gene is destined to be expressed. Guidance regarding the design and production of synthetic genes can be found in, for example, WO1997013402, U.S. Pat. Nos. 6,166,302, and 5,380,831.

A DNA sequence having a maize codon bias was designed and synthesized to produce a DIG-177 insecticidal protein in transgenic monocot plants (SEQ ID NO:2). A codon usage table for maize (Zea mays L.) was calculated from hundreds of protein coding sequences obtained from sequences deposited in GenBank (www.ncbi.nlm.nih.gov). A rescaled maize codon set was calculated after omitting any synonymous codon used less than about 10% of total codon uses for that amino acid.

To derive a maize-codon-optimized DNA sequence encoding the DIG-177 protein, variants or chimeras of DIG-177 insecticidal proteins, or insecticidal fragments thereof, are the subject of codon substitutions to the experimentally determined (native) DIG-177 DNA sequence (SEQ ID NO:1) encoding the pesticidal protein were made such that the resulting DNA sequence had the overall codon composition of the maize-optimized codon bias table. Further refinements of the sequences were made to eliminate undesirable restriction enzyme recognition sites, potential plant intron splice sites, long runs of A/T or C/G residues, and other motifs that might interfere with mRNA stability, transcription, or translation of the coding region in plant cells. Other changes were made to introduce desired restriction enzyme recognition sites, and to eliminate long internal Open Reading Frames (frames other than +1). These changes were all made within the constraints of retaining the maize-biased rescaled codon composition. A maize-optimized DNA sequence encoding DIG-177 polypeptide is disclosed as SEQ ID NO:3.

### Construct Design and Plasmid List.

All of the constructs were designed for standard nuclear transformation, nuclear transcription and cytoloslic translation. The maize ubiquitin promoter and maize perxoxidase 5 3′ untranslated regions were used to regulate the DIG-177 coding regions. Herbicide selection was provided by the AAD-1 gene (Wright et al. 2010) under the control of the Sugarcane Bacilliform virus promoter with a maize streak virus leader and maize alcohol dehydrogenase intron; the 3′ untranslated region was from the maize lipase gene. Seven different sub cellular compartments were tested for DIG-177 accumulation. A summary of the transit peptides used is shown in Table 2. Table 2

Summary of With the exception of the apoplast, multiple transit peptides were tested for each compartment. The native DIG-177 initiating methionine codon was removed for amino terminal transit peptides. The transit peptides were adjusted to reflect a similar codon bias as the DIG-177 coding region.

TABLE 2
Summary of plasmids, coding regions and transit peptides
(N denotes amino terminal location; C denotes carboxy terminal location)

| | | | | Transit | |
|---|---|---|---|---|---|
| | DIG-177 | SEQ ID | Target | Peptide | Transit Petide |
| Plasmid | Coding Region | NO | Compartment | Location | Reference |
| pDAB117247 | IRDIG.552.60 | 4 | Mitochondrion | N-terminal | Fallahi et al., 2005 |
| pDAB117248 | IRDIG.552.61 | 6 | Mitochondrion | N-terminal | White et al., 1989 |
| pDAB117249 | IRDIG.552.62 | 8 | Mitochondrion | N-terminal | Rokov-Plavec et al., 2008 |
| | | | and Chloroplast | | |
| pDAB117250 | IRDIG.552.63 | 10 | Peroxisome | C-terminal | Hahn, et al. 1999; |
| | | | | | Gnanasambandam, et |
| | | | | | al., 2012 |
| pDAB117251 | IRDIG.552.64 | 12 | Peroxisome | C-terminal | Mano, et al. 2002; |
| | | | | | Hyunjong, et al., 2006 |
| pDAB117252 | IRDIG.552.65 | 14 | Peroxisome | N-terminal | Mano, et al., 2002 |
| pDAB117253 | IRDIG.552.66 | 16 | Vacuole | N-terminal | Holwerda, et al., 1992 |
| pDAB117254 | IRDIG.552.67 | 18 | Vacuole | N-terminal | Cervelli, et al., 2000; |
| | | | | C-terminal | US20090193541 2012 |
| pDAB117255 | IRDIG.552.68 | 20 | Vacuole | N-terminal | Miao, et al., 2006 |
| | | | | C-terminal | |
| pDAB117256 | IRDIG.552.69 | 22 | Apoplast | N-terminal | Hood, et al., 2007 |
| pDAB117257 | IRDIG.552.70 | 24 | Endoplasmic | N-terminal | Hood, et al., 2007 |
| | | | Reticulum | C-terminal | |
| pDAB117258 | IRDIG.552.71 | 26 | Nucleus | N-terminal | Varagona, et al., 1994; |
| | | | | | Cao, et al., 2013 |
| pDAB117259 | IRDIG.552.72 | 28 | Nucleus | C-terminal | Varagona, et al., 1994; |
| | | | | | Cao, et al., 2013 |
| pDAB117260 | IRDIG.552.73 | 30 | Chloroplast | N-terminal | WO2013/116768 A1 |
| pDAB117261 | IRDIG.552.74 | 32 | Chloroplast | N-terminal | WO2013/116768 A1 |

T₀ and T₁ Experimental Design.

A goal of twenty five transgenic events per construction was set with fifteen being low copy. All events were analyzed for insert copy number and DIG-177 leaf accumulation by LC/MS/MS. The low copy events were set aside, the non-expressers discarded and the expressers carried forward for T₁ seed production. This ensured recovery of partially efficacious events which might be lost at the T₀ bioassay. Multi copy expressing events were bioassayed at the T₀ stage; those which passed were saved for T₁ seed production and further analysis. The T₁ seed were planted, the plants analyzed for protein (LC/MS/MS and Western blot) in both leaf and root tissues, five siblings were tested in bioassay.

Agrobacterium Culture Initiation.

The Agrobacterium tumefaciens strains containing the DIG-177 plant transformation constructions (Table 2) were obtained from the DAS Recombinant Culture Collection. The cultures were streaked from glycerol stocks onto Agrobacterium minimal medium and incubated at 20° C. in the dark for 3 days. Agrobacterium cultures were then streaked onto a plate of YEP medium and incubated at 20° C. in the dark for 1 day.

On the day of an experiment, a mixture of inoculation medium and acetosyringone was prepared in a volume appropriate to the number of constructs in the experiment. A 1 M stock solution of acetosyringone in 100% dimethyl sulfoxide was added to the flask containing inoculation medium in a volume appropriate to make a final acetosyringone concentration of 200 μM.

For each construct, 1-2 loops of Agrobacterium from the YEP plate were suspended in 15 ml of the inoculation medium/acetosyringone mixture inside a sterile, disposable, 50 ml centrifuge tube and the optical density of the solution at 600 nm (O.D.₆₀₀) was measured in a spectrophotometer. The suspension was then diluted down to 0.25-0.35 O.D.₆₀₀ using additional Inoculation medium/acetosyringone mixture. The tube of Agrobacterium suspension was then placed horizontally on a platform shaker set at 75 rpm at room temperature for between 1 and 4 hours before use.

Ear Sterilization and Embryo Isolation.

Ears from Zea mays cultivar B104 were produced in greenhouse facilities and harvested 10-12 days post pollination. Harvested ears were de-husked and surface-sterilized by immersion in a 20% solution of commercial bleach (Ultra Clorox® Germicidal Bleach, 6.15% sodium hypochlorite) and two drops of soap, for 20 minutes, followed by three rinses in sterile, deionized water inside a laminar flow hood. Immature zygotic embryos (1.8-2.2 mm long) were aseptically excised from each ear and distributed into one or more micro-centrifuge tubes containing 2.0 ml of Agrobacterium suspension into which 2 μl of 10% Break-Thru® 5233 surfactant had been added.

Agrobacterium Co-Cultivation.

Upon completion of the embryo isolation activity the tube of embryos was closed and placed on a rocker platform for 5 minutes. The contents of the tube were then poured onto a plate of co-cultivation medium and the liquid Agrobacterium suspension was removed with a sterile, disposable, transfer pipette. The co-cultivation plate containing embryos was placed at the back of the laminar flow hood with the lid ajar for 30 minutes; after which time the embryos were oriented with the scutellum facing up using a microscope. The co-cultivation plate with embryos was then returned to the back of the laminar flow hood with the lid ajar for a further 15 minutes. The plate was then closed, sealed with 3M Micropore™ tape, and placed in an incubator at 25° C. with 24 hours/day light at approximately 60 μmol m⁻² s⁻¹ photosynthetically active radiation (PAR).

Callus Selection and Regeneration of Transgenic Events.

Following the co-cultivation period, embryos were transferred to Resting medium. No more than 36 embryos were moved to each plate. The plates were incubated at 27° C. with 24 hours/day light at approximately 50 μmol m⁻² s⁻¹ PAR for 7-10 days. Callused embryos were then transferred onto Selection I medium. The plates were incubated at 27° C. with 24 hours/day light at approximately 50 μmol m⁻² s⁻¹ PAR for 7 days. Callused embryos were then transferred to Selection II medium. The plates were incubated at 27° C. with 24 hours/day light at approximately 50 μmol m⁻² s⁻¹ PAR for 14 days.

At this stage resistant calli were moved to pre-regeneration medium. The plates were incubated at 27° C. with 24 hours/day light at approximately 50 μmol m⁻² s⁻¹ PAR for 7 days. Regenerating calli were then transferred to regeneration medium in Phytatrays™ and incubated at 28° C. with 16 hours light/8 hours dark per day at approximately 150 μmol m⁻² s⁻¹ PAR for 7-14 days or until shoots develop. Small shoots with primary roots were then isolated and transferred to Robusting medium. Rooted plantlets about 6 cm or taller were transplanted into soil and moved to a growth chamber for hardening off.

Genomic DNA Isolation for PCR from Plant Tissues.

Tissue samples, leaf tear equivalent to 2 leaf punches, were collected in 96-well collection plates (Qiagen, Hilden, Germany). Tissue disruption was performed with a Klecko™ tissue pulverizer (Garcia Manufacturing, Visalia, Calif.) in the Biosprint96 AP1 lysis buffer with one stainless steel bead. Following tissue maceration, the genomic DNA was isolated in high throughput format. Genomic DNA was diluted 2:3 DNA/H₂O prior to setting up the qPCR reaction to achieve appropriate Cp scores.

Hydrolysis Probe Assay.

Transgene detection by hydrolysis probe assay was performed by real-time PCR. Assays were designed at Dow AgroSciences for the genes of interest (GOI) Cry6Aa (IRDIG522.28) using LightCycler® Probe Design Software 2.0. The RNA detection assays were run as single reactions using Maize TIP41-like as the reference. For amplification, LightCycler® 480 Probes Master mix (Roche Applied Science) was prepared at 1× final concentration in a 10 μL volume biplex reaction containing 0.4 μM of each primer and 0.2 μM of each probe. A two step amplification reaction was performed with an extension at 60° C. for 40 seconds with fluorescence acquisition. Cp scores, the point at which the florescence signal crosses the background threshold using the fit points algorithm (LightCycler® software release 1.5) and the Absolute Quant module (based on the ΔΔCt method), were used to perform the analysis of real time PCR data.

T₀ Greenhouse.

Plant bearing selected events were transplanted into 5 gallon pots. Shoot bags were placed over the shoots prior to silk emergence to prevent cross-contamination by stray pollen. The second shoot was then covered and used for pollinations. Silks were cut back the day prior to pollination to provide an even brush to accept pollen. Pollen from the inbred B104 was used for all pollinations. Reciprocal crosses were performed when possible. Ears were peeled back at 21 days after pollination to enhance dry down followed by complete harvest (ear removed from plant) at 42 days after pollinations. Ears were placed in the dryer for 1 week, followed by seed processing (shelling, counting, packaging).

Leaf Sampling for Western Blot and LC/MS/MS Analyses.

The plants were sampled at the V-3 to V-5 stage within a day of bioassay collection. Two 6 mm diameter leaf samples were stored in a 96 well cluster tube rack at −80° C. until the day of analysis. Two Daisy™ steel BB's and 300 μl of extraction buffer (PBS solution containing 0.05% of Tween 20 and 5 μl/ml of Sigma protease inhibitors) was added to each tube. The samples were milled in a Kelco bead mill for 3 minutes, on maximum setting. Samples were centrifuged at 3,000×g for 5 minutes; 100 μl of the supernatant was transferred to an empty sample tube. Another 100 μl of extraction buffer was added to the plant sample and bead milled 3 additional minutes, centrifuged and 100 μl of this extract was combined with the first 100 The combined supernatants were mixed and analyzed the same day as the extraction.

Root Sampling for Western Blot and LC/MS/MS Analyses.

The complete root system was collected, washed with water, and stored at −80° C. for all of the T₁ plants at the V-3 to V-5 stage. Each plant remained a separate sample in individual plastic bags. Each root system was ground with dry ice in an industrial food processor, and the dry ice sublimed at −20° C. keeping the samples frozen. The ground, sublimed frozen samples were then lyophilized for 2 weeks. Portions of the lyophilized root systems were weighed and placed in individual cluster tubes, 96 well format. The samples were prepared as described above for the leaf sampling.

DIG-177 Quantitation by LC/MS/MS.

Leaf samples were extracted for each plant in 25 mM ammonium bicarbonate+0.05% Tween 20. The samples were extracted twice by bead mill and then pooled. For root samples, ground and lyophilized root tissue was weighed into a vial and extracted as described above. The samples were denatured with 6 mM DTT at 95° C. for 20 minutes. After the samples were cooled, 1 μg of trypsin was added to each sample and the samples were digested at 37° C. for 16 hours. Following digestion the samples were treated with 1% formic acid, incubated for 30 minutes at 4° C., and centrifuged at 4,000 rpm for 10 minutes. The digested samples were analyzed by LC/MS/MS. A standard curve of DIG-177 peptide standards was prepared in digested B104 matrix (prepared as described above). The standard curve was linear from 0.488-31.25 ng/mL. The samples were analyzed on Waters Acquity binary pump LC and a Sciex QTRAP 6500 using an Acquity UPLC BEH130 C18, 1.7 μm 2.1×50 mm column Each sample was injected at 20 μl and eluted using a quick gradient (95%-45% A over 1 min, 45-10% A over 1 min, hold 10% 1 min, 10-95% 1 min: Buffer A: Water+0.1% Formic Acid, Buffer B: Acetonitrile+0.1% Formic Acid). Two peptides were tracked (m/z 694.820 and m/z 586.778) for each sample. Quantitation was based off the most sensitive transition, m/z 694.820 to m/z 912.417.

Western Blot.

Conventional electrophoresis and blotting, (Gallagher, et al., 2008) methods were used with Invitrogen™ devices and basic reagents. A rabbit anti-Cry6a antibody was the primary antibody for the detection of Cry6a in leaf and root. All proteins were detected with a fluorescence detection system and an Avidin-Biotin, Alkaline phosphatase detection system.

T₀ and T₁ Maize Root Bioassay.

Non-diapausing Diabrotica virgifera (Western corn rootworm, WCR) eggs were received in soil from Crop Characteristics (Farmington, Minn.) and incubated at 28° C. and 60% RH for 10 days. On the 10^{th} day after start of incubation (approximately one day before expected hatch), the eggs were prepared for bioassay. The soil was rinsed from the eggs. The eggs were suspended in a 0.15% water agar solution at a concentration of approximately 100-200 eggs per 0.5 ml and placed into hatch plates. The number of viable eggs on the hatch plates were counted to determine the approximate concentration of eggs in the suspension and thus to calculate the volume of suspension needed to add to bioassay plants to achieve the desired infestation. The plates were maintained in a 28° C. incubator in a dark box.

Planting and Preparation for WCR Bioassay.

Transformed plants from the laboratory (T₀s) were moved to the conviron where they were maintained until they reached the V3-V4 growth stage. The V3-V4 healthy plants with good root systems were moved to the greenhouse. Plants that were weak, small, or had poor root development were left in the conviron until healthy enough for bioassay. After one to two days in the greenhouse, the plants were transplanted into root trainers filled with Metro-Mix soil.

Seeds for control plants were planted directly into Metro Mix soil in root trainer pots weekly beginning at least two weeks before the expected availability of the first T₀ plants for bioassay. About 4 days after transplanting the T0 plants, along with five control plants of each type at the same growth stage were infested with WCR eggs.

Negative control plants were the following: the B104 inbred, the 7SH382 Herculex RW (HX-RW) inbred and 101556, a yellow fluorescent protein transgenic. The positive controls were corn line 7SH382RW Transgenic Herculex RW (HX-RW).

Plants were infested with approximately 200 eggs/plant. Hatch rate was assumed to be about 50%, therefore each plant was expected to have about 100 larvae hatch and feed on the roots. Watering was monitored carefully throughout the course of the bioassay to ensure that each pot stayed moist.

Two weeks after infestation, each plant was scored for root damage, beginning with the control plants. Each plant was carefully removed from the root trainer pot, keeping the root mass intact. The top one to two inches of soil were scraped from the root and the resulting exposed area of the roots were washed with water in order to clearly view feeding damage at the base of the plants (top of the nodal roots). Feeding damage was scored using the 0.0 to 1.0 root damage rating scale that is derived from a published field corn root damage rating scale 0.0 to 3.0 (J. D. Oleson et al 2005) for greenhouse corn seedling root damage rating need. The negative controls (RW inbred, B104 and 101556) were expected to have high damage (about 0.75 to 1.0 root rating), and the positive control (transgenic Herculex™ RW (HX-RW)), was expected to have low damage, (0.0 to 0.25 root rating). After evaluation of the control plants was completed, then the T₀ plants were scored, employing a pass/fail method (0 to 1.00 scoring) and disturbing the root ball as little as possible. Passing plants were immediately transplanted to 5-gallon pots with promix-50-50 soil. After all plants were scored, passing plants were treated with a soil application of 1 tsp of FORCE (a.i. Tefluthrin) and cared for appropriately throughout development.

T₁ Greenhouse.

Selected plants were transplanted into 5 gallon pots. Shoot bags were placed over the shoots prior to silk emergence to prevent cross-contamination by stray pollen. The second shoot was then covered and used for pollinations. Silks were cut back the day prior to pollinations to provide an even brush to accept pollen. Pollen from the tassel of the plant was used to pollinate the ear on the same plant. Self pollinations were performed when possible. If a self pollination could not be performed then B104 pollen was taken to the transgenic ear. Ears were peeled back at 21 days after pollination to enhance dry down followed by complete harvest (ear removed from plant) at 42 days after pollinations. Ears were placed in the dryer for 1 week, followed by seed processing (shelling, counting, packaging in pre-printed envelopes).

Protein Accumulation Results from T₀ Events.

A range from 8 to 28 DIG-177 expressing low copy events were obtained with an overall transformation frequency of 9%. All of the regenerated events that passed the molecular analysis screen from each of the fifteen constructs were analyzed for DIG-177 leaf protein accumulation by LC/MS/MS. The average protein accumulation is shown in

Table 3. Average T₀ leaf protein accumulation level ranged from 0 ng/cm² to 98.9 ng/cm², with construct pDAB117255, targeted to the prevacuole, having the lowest average accumulation and construct pDAB117261, targeted to the chloroplast, having the highest average accumulation. Overall, the highest average protein accumulation levels were seen from the two constructs that targeted the DIG-177 protein to the chloroplast, pDAB117260 and pDAB11261 respectively. The protein accumulation for these two constructs was higher than what was seen in the previous cytosolic experiment which averaged 23.6 ng/cm². Conversely, constructs that targeted the vacuole, prevacuole and the apoplast resulted in the lowest leaf protein accumulation.

TABLE 3
Average DIG-177 protein leaf accumulation
as determined by LC/MS/MS.

| | | Accumulation | Accumulation |
|---|---|---|---|
| Construction | Compartment | T₀ ng/cm² | T₁ ng/cm² |
| pDAB117247 | Mitochondrion | 3.5 | 18.9 |
| pDAB117248 | Mitochondrion | 21.0 | 88.7 |
| pDAB117249 | Mitochondrion | 0.3 | 20.1 |
| | Chloroplast | | |
| pDAB117250 | Peroxisome | 6.3 | 46.3 |
| pDAB117251 | Peroxisome | 13.1 | 64.6 |
| pDAB117252 | Peroxisome | 0.0 | 11.6 |
| pDAB117253 | Vacuole | 1.5 | 32.2 |
| pDAB117254 | Vacuole | 5.9 | 53.4 |
| pDAB117255 | Vacuole | 0.0 | 56.1 |
| pDAB117256 | Apoplast | 0.9 | 24.0 |
| pDAB117257 | Endoplasmic | 27.9 | 93.8 |
| | Reticulum | | |
| pDAB117258 | Nucleus | 8.4 | 47.4 |
| pDAB117259 | Nucleus | 8.8 | 114.1 |
| pDAB117260 | Chloroplast | 44.4 | 232.9 |
| pDAB117261 | Chloroplast | 98.9 | 731.5 |

Leaf tissue from select T₀ events for each of the fifteen constructs was analyzed by Western blot. The proteins were directed to the specific compartments by the use of transit peptides. The precursor proteins thereby had greater molecular weights than the full-length wild type DIG-177 protein at 54.2 kDa. Depending on the compartment, the transit peptides (TraP) may or may not be cleaved upon translocation, resulting in a mature form of the protein. The predicted molecular weights of the precursor and mature forms of the proteins are shown in Table 4.

TABLE 4
Key to plasmid, protein names, target compartment and molecular weights
of the transit peptide modified DIG-177 proteins used in this study.

| | | | Precursor | Mature | Expected Transit |
|---|---|---|---|---|---|
| | | Target | Protein | Protein | Peptide (TraP) |
| Plasmid | Protein | Compartment | Mwt kDa | Mwt kDa | Processing |
| | DIG-177 | Cytosol | | 54.2 | |
| pDAB117247 | IRDIG.552.60 | Mitochondrion | 59.4 | 54.1 | N-term TraP cleaved |
| pDAB117248 | IRDIG.552.61 | Mitochondrion | 57.1 | 54.1 | N-term TraP cleaved |
| pDAB117249 | IRDIG.552.62 | Mito/Chloro. | 62.4 | 62.4 | N-term TraP cleaved |
| pDAB117250 | IRDIG.552.63 | Peroxisome | 54.8 | 54.8 | TraP not cleaved |
| pDAB117251 | IRDIG.552.64 | Peroxisome | 55.5 | 55.5 | TraP not cleaved |
| pDAB117252 | IRDIG.552.65 | Peroxisome | 59.2 | 59.2 | TraP not cleaved |
| pDAB117253 | IRDIG.552.66 | Vacuole | 58.3 | 54.1 | N-term TraP cleaved |
| pDAB117254 | IRDIG.552.67 | Vacuole | 57.4 | 54.9 | N-term TraP cleaved |
| | | | | | C-term TraP not cleaved |
| pDAB117255 | IRDIG.552.68 | Pre Vacuole | 64.3 | 61.2 | N-term TraP cleaved |
| | | | | | C-term TraP no cleaved |
| pDAB117256 | IRDIG.552.69 | Apoplast | 56.5 | 54.1 | N-term TraP cleaved |
| pDAB117257 | IRDIG.552.70 | ER | 57.2 | 54.7 | N-term TraP cleaved |
| | | | | | C-term TraP no cleaved |
| pDAB117258 | IRDIG.552.71 | Nucleus | 56.7 | 56.7 | TraP not cleaved |
| pDAB117259 | IRDIG.552.72 | Nucleus | 56.5 | 56.5 | TraP not cleaved |
| pDAB117260 | IRDIG.552.73 | Chloroplast | 61.7 | 54.1 | N-term TraP cleaved |
| pDAB117261 | IRDIG.552.74 | Chloroplast | 61.5 | 54.1 | N-term TraP cleaved |

Non-transgenic negative control samples did not show any background bands which reacted with the DIG-177 antisera. In the transgenic samples, a distinct band of apparent mature protein (comigrating with DIG-177 standard) consistent with the transit peptide being removed, was detected in many samples. In some cases, bands larger than the mature protein were also detected, consistent with detection of the precursor proteins (transit peptides not removed). All constructions showed smears of DIG-177 material from the apparent mature band 54 kDa to approximately 40 kDa, consistent with partial degradation of the protein.

Bioassay Results of T₀ Events.

Root systems from events representing the 15 different backgrounds were challenged for two weeks with WCR larvae at the V3-V4 stage of development. The samples were then scored using a pass/fail rating system as described above for damage to the root system. A total of 228 events were assayed of which 15 events scored a ‘pass’ and were saved for T₁ bioassay.

Analysis of T₁ Events.

The T₁ events were analyzed for transgenic protein production and accumulation in both leaf and root tissues. Average leaf protein accumulation increased for each of the fifteen backgrounds from the T₀ to T₁ generation and ranged from 11.6 to 731.5 ng/cm² (Table 3 above). T₁ root accumulation was significantly lower than T₁ leaf accumulation in all backgrounds (Table 5).

TABLE 5
Event average DIG-177 T₁ protein accumulation for
leaf and root tissues as determined by LC/MS/MS

| | Avg μg protein/ | Avg μg protein/ |
|---|---|---|
| Construction | g dry wt leaf | dry wt root |
| pDAB117247 | 43.4 | 1.3 |
| pDAB117248 | 126.2 | 2. |
| pDAB117249 | 29.6 | 0.9 |
| pDAB117250 | 44.4 | 1.7 |
| pDAB117251 | 55.9 | 2.6 |
| pDAB117252 | 20.3 | 0. |
| pDAB117253 | 36.9 | 4.1 |
| pDAB117254 | 57.7 | 5.2 |
| pDAB117255 | 99.6 | 3.0 |
| pDAB117256 | 29.6 | 2.2 |
| pDAB117257 | 126.7 | 12.3 |
| pDAB117258 | 72.8 | 3.1 |
| pDAB117259 | 131.8 | 13.3 |
| pDAB117260 | 364.2 | 12.4 |
| pDAB117261 | 1099.9 | 42.2 |

Both leaf and root tissue from each of the T₁ events were analyzed for protein stability by Western blot. The results were similar to those seen at T₀; distinct bands of apparent mature protein (comigrating with DIG-177 standard) consistent with the transit peptide being removed. In addition, bands larger than the mature protein were also detected, consistent with precursor proteins. Finally all constructions resulted in smear of DIG-177 material from approximately 54 kDa to approximately 40 kDa, consistent with partial degradation of the protein.

Bioassay Results of T₁ Events.

Five plants from events representing the 15 different backgrounds were challenged for two weeks with WCR larvae at the V3-V4 stage of development. The samples were graded as before for damage to the root system; plants with a Root Rating ≤0.5 were considered passing. None of the tested events passed this bioassay; none of the events were significantly different than the negative control with regard to root protection. Therefore localization to various subcellular compartments alone, using transit peptides, did not sufficiently protect DIG-177 from protease degradation.

Western Blot Analysis.

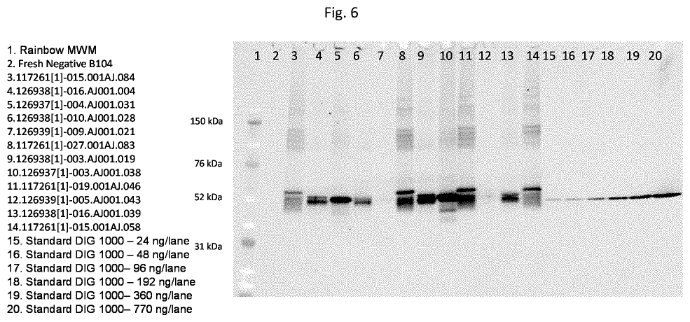

The results of the T₁ maize leaf expression experiments are shown in FIG. 6. Western analysis showed no expression of Cry6Aa proteins in the negative controls; B104 (lane 2) and pDAB115782 (lane 3) or in the transformation controls containing YFP and PAT (lane 12). The six far right lanes are protein standards of DIG-1000 (47.3 kDa).

The pDAB117261 (DIG-177) lanes 3, 8, 11, and 14 contain T₁ samples as control to compare processing with DIG 1000. The results were similar to those seen at T₀; distinct bands of apparent mature protein (comigrating with DIG-177 standard) consistent with the transit peptide being removed. In addition, bands larger than the mature protein were also detected, consistent with precursor proteins. This control construct produced a smear of DIG-177 material from approximately 54 kDa to approximately 40 kDa, consistent with partial degradation of the protein.

The results for pDAB126937 (DIG-1000) targeted to the peroxisome are located in lanes 5 and 10 of FIG. 6. There is one major band produced at the correct size corresponding to the DIG 1000 standard. Lane 10 contains one distinct smaller band slightly lower than 40 kDa smear produced with DIG 177, indicating one specific processing site.

The DIG-1000 targeted to the mitochondria pDAB126938 are located in lanes 4, 6, 9 and 13 of FIG. 6. This construct produced two bands one of the correct size and one slightly higher, likely representing the precursor protein. These data are consistent with the DIG-1000 coding sequence expressing a plant cell stable, insecticidal protein useful for western corn rootworm control.

### Example 2

### Identification of DIG-177 Disulfide Bonds

Recombinant Protein Expression Plasmids.

DIG-177 and DIG-177 variant coding sequences were cloned into individual Pseudomonas expression vector, pDOW1169. The expression vectors were then transformed into Pseudomonas fluorescens and the resulting transformed colonies were characterized and stored.

Recombinant Protein Expression.

One milliliter glycerol stocks were inoculated into 500 mL Ultra™ of production medium in a 2.5 L Ultra Yield flask (Thomson Instrument Company, Oceanside, Calif.) and incubated for 24 hrs at 30° C., shaking at 225 rpm with a 1 inch throw. Expression was induced with 150 μL of 1M IPTG. Cells were incubated at 25° C. for 24 hrs, at which time a 0.5 mL sample was taken and flasks were removed from the shaker. Cultures were harvested by centrifugation at either 19,000 rpm for 10 minutes in a JA-20 rotor (Beckman Coulter, Brea, Calif.) or 11,409 rpm for 15 min in a FIBERLite™ F12-6X500 LEX rotor (Thermo Scientific); cell pastes were stored at −80° C.

Recombinant Protein Enrichment.

DIG-177 and the variant proteins, described below, accumulated in P. fluorescens as inclusion bodies (IBs). The cell paste was thawed at 4° C. The cells were suspended to 10% w/v in lysis buffer (50 mM Tris, pH 7.5, 200 mM NaCl, 10% Glycerol, 20 mM EDTA, 0.5% Triton X-100, 5 mM benzamidine, and 1 mM DTT-added just prior to use) and mixed through with a homogenizer. The slurry was passed two times through a Microfluidics Microfluidizer (Westwood, Mass. USA) at 12000+ psi. The lysate was centrifuged at 14,000×g at 4° C. for 40 min. The supernatant was retained. The inclusion body pellet was re-suspended to 10% w/v in lysis buffer and lysozyme (L-7651; Sigma-Aldrich, St. Louis, Mo.) was added to a final concentration of 400 μg/mL. The suspension was incubated at room temperature (˜20° C.) for 60 min, and centrifuged. The inclusion body pellet was washed with lysis buffer one time and with lysis buffer minus Triton™ X-100 a second time. Finally, the inclusion body pellet was re-suspended to 30% w/v in 10 mM EDTA solution and stored at −80° C. in 2 mL aliquots. The sample purity was analyzed by SDS-PAGE (NuPAGE Bis-Tris gels, Protocol Pub. No. MAN0007894 Rev. A.0, Invitrogen Life technologies, Waltham, Mass.).

Inclusion Body Solubilization.

The IB paste stored at −80° C., was thawed at 4° C. overnight and then centrifuged at 23,000×g for 25 min at 4° C., and the supernatant was removed. The IB pellet was suspended to 20% (w/v) in 100 mM CAPS, pH 11, and solubilized at room temperature for 2 hours. The sample was centrifuged as above and the supernatant collected. The buffer was exchanged into 10 mM CAPS, pH 10, by PD-10 desalting column. The protein was quantified by Bradford protein assay following the “Quick Start™ Bradford Protein Assay—Bio-Rad” (Bio-Rad, Hercules, Calif.) protocol. The standard was BSA (bovine-serum-albumin, Albumin Standard from Pierce, Grand Island, N.Y.).

SDS-PAGE.

SDS-PAGE was run following the protocol NuPAGE Bis-Tris gels from Invitrogen Life technologies (Protocol Pub. No. MAN0007894 Rev. A.0, Ref.2). Briefly, samples were mixed with denaturing sample buffer (Invitrogen) plus 5 mM DTT (for reducing PAGE) or minus DTT (for non reducing PAGE) and heated at 95° C. for 5 minutes. The samples were loaded onto Invitrogen Bis/Tris gel. The gel was run with MOPS or MES running buffer under 200 V for ˜43 minutes. The gel was stained with Coomassie blue staining solution (Bio-Rad) for 30 minutes and de-stained with de-staining solution (7% Acetic acid and 5% Methanol in water) until the background cleared.

Intact Molecular Weight Analysis/Charged State Distribution.

Intact mass analysis was performed on an Agilent 1200 HPLC/MSD TOF 1969A system using a Michrom desalting trap heated to 50° C. Each sample was diluted to a concentration of 0.2 μg/μL in 10 mM CAPS, pH 11, buffer. Samples were also analyzed after being reduced with 50 mM TCEP ((2-carboxyethyl) phosphine hydrochloride) for 10 minutes. Approximately 1 μg protein was injected on column. The sample was eluted using a gradient (10% buffer D for 1 minute, 10-60% buffer D over 2 minutes, 60-98% buffer D over 2 minutes, 10% buffer D for 1 min), where buffer A is 0.1% Formic Acid in water and buffer D is 70% Isopropanol, 20% Acetonitrile, 10% water+0.1% Formic Acid. The mass was calculated using the Mass Hunter Qualitative Analysis software and the maximum entropy de-convolution algorithm.

Mass spectrometric analysis of DIG-177 under both reducing and not reducing conditions verified two disulfide bonds present in the protein. DIG-177 has five cysteine residues located at positions 88, 162, 402, 404, and 451. To identify the residues contributing to the disulfide bonds, mutations were made at selected cysteins and the recombinant proteins were expressed. The intact molecule weights of the variant proteins were analyzed in the presence or absence of a reducing agent. Under these conditions, each disulfide bond present in the protein is expected to account for an m/z increase of 2 when reduced with TCEP. Upon reduction of the wild type protein (DIG-177), an m/z increase of 3.8 was observed indicating that two disulfide bonds are present in the protein. DIG-614 (SEQ ID NO:35), 615 (SEQ ID NO:37), 618 (SEQ ID NO:43), 619 (SEQ ID NO:45), 983 (SEQ ID NO:47), and 984 (SEQ ID NO:49) each showed a mass change of approximately +2 upon reduction, representing a single disulfide bond. Each of these variants was expected to result in elimination of the disulfide bond between cysteine residues 88 and 451. Based on these data, an additional disulfide bond was present involving two of the cysteine residues 162, 402, or 404. Mutants DIG-616 (SEQ ID NO:39) and 617 (SEQ ID NO:41), which were expected to disrupt a disulfide bond involving Cys162, showed a change of approximately +4 upon reduction, again as with DIG-177, indicating the presence of two disulfide bonds. Since one of these disulfide bonds was found between cysteines 88 and 451, the second disulfide bond was shown by inference to be between cysteine residues 402 and 404.

TABLE 6
Intact MW of cysteine mutants plus and minus reduction with TCEP.

| | | | Observed | | | | | | |
|---|---|---|---|---|---|---|---|---|---|
| | | Expected | Avg. Mass | Mass | PPM | Disulfide | Observed Avg. | Mass | PPM |
| Protein | Mutant | Avg. Mass | w/o TCEP | difference | Error | bonds | Mass w/TCEP | difference | Error |
| DIG-177 | WT | 54075.9333 | 54072.1020 | 3.8313 | 70.85 | 2 | 54075.7579 | 0.1754 | 3.24 |
| DIG-614 | C88 > A | 54043.8672 | 54041.8036 | 2.0636 | 38.18 | 1 | 54043.8125 | 0.0547 | 1.01 |
| DIG-615 | C88 > S | 54059.8665 | 54057.6129 | 2.2536 | 41.69 | 1 | 54059.7123 | 0.1542 | 2.85 |
| DIG-616 | C162 > A | 54043.8672 | 54040.2870 | 3.5802 | 66.25 | 2 | 54043.8329 | 0.0343 | 0.63 |
| DIG-617 | C162 > S | 54059.8666 | 54055.9330 | 3.9336 | 72.76 | 2 | 54059.6086 | 0.2580 | 4.77 |
| DIG-618 | C451 > A | 54043.8672 | 54042.1269 | 1.7403 | 32.20 | 1 | 54044.0511 | −0.1839 | −3.40 |
| DIG-619 | C451 > S | 54059.8666 | 54058.3141 | 1.5525 | 28.72 | 1 | 54060.0444 | −0.1778 | −3.29 |
| DIG-983 | C88 > S; | 54043.7999 | 54041.5638 | 2.2361 | 41.38 | 1 | 54044.7883 | −0.9884 | −18.29 |
| | C451 > S | | | | | | | | |
| DIG-984 | C88 > A; | 54011.8011 | 54010.2630 | 1.5381 | 28.48 | 1 | 54012.0540 | −0.2529 | −4.68 |
| | C451 > A | | | | | | | | |

### Example 3

### Characterization of Trypsin Treated DIG-177

In summary, trypsin treated DIG-177 (trypsin core, TC) consisted of a large fragment (LF; amino acids 12-390 of SEQ ID NO:50) and either of two small fragments (amino acids 444-475 (SEQ ID NO:51 or 451-475 SEQ ID NO:52) called carboxy terminal peptides (CTP). The LF and the CTP were found to be joined through a disulfide bond between cys88 and cys451. Under non-reducing conditions, the trypsin treated sample had insecticidal activity; and under reducing conditions, the fragments dissociated (LF and CTP) and activity decreased. Neither the LF nor the CTP showed insecticidal activity at the levels tested. These observations indicate that the CTP, attached to the LF, are necessary for maintaining activity of the toxin following trypsin proteolysis.

Overview of Trypsin Treated Samples Prepared, Characterized and Tested.

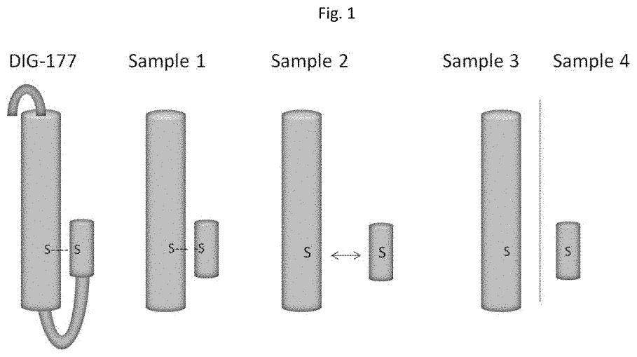

Four different samples were prepared, characterized, and bioassayed to determine which combination of peptides had WCR insecticidal activity (see FIG. 1).
Sample 1: Trypsin treated DIG-177, CTP present and disulfide bond linked to the LF.
Sample 2: Trypsin treated DIG-177, CTP present, the sample was treated with reducing agent after digestion; the reducing agent was then removed by dialysis.
Sample 3: Trypsin treated DIG-177, isolated LF
Sample 4: Trypsin treated DIG-177, isolated CTP

Trypsin Digestion.

The DIG-177 protein was produced in Pseudomonas fluorescens and purified as described in Example 2. The recombinant protein was treated with trypsin in a digestion buffer (100 mM CAPS buffer, pH 10.5, 5 mM CaCl₂, 5 mM MgCl₂) containing trypsin (TPCK treated Sigma-Aldrich, St. Louis, Mo.) to a final ratio of 15 parts protein to 1 part trypsin (W/W). The reaction was agitated with gentle rocking at room temperature. An aliquot was removed at each time point (5 min, 2 and 17 hours) for analysis, the digestion was stopped by addition of lithium dodecyl sulfate (LDS) sample buffer with 5 mM DTT and heating at 95° C. for 5 min

The trypsin treated proteins were purified by ion exchange chromatography (IEC) using an AKTA protein purifier (Amersham Pharmacia Biotech, Piscataway, N.J.). The sample was diluted with 10 mM CAPS, pH10, at 1:1 and filtered by a vacuum driven filter with a 0.22 μM membrane. The sample was injected over a pre-equilibrated HiTrap™ Q column (GE, Pittsburgh, Pa.) at 3 mL/min flow rate, the column was washed with ˜25 mL of buffer A (50 mM CAPS, pH 10) and the protein was eluted with 20% buffer B (buffer A+1M NaCl), and then followed by 30%, 40%, and 50% buffer B. Each elution was ˜25 mL. Fractions were collected from each elution based on UV absorbance, respectively. These fractions were analyzed by SDS-PAGE (see protocol NuPAGE Bis-Tris gels from Invitrogen Life technologies, Protocol Pub. No. MAN0007894 Rev. A.0).

The fractions that contained the target protein were pooled and concentrated to ˜3 mL using a centrifugal filter device with 10 kDa molecular weight cut off (MWCO) membrane (Millipore, Billerica, Mass.). The sample buffer was exchanged into 10 mM CAPS, pH 10, by dialysis. The concentrated samples were transferred into a Slide-A-Lyzer™ dialysis cassette (Thermo Scientific). The cassettes were replaced in 4 L of 10 mM CAPS, pH 10, and dialyzed at 4° C. for overnight (˜18 hours). The samples, assessed at greater than 95% purity by SDS-PAGE (as described in Example 2), were collected for WCR bioassay and/or characterization, respectively.

The protein concentration was measured by Bradford protein assay following the manufacturer's protocol “Quick Start™ Bradford Protein Assay—Bio-Rad” (Bio-Rad). The BSA (bovine-serum-albumin) was used as standard.

Sample 1: Preparation and Characterization of Trypsin Treated DIG-177 (LF Plus CTP).

Wild type DIG-177; SEQ ID NO:2) was digested with trypsin for 16 hours and run on an ion exchange column to remove the trypsin. The samples were analyzed by SDS-PAGE (as described in Example 2) under reducing-denaturing conditions. Undigested full-length material migrated at ˜54 kDa, a small amount of dimer appeared at approximately ˜108 kDa. DIG-177 can form detectable amounts of high molecular weight aggregates. The trypsin treated sample, before fractionation ran as a single band of approximately 43 kDa representing the LF, predicted to be residues 12-390, based on trypsin cleavage sites.

N-Terminal Sequencing.

The amino terminus of the LF was confirmed by Edman degradation N-terminal sequencing performed on a Shimadzu Protein Sequencer (Model PPSQ-33A) using basic Edman degradation chemistry. The protein sample was separated with SDS-PAGE under reducing condition, and then the proteins were blotted onto PVDF membrane by liquid transfer). The target protein bands were excised and loaded into a glass reaction chamber. Then chamber was inserted into the Sequencer and subjected to Edman degradation. A standard mix of 20 PTH-amino acids (Shimadzu, Kyoto, Japan) was run each time. The amino acid residues from each Edman degradation cycle were determined based on their retention times from the C-18 column compared to standards. This process was repeated sequentially to obtain the amino terminal sequence of the protein. Edman degradation determined the N-terminus of the LF to begin at residue 12 of SEQ ID NO:2.

Protein intact molecular weight analysis (as described in Example 2) was performed, without reduction, resulted in a dominant species with a mass of 46,844.19 Da and a minor species with a mass of 45,995.25 Da (Table 7). The de-convoluted intact MW avg. value of 46,844.19 Da matches the theoretical value (46,843.43 Da) expected for a protein containing polypeptide chains of 12-390 disulfide bonded to chain 444-475 (CTP1). The minor species with MW avg. of 45,995.25 Da matches the theoretical value of 45,996.51 for a protein containing polypeptide chains of 12-390 disulfide bonded to chain 451-475 (CTP2).

TABLE 7
Intact molecular weight anlaysis of Sample
1 under non-reducing conditions

| | Observed | PPM | Consistent | |
|---|---|---|---|---|
| Sample | Not Reduced | error | Residues | Predicted |
| DIG- | 46,844.19 Da | −16.2 ppm | 12-390 disulfide | 46,843.43 Da |
| 177 | Major | | bonded to chain | |
| Trypsin | | | 444-475 (CTP1) | |
| Treated | 45,995.25 Da | −5.4 ppm | 12-390 disulfide | 45,995.0 Da |
| | Minor | | bonded to chain | |
| | | | 451-475 (CTP2) | |

The intact molecular weight of the sample was determined following TCEP treatment (reducing conditions); two components were observed (Table 8). A major component at 42,729.71 Da, matches the theoretical mass of 42,729.4 for the trypsin treated DIG-177 LF (residues 12-390, no CTP). A minor component was also observed, with a mass of 46,844.14 Da, matching the mass of the LF with CTP1 still attached (incomplete reduction). The results indicate the CTP1 and 2 were largely removed by reduction with TCEP.

TABLE 8
Intact molecular weight anlaysis of
Sample 1 under reducing conditions.

| | Observed | PPM | Consistent | |
|---|---|---|---|---|
| Sample | Reduced | error | Residues | Predicted |
| DIG- | 42,729.71 Da | −7.2 ppm | 12-390 | 42,729.4 Da |
| 177 | Major | | | |
| Trypsin | 46,844.14 Da | −15.1 ppm | 12-390 disulfide | 46,843.43 Da |
| Treated | Minor | | bonded to chain | |
| | | | 444-475 (CTP1) | |

Sample 2: Preparation and Characterization of Trypsin Treated DIG-177 (LF with CTP Following Reduction).

Trypsin treated DIG-177 was purified under non-reducing conditions as described for Sample 1. DTT was added to the sample at a final concentration of 5 mM and incubated at room temperature for 10 minutes. The sample was then dialyzed overnight against 10 mM CAPS, pH 10, to remove the DTT to create Sample 2. Samples 1 and 2 were analyzed by SDS-PAGE using a 4-12% Bis/Tris gel and MOPS running buffer to obtain better resolution around 40 kDa. Under reducing conditions Sample 1 and Sample 2 (DTT treated), showed one band at the expected molecular weight of ˜43 kDa, consistent with the LF (12-390), a second band at the bottom of the gel are the CTP (CTP1 and CTP2 are not resolved under these conditions) having been released by disulfide reduction. Under non-reducing conditions, Sample 1 ran at expected molecular weight of ˜46 kDa consistent with the LF (residues 12-390) and the CTP being linked. Sample 2 (DTT treated, removed) showed two higher molecular weight bands, one at ˜43 kDa, consistent with the LF (residues 12-390); the second ˜46 kDa band, consistent with the LF plus CTP. A third band is present at the bottom of the gel which corresponds to the CTP. These results demonstrate that in Sample 2, most of the CTP is not linked to the large fragment; a fraction of the sample appears to be re-associated.

The spectrum without TCEP treatment showed three dominant peaks with measured MW avg. of 42,729.46, 45,994.89 and 46,844.14 Da (Table 9). The 42,729.46 peak matched the theoretical mass (42,729.0 Da) of the LF, residues 12-390. The 45,994.89 component matched the theoretical mass (45,995.0 Da) of the LF plus CTP2 (residues 12-390+451-475). The 46,844.14 component matched the theoretical MW avg. (46,843.72 Da) of the LF plus CTP1 (residues 12-390+444-475).

TABLE 9
Intact molecular weight anlaysis of Sample
2 under non-reducing conditions

| | Observed | PPM | Consistent | |
|---|---|---|---|---|
| Sample | Not Reduced | error | Residues | Predicted |
| DIG- | 42,729.46 Da | −1.4 ppm | 12-390 | 42,729.4 Da |
| 177 | Major | | | |
| Trypsin | 45,994.89 Da | +2.4 ppm | 12-390 | 45,995.0 Da |
| Treated | Minor | | disulfide | |
| | | | bonded to | |
| | | | chain 451-475 | |
| | | | (CTP2) | |
| | 46,844.14 Da | −15.1 ppm | 12-390 | 46,843.43 Da |
| | Minor | | disulfide | |
| | | | bonded to | |
| | | | chain 444-475 | |
| | | | (CTP1) | |

The spectrum with 50 mM TCEP treatment showed only one component with MW avg. of 42,729.27 (Table 10); the CTP were not captured in this spectrum window. These results confirmed the DTT treatment released the CTP, and after removing the DTT, a fraction of the CTPs re-associated with the LF.

TABLE 10
Intact molecular weight anlaysis of
Sample 2 under reducing conditions.

| | Observed | PPM | Consistent | |
|---|---|---|---|---|
| Sample | Not Reduced | error | Residues | Predicted |
| DIG-177 | 42,729.27 Da | +3.0 ppm | 12-390 | 42,729.4 Da |
| Trypsin | | | | |
| Treated | | | | |

Sample 3: Preparation and Characterization of the LF.

To separate the DIG-177 trypsin generated LF and the CTPs, IEC purification following trypsin digestion was performed under reducing conditions (5 mM DTT). The samples were analyzed by non-reducing SDS-PAGE. The trypsin treated, non reduced sample, migrated at the expected molecular weight of ˜46 kDa, consistent with the both the LF (12-390) linked to the CTP. The starting material sample (treated with DTT during preparation) migrated substantially faster and was consistent with the loss of the CTP. The LF minus the CTP was obtained in Fraction 3.

To verify the composition of Fraction 3, the sample was subjected to intact molecular weight analysis (Table 11). The spectrum without TCEP treatment showed a dominant species with a MW avg. of 42,729.76 Da and a minor component with 45,995.19 Da. The dominant component at 42,729.76 Da matched the theoretical MW avg. (42,729.0 Da) of the trypsin LF (residues 12-390), confirming the CTP were removed. The minor component at 45,995.19 Da matched the theoretical MW avg. of 45,995.0 Da of a second species composed of the LF (residues 12-390) and CTP2 (residues 451-475), indicating the reduction was not complete during purification. These results confirm the majority of the sample represents the LF without the CTP.

TABLE 11
Intact molecular weight anlaysis of
Sample 3 under reducing conditions.

| | Observed | PPM | Interpretation | |
|---|---|---|---|---|
| Sample | Not Reduced | error | Consistent Residues | Predicted |
| LF | 42,729.76 Da | −8.4 ppm | 12-390 | 42,729.4 Da |
| | Major | | | |
| | 45,995.19 Da | μ4.1 ppm | 12-390 disulfide | 45,995.0 Da |
| | Minor | | bonded to chain | |
| | | | 451-475 (CTP2) | |

Sample 4: Isolation and Characterization of the C-Terminal Peptides (CTP).

The trypsin digested DIG-177, purified under non-reducing conditions (see above), was treated with 5 mM DTT to release the C-terminal peptide. The treated sample was passed through a centrifugal filter device with 10 kDa MWCO (Millipore). The C-terminal peptide was present in the flow through while the large fragment was retained in the filtration unit. The flow through and retained sample were collected and the buffers were exchanged in 10 mM CAPS, pH 10, by dialysis.

The C-terminal peptide sample (Sample 4) was analyzed by MALDI-TOF/TOF MS to determine the peptide masses and subsequently fragmented in the LIFT mode to confirm the sequence of the peptide. The MALDI-TOF MS and MS/MS were conducted with Bruker UltraFlextreme™ mass spectrometer. The C-terminal peptide sample was diluted with 0.2% TFA (Trifluoroacetic acid) at 1:1 (v/v) and desalted using a C-18 Ziptip (Millipore). The peptides were eluted with 60% acetonitrile (ACN) in 0.1% TFA and mixed with 2,5-dihydroxybenzoic acid (DHB) matrix (15 mg/ml in ACN:H₂O (50:50)). After spotting 1 μL of the mix on a MALDI sample plate, the peptide mass was analyzed using reflection-positive mode and the peptide was fragmented using the LIFT mode. The instrument was calibrated with CM 2 (calibration mixture 2, Peptide mass standards kit, Applied Biosystems Sciex, Foster City, Calif.). The mass spectrum was collected and analyzed using flex analysis software. The sequence was verified using BioTools software (Bruker) and MASCOT search engine (Matrix Science, Boston, Mass.). MALDI MS showed three major peaks with masses of 4,114.894, 3,266.38, and 2,154.933 Da, and several minor peaks (Table 12). The peak at 4,114.89 m/z matched the theoretical mass 4,113.66 representing residues 444-475 (CTP1); the peak at 3,266.38 m/z matched the theoretical mass 3,265.26 representing residues 451-475 (CTP2). The peak at 2,154.933 m/z did not match any peptides from C-terminus and its origin has yet to be determined.

TABLE 12
Intact molecular weight analysis of
Sample 2 under reducing conditions

| | | | | Predicted |
|---|---|---|---|---|
| | Observed | PPM | Consistent | theoretical mass + |
| Sample | Not Reduced | error | Residues | H+ in Daltons |
| CTP | 4,114.89 m/z | +55.9 ppm | 444-475 | 4,113.66 + 1 |
| | Major | | | |
| | 3,266.38 m/z | +36.7 ppm | 451-475 | 3,265.26 + 1 |
| | Minor | | | |
| | 2,154.933 m/z | | | |
| | Minor | | | |

The two peptides, m/z 4,114.894 and 3,266.38 Da, were sequenced by MALDI MS/MS. The results confirmed the 4,114.894 peak had the sequence NSNLEYKCPENNFMIYWYNNSDWYNNSDWYNN (underlined residues were identified and assigned) which matched the CTP1 sequence of residues 444-475 of SEQ ID NO:51. The 3,266.38 peak had the sequence CPENNFMIYWYNNSDWYNNSDWYNN which matched the CTP2 sequence from residues #451-475 of SEQ ID NO:52.

Insecticidal Activity of Samples 1-4.

Non-diapausing WCR eggs (Crop Characteristics Inc., Farmington, Minn.) were incubated at 28° C. in soil for 10 days. These eggs were washed from soil with water, surface sterilized with 10% formaldehyde and triple rinsed with sterile water. These eggs were allowed to hatch and fed with a proprietary WCR diet. Overlay diet bioassays were conducted in 24-well titer plates with each well containing 1.5 mL of the artificial WCR diet. The test samples were applied onto diet surface at 100 μg/cm² dose (80 μL) (unless otherwise stated), and dried under room temperature in laminar flow. Treated diet surface of each well was infested with five D. virgifera neonates (24-48 hr old) and test insects were enclosed in the bioassay plate with Breathe Easy® gas permeable covers, the plate was sealed and held under controlled environmental conditions (28° C., 24 hr scotophase, 60-80% relative humidity). Twenty insects were tested per replicate. The number of live insects, dead insects, and pooled live weight of insects per treatment were recorded after five days incubation. The number of dead insects and the weight of surviving insects were recorded.

Percent mortality and percent growth inhibition were calculated for each treatment. Growth inhibition (GI) is calculated as follows:

GI=[1−(TWIT/TNIT)/(TWIBC/TNIBC)]

where TWIT is the Total Weight of Insects in the Treatment, TNIT is the Total Number of Insects in the Treatment, TWIBC is the Total Weight of Insects in the Background Check (Buffer control), and TNIBC is the Total Number of Insects in the Background Check (Buffer control). Negative controls were 20 mM sodium citrate buffer, pH 3.5, 10 mM CAPS buffer, pH 10, and 350 μg/cm² Cry1Fa. Positive controls were 100 μg/cm² Cry34/35Ab1 in sodium citrate buffer and/or 100 μg/cm² DIG-177 in CAPS buffer. Samples 1-4 from the trypsin treated DIG-177 were bioassayed at 100 μg/cm² (LC₅₀ DIG-177-40 μg/cm²). The bioassay results are summarized in Table 13, Cry1Fa and two buffer samples were used as negative controls. Full length DIG-177 was used as the positive control.

Sample 1, the large fragment+CTP showed insecticidal activity nearly equivalent to the full-length positive control. Sample 2, the large fragment with the CTP released, but present in the sample, had low but measurable activity demonstrating that treatment with DTT, followed by dialysis, substantially reduced insecticidal activity. The analytical mass spectrometry data show some of the CTP was associated with the large fragment to create an active toxin complex in these samples. Samples 3 and 4, the large fragment and the CTP were tested separately; in all cases, these samples did not show activity significantly different than the negative control at this single dose, indicating that both fragments are required.

TABLE 13
Insecticidal activity of trypsin treated DIG-
177 samples 1-4 against western com rootworm

| | % Growth | |
|---|---|---|
| Sample | Inhibition | % Mortality |
| DIG-177 (non treated Cry6Aa); Rep 1 | 99 | 94.7 |
| DIG-177 (non treated Cry6Aa); Rep 2 | 99 | 90 |
| Sample 1 (LF + CTP); Rep 1 | 95 | 56.2 |
| Sample 1 (LF + CTP); Rep 2 | 97 | 70 |
| Sample 2 (LF + CTP reduced); Rep 1 | 57 | 20 |
| Sample 2 (LF + CTP reduced); Rep 2 | 72 | 30 |
| Sample 3 (LF); Rep 1 | 0 | 0 |
| Sample 3 (LF); Rep 2 | 22 | 5 |
| Sample 4 (CTP); Rep 1 | 0 | 5 |
| Sample 4 (CTP); Rep 2 | 11 | 0 |
| Buffer Rep 2 | 0 | 0 |
| Buffer Rep 2 | 0 | 0 |
| Cry1F Rep 1 | 0.24 | 0 |
| Cry1F Rep 2 | 0.6 | 0 |
| Cry34/35 Rep 1 | 93 | 63 |
| Cry34/35 Rep 2 | 98 | 80 |

* Mean percent larval mortality and Mean percent growth inhibition of first instar western corn rootworm after exposure to 100 μg/cm². Negative controls were 350 μg/cm² Cry1Fa, 10 mM CAPS (pH 10) and 20 mM sodium citrate (pH 3.5) buffers while positive control was 100 μg/cm² Cry34/35Ab1.

TABLE 14
Dose response of TcdA, Cry34/35Ab1, and DIG-1000

| Dose Response | TcdA | Cry34/35Ab1 | DIG-177 | DIG-1000 |
|---|---|---|---|---|
| # Exper. Dates | 2 | 2 | 6 | 8 |
| # test larvae | 479 | 413 | 1034 | 1314 |

| | Estimate | CI or SE | Estimate | CI or SE | Estimate | CI or SE | Estimate | CI or SE |
|---|---|---|---|---|---|---|---|---|
| Mortality + | | | | | | | | |
| Moribund | | | | | | | | |
| LC50 | 4.5 | 3.6-5.7 | 69.3 | 42.8-112.2 | 15.5 | 13.9-17.2 | 61 | 55.9-66.6 |
| LC90 | 16.1 | 11.1-23.3 | out of range* | | 40.4 | 35.2-46.5 | 146.7* | 126.1-170.6* |
| Slope ^{c} | 1.01 | 0.14 | 0.49 | 0.07 | 1.35 | 0.09 | 1.46 | 0.12 |
| Normalized live | | | | | | | | |
| weight, pooled | | | | | | | | |
| (GI) | | | | | | | | |
| EC50 | 1.7 | 0.7-4.3 | 1.8 | 1.2-2.6 | 5.6 | 3.9-8.0 | 15.7 | 11.2-21.19 |
| EC90 | 16.7 | 3.5-79.1 | 14.2 | 6.9-29.4 | 26.4 | 17.0-40.8 | 124.9* | 74.4-209.8* |
| Slope | 0.97 | 0.44 | 1.06 | 0.19 | 1.42 | 0.26 | 1.06 | 0.16 |

*Values have been extrapolated beyond the tested rate range

### Example 4

### Genetic Deletion of the Carboxy Terminus of DIG-177

A series of five coding regions, DIG-137 (SEQ ID NO:53), DIG-138 (SEQ ID NO:55), DIG-147 (SEQ ID NO:57), DIG-148 (SEQ ID NO:59), and DIG-149 (SEQ ID NO:61), resulting in sequential deletions from the carboxy terminus of DIG-177 were constructed and expressed as described in Example 2. The recombinant proteins accumulated in the soluble fraction of the Pseudomonas host cells and were purified as follows: The recombinant protein containing cell paste from −80° C. freezer was transferred to −20° C. overnight, it was re-suspended in extract buffer (50 mM Tris, 5 mM EDTA, pH 8.0). It was mixed thoroughly with a homogenizer and sonicated in 5 cycles of 3 min using a 250 (Branson) Sonifier with a flat tip (probe) at a 30% duty cycle, followed by a 5 min break after each cycle on ice. After cell lysis, the mix was centrifuged at 22,000×g for 25 minutes at 4° C. The supernatant was filtered through 0.45 μm filters. The purification was a two-step chromatography protocol using ion exchange and hydrophobic interaction resins. First, the supernatant was injected into a Q column (5 mL HiTrap Q HP column from GE Healthcare, Piscataway, N.J.) pre-equilibrated in 50 mM Tris, 5 mM EDTA, pH 8.0, and proteins were eluted by 0-0.6 M NaCl salt gradient. Fractions were collected based on UV absorbance and checked by SDS-PAGE. Fractions containing the recombinant protein were pooled and diluted with buffer A plus 2 M ammonia sulfate at a 1:1 ratio, the final ammonia sulfate concentration reached 1 M. The sample was applied onto a Phenyl HIC column (5 mL HiTrap Phenyl FF high sub column from GE Healthcare), the proteins were eluted by 1-0 M (NH₄)₂SO₄ gradient. Fractions which contained the target protein were pooled and concentrated with 10 kDa MWCO centrifugal filter and dialyzed against 10 mM COPS, pH10. The protein concentration was determined by Bradford and Densitometry.

The compositions of the protein samples were confirmed by mass spectrometry as described in Example 3. The materials were tested for insecticidal activity against western corn rootworm as described in Example 3. The results show the deletion of the region from residues 444-475 (DIG-137) had activity similar to DIG-177 at the concentration tested. When treated with trypsin, DIG-137 showed decreased activity whereas DIG-177 retained activity when not reduced as shown in Example 3.

This observation demonstrated that the CTP was not specifically required for activity in the absence of trypsin treatment. Larger deletions (DIG-138, DIG-147, DIG-148, and DIG-149) showed less insecticidal activity than the DIG-177 control. Trypsin treatment of these samples reduced insecticidal activity beyond the non trypsin treated samples against WCR. These results were consistent with those of Wei et al, which showed carboxy terminal deletions of Cry6Aa, up to residue 382 maintained some activity against nematodes in the absence of proteolysis. These results confirmed the importance of stabilizing the DIG-177 polypeptide in the region between residues 390-475 to maintain potent insecticidal activity.

TABLE 14
Insecticidal activity of carboxy terminal deletions against WCR

| | | % Growth |
|---|---|---|
| Sample | % Mortality | Inhibition |
| DIG-177 | 100 | 100 |
| DIG-137 | 100 | 100 |
| DIG-137 + Trypsin | 10 | 0 |
| DIG-138 | 9 | 2 |
| DIG-138 + Trypsin | 0 | 0 |
| DIG-147 | 3 | 27 |
| DIG-147 + Trypsin | 6 | 16 |
| DIG-148 | 3 | 16 |
| DIG-148 + Trypsin | 7 | 9 |
| DIG-149 | 6 | 43 |
| DIG-149 + Trypsin | 3 | 7 |
| Cry1Fa (Negative Control) | 3 | −11 |
| 20 mM NaCitrate pH 3.5 (Negative Control) | 6 | 0 |
| 10 mM CAPS pH 10 (Negative Control) | 0 | 0 |
| Cry 34/35 (Positive Control) | 94 | 100 |

* Mean percent larval mortality and mean percent growth inhibition of first instar western corn rootworm after exposure to 100 μg/cm² of various samples, the average of two data sets. Negative controls were 350 μg/cm² Cry1Fa, 10 mM CAPS (pH 10) and 20 mM sodium citrate (pH 3.5) buffers while positive control was 100 μg/cm² Cry34/35Ab1.

### Example 5

### Study of the C88-C451 Disulfide Bond

To investigate the importance of the cys88-cys451 disulfide bond to insecticidal activity mutants DIG-616 (C163>A; (SEQ ID NO:39)) and DIG-984 (C88>A; 451>A; (SEQ ID NO:49)) were characterized as described in Examples 2 and 3. The DIG-616 and DIG-984 proteins were shown to have the expected molecular weight and number of disulfide bonds by mass spectrometry.

TABLE 15
Intact molecular weight analysis of DIG-177 mutants under non-reducing and reducing conditions.

| | | Observed | | | Observed | | | |
|---|---|---|---|---|---|---|---|---|
| | Expected | Avg. Mass | Mass | PPM | Avg. Mass | Mass | PPM | Interpretation |
| Sample | Avg. Mass | w/o TCEP | difference | Error | w/TCEP | difference | Error | Residues |
| DIG-177 | 54,075.9333 | 54,072.102 | 3.8313 | 70.85 | 54075.7579 | 0.1754 | 3.24 | 1-475 |
| | | | | | | | | 2 disulfides |
| DIG-616 | 54,043.8672 | 54,040.287 | 3.5802 | 66.25 | 54043.8329 | 0.0343 | 0.63 | 1-475 |
| C162 > A | | | | | | | | 2 disulfides |
| DIG-984 | 54,011.8011 | 54,010.263 | 1.5381 | 28.48 | 54012.054 | −0.2529 | −4.68 | 1-475 |
| C88 > A; | | | | | | | | 1 disulfide |
| 451 > A | | | | | | | | |

Both DIG-616 and DIG-984 had insecticidal activity against WCR at 100 ug/cm² equivalent to DIG-177 in diet bioassays (Table 17). When treated with trypsin, DIG-616 maintained insecticidal activity whereas DIG-984 less insecticidal activity than either DIG-616 or DIG-177 when treated with trypsin. Mass spectrometric analysis showed trypsin treated DIG-616 retained the CTP and DIG-984 lost the CTP confirming the requirement of the peptide for western corn rootworm activity (Table 16) following proteolysis and the limited affinity of the LF and CTP in the absence of the disulfide bond.

TABLE 16
Intact molecular weight anlaysis of DIG-177 mutants following digestion
with trypsin under non-reducing and reducing conditions

| | Mass in | Consistent | | Mass in | Consistent | |
|---|---|---|---|---|---|---|
| | Daltons | Residues Non- | PPM | Daltons | Residues | PPM |
| Sample | Not Reduced | Reducing | error | Reduced | Reducing | error |
| DIG-616 | 46,811.34 | 12-390 + 444-475 | −9.92 | 42,696.84 | 12-390 | −10.87 |
| C162 > A | 45,962.33 | 12-390 + 451-475 | | | | |
| | 43,372.88 | 16-400 | | | | |
| DIG-984 | 42,697.00 | 12-390 | | 42,697.00 | 12-390 | −9.92 |
| C88 > A; | | | | | | |
| 451 > A | | | | | | |

TABLE 17
Insecticidal activity of DIG-177 and mutants with
and without trypsin treatment against WCR

| | | | % Growth |
|---|---|---|---|
| Sample | Replications | % Mortality | Inhibition |
| DIG-177 | 6 | 100.0 | 100 |
| DIG-177 | | 100.0 | 100 |
| DIG-177 | | 95.0 | 99 |
| DIG-177 | | 100.0 | 100 |
| DIG-177 | | 80.0 | 94 |
| DIG-177 | | 90.0 | 99 |
| DIG-177 Trypsin Treated | 2 | 95.0 | 99 |
| DIG-177 Trypsin Treated | | 85.0 | 88 |
| DIG-616 | | 87.5 | 97 |
| DIG-616 | | 100.0 | 100 |
| DIG-616 Trypsin Treated | | 95.0 | 99 |
| DIG-616 Trypsin Treated | | 95.0 | 100 |
| DIG-984 | | 85.0 | 84 |
| DIG-984 | | 78.3 | 98 |
| DIG-984 | | 80.0 | 97 |
| DIG-984 | | 90.0 | 100 |
| DIG-984 Trypsin Treated | | 0.0 | 22 |
| DIG-984 Trypsin Treated | | 0.0 | 43 |
| DIG-984 Trypsin Treated | | 21.1 | 16 |
| DIG-984 Trypsin Treated | | 15.0 | 34 |
| Buffer Avg of 8 reps | | 7 | 0.000 |
| Cry1F Avg of 6 reps | | 9.5 | 0.11 |

* Mean percent larval mortality and mean percent growth inhibition of first instar western corn rootworm after exposure to 100 μg/cm² of various samples. Negative controls were 350 μg/cm² Cry1Fa, 10 mM CAPS (pH 10) and 20 mM sodium citrate (pH 3.5) buffers while positive control was 100 μg/cm² DIG-177.

### Example 6

### Proteinase K Digestion of DIG-177

The proteolytic susceptibility of the DIG-177 protein was determined using proteinase K. (Proteinase K has been shown to have broader specificity than trypsin, cleaving on the carboxyl side of aliphatic and aromatic residues, whereas trypsin cleaved at lysine and arginine residues.) The DIG-177 sample protein was prepared as described in Example 2. It was digested in 50 mM Tris, pH7.5, 2 mM CaCl₂) at a concentration 1 mg/mL at a 40:1 mass ration to proteinase K (SIGMA-ALDRICH, St. Louis, Mo.) with gentle rocking at 20° C. Time point samples were taken at 0, 5, 10, 30, 50, and 90 minutes with the digestions terminated by adding PMSF to a final concentration of 5 mM. The 0 time point was taken immediately after proteinase K was added to the sample. Samples were analyzed by SDS-PAGE, mass spectrometry, and insect bioassay as described in Examples 2 and 3.

Digestion of full length DIG-177 to 50 minutes, under these conditions, resulted in a large fragment of approximately 43 kDa. Due to the broad specificity of proteinase K, the peptides endpoints were heterogeneous ranging, at the amino terminus, of residues 5-73 and the carboxyl terminus, of residues 386-456. Depending on the peptide endpoints, in some cases the CTP fragments were linked to the large fragment by the C88-C451 disulfide bond. The proteinase K regions of susceptibility were found to be consistent with the trypsin results presented in Example 3.

### Example 7

### Characterization of DIG-177 Internal Deletions for Insecticidal Activity and Proteinase K Stability

Three series of sequential deletions were made across the proteolytically processed region of DIG-177, residues ˜390-443 of SEQ ID NO: 2. The first deletion set was 5 amino acids resulting in proteins (DIG-921 to 927 (SEQ ID NOs:64, 66, 68, 70, 72, 74, 76) and DIG-931 (SEQ ID NO:78), the second 10 (DIG-969 to 973 (SEQ ID NOs:80, 82,84, 86, 88)), the third (DIG-985 to 997 (SEQ ID NOs:90, 92, 94, 96, 98, 100, 102, 104, 106, 108, 110, 112 114)) was 15, 20, 25, and 43 residues. Each series was expressed in Pseudomonas, purified, and tested for insecticidal activity against western corn rootworm as described in Examples 2 and 3. The stability of the proteins was determined by digestion with proteinase K digestion as described above. In all cases, the mutant proteins had insecticidal activity. The proteins were approximately as susceptible to proteinase K as DIG-177; a notable exception is DIG-995 (SEQ ID NO:110), a 43 amino acid deletion which showed less digestion.

TABLE 18
Description of DIG-177 deletions

| | | Residues Deleted |
|---|---|---|
| SEQ ID NO: | Protein Name | from DIG-177 |
| 2 | DIG-177 | None |
| 64 | DIG-921 | 391-395 |
| 66 | DIG-922 | 396-400 |
| 68 | DIG-923 | 401-405 |
| 70 | DIG-924 | 406-410 |
| 72 | DIG-925 | 411-415 |
| 74 | DIG-926 | 416-420 |
| 76 | DIG-927 | 421-425 |
| 78 | DIG-931 | 441-445 |
| 80 | DIG-969 | 391-400 |
| 82 | DIG-970 | 401-410 |
| 84 | DIG-971 | 411-420 |
| 86 | DIG-972 | 421-430 |
| 88 | DIG-973 | 431-440 |
| 90 | DIG-985 | 391-405 |
| 92 | DIG-986 | 406-420 |
| 94 | DIG-987 | 421-435 |
| 96 | DIG-988 | 429-443 |
| 98 | DIG-989 | 391-410 |
| 100 | DIG-990 | 411-430 |
| 102 | DIG-991 | 424-443 |
| 104 | DIG-992 | 391-415 |
| 106 | DIG-993 | 415-440 |
| 108 | DIG-994 | 419-443 |
| 110 | DIG-995 | 401-443 |
| 112 | DIG-996 | 391-433 |
| 114 | DIG-997 | 391-414; 425-443 |

### Example 8

### Crystal Structure Determination of Trypsin Treated DIG-177

Inclusion Body (IB) Preparation.

Pseudomonas fluorescens derived cell paste expressing full length, DIG-177 (SEQ ID NO:2) was transferred from −80° C. storage to 4° C. and resuspended at 20% w/v in cold lysis buffer (50 mM Tris, 200 mM NaCl, 10% glycerol, 0.5% Triton X-100, 20 mM EDTA, 1 mM TCEP, pH 7.5) and mixed thoroughly with a hand held homogenizer. The suspension was then passed through a Microfluidizer (M-110EH) twice at 16,000 psi then centrifuged (SLC-6000 rotor/14,000 g/40 minutes/4° C.). The supernatant was discarded. The inclusion body pellet was resuspended in 10% w/v room temperature lysis buffer with 0.4 g/L Lysozyme (L-6876; Sigma-Aldrich) and fully resuspended by homogenization. The suspension was incubated at 30° C. for 30 minutes, with brief homogenizations every 10 minutes. The inclusion bodies were then centrifuged (SLC-6000 rotor/14,000 g/40 minutes/4° C.) and the supernatant discarded. The pellet was resuspended for a final time in 10% w/v cold lysis buffer using the homogenizer and centrifuged (SLC-6000 rotor/14,000 g/40 minutes/4° C.) and the supernatant discarded. The inclusion body pellet was suspended in 10% w/v in cold lysis buffer without Triton X-100 (50 mM Tris, 200 mM NaCl, 10% glycerol, 20 mM EDTA, 1 mM TECP, pH 7.5) using the homogenizer and centrifuged (SLC-6000 rotor/14,000 g/40 minutes/4° C.) and the supernatant discarded; this step was repeated. The inclusion bodies were either resuspended to 30% (w/v) in 10 mM EDTA, pH 8.0, or aliquoted into 1.5 mL aliquots and frozen at −80° C. until needed.

Preparation of the DIG-177 Trypsin Core.

Eight, 2 ml tubes of IB suspension of full length, DIG-177 were thawed and extracted in 80 ml final volume (1:5 dilution) of 10 mM CAPS, pH 11.0. The pH was measured at 9.1 and then adjusted to 11.0 with NaOH. To the extract, 50 mg of freshly prepared trypsin (25 mg/ml Trypsin solution (Sigma, T1426-1G TLCK treated) in (1 mM HCl, 5 mM CaCl₂). The pH was maintained at 11.0 and stirred overnight at 4° C.

The solution was applied to a Source 15Q 16/10 column pre-equilibrated in buffer A (25 mM CAPS, pH 11.0) at a flow rate of 10 mL/minute and eluted with a gradient of Buffer A+1 M NaCl over 75 minutes. Truncated DIG-177 eluted as a single, large peak, which was concentrated from 100 mL to 10 mL using four, 15 ml Amicon 10,000 MWCO spin concentrators in a JA-12 rotor at 4° C. and 5000×g. The concentrated ion exchange sample was applied to a Superdex 75 26/90 gel filtration column pre-equilibrated in 25 mM CAPS, pH 11.0, and 50 mM NaCl. The sample was eluted using a 2.5 mL/minute flow rate. The fractions contained in the large DIG-177 core peak were pooled (80 mL at 2.05 mg/mL).

Preparation of Full Length DIG-177.

About 500 mg of IB was thawed at 4° C., and centrifuged at 23,000×g for 25 min at 4° C. The supernatant was removed and the IB pellet was solubilized in 30 mL, 100 mM CAPS, pH 11.0, and the suspension was gently rocked for two hours at room temperature to solubilize the DIG-177 protein. After solubilization, the mix was centrifuged at 23,000×g for 25 min at 4° C. The supernatant was dialyzed against 25 mM CAPS, pH 10.0, overnight.

The buffer exchanged DIG-177 sample was then filtered through a 0.22 micron syringe filter and applied to a Source 15Q 16/6 ion exchange column at 5 mL/min flow rate. The column pre-equilibrated with buffer A (25 mM CAPS, pH 10). Protein was eluted with a step gradient of 20%, 30%, 40%, and 50% buffer B (buffer A+1M NaCl). Each elution was ˜50 mL. Fractions were collected from each elution based on UV absorbance and analyzed by SDS-PAGE.

Full length DIG-177 was in the 20% B fractions which were pooled and concentrated to ˜30 mL using a centrifugal filter devices with 10 kDa molecular weight cut off membrane (Millipore).

The concentrated sample was further purified by size exclusion chromatography. For each run, 4.0 mL of the sample was applied over a Superdex 75 26/90 gel filtration column pre-equilibrated in 25 mM CAPS, pH 10, 50 mM NaCl buffer, at a flow rate of 2.5 mL/min. Two peaks were observed; the first peak, eluted at the void volume and contained DIG-177 dimers. The fractions from peak 2 contained predominantly monomer. The fractions from peak 2 were pooled separately and submitted for crystallization experiments.

Protein Concentration Determination.

BCA assay (Pierce Life Technologies, Grand Island, N.Y.) was performed according to the manufacturer's instructions except a 1000 μL working reagent was added to a 50 μl sample. Bradford Protein Assay (Bio-Rad, Hercules, Calif., USA) was performed according to the manufacturer's instructions except a 1000 μL working reagent was added to a 20 μL sample.

Crystallization, Data Collection and Structure Determination of the DIG-177 Trypsin Core.

The DIG-177 trypsin core was concentrated to 100 mg/mL. Initial crystals were obtained using Rigaku Reagents, Inc. Wizard Classic I (Bainbridge Island, Wash.). After screening multiple conditions, suitable crystals were obtained from 20% (w/v) PEG 1000, 0.1 M Na Phosphate/citric acid, pH 4.2; 0.2 M Lithium sulfate. Data were collected at 100 K from a single crystal on a Mar CCD-300 detector at LS-CAT (Advanced Proton Sources, Argonne National Laboratory). The cell constants were a=112.07, b=112.07, c=76.6, α=90.0, β=90.0, γ=120.0. The initial data collections at the home source suggested space group P6₅ or P6₁; therefore, the data was initially processed in P6₅. However, subsequent analysis led to the realization that the space group was P6₃.

The structure of the truncated form of DIG-177 toxin was solved by molecular replacement method using PHASER (1) (CCP4 package (Winn, M. D. et al., 2011) followed by manual rebuilding and model refinement. The poly-alanine chain of the crystal structure of Hemolysin B from Bacillus cereus (Protein Data Bank entry 2NRJ) consisting of residues 19-334 was used as a search model. The final model was obtained by carrying out several cycles of refinement consisting of manual model building using COOT (Emsley et. al., 2010), followed by restrained refinement with REFMAC (Murshudov et. al., 1997).

TABLE 19
Crytallagraphic data collection and refinement statistics
for the DIG-177 trypsin treated (PDB:).

| Wavelength (Å) | 1.1276 | |
|---|---|---|
| Resolution range (Å) | 33.3-1.764 | (1.827-1.764) |
| Space group | P 65 | |
| Unit cell (a, b, c) | 112.965, 112.965, 76.628 | |
| Total reflections | 41,916 | |
| Unique reflections | 41,898 | (352) |
| Multiplicity | 3.4 | (1.2) |
| Completeness (%) | 76.59 | (6.48) |
| <I>/sigma(I) | 20.12 | (2.59) |
| Wilson B-factor | 25.73 | |
| R-merge (%) | 5.4 | (36.3) |
| R-work^{a} (%) | 15.8 | (22.9) |
| R-cryst^{b} (%) | 22.0 | (34.9) |

| | |
|---|---|
| Number of non-hydrogen atoms | 3,556 |
| Macromolecules | 3,165 |
| Ligands | 0 |
| Water | 391 |
| Protein residues | 402 |
| RMS(bonds) | 0.006 |
| RMS(angles) | 0.89 |
| Ramachandran favored (%) | 97 |
| Ramachandran outliers (%) | 0 |
| Clashscore | 3.03 |
| Average B-factor | 37.60 |
| Macromolecules | 36.80 |
| Ligands | 0 |
| Solvent | 44.70 |

^{a}R_{merge} = 100Σ(h)Σ(i)|I(i) − <I>|/Σ(h)Σ(i)I(i) where I(i) is the ith intensity measurement of reflection h, and <I> is the average intensity from multiple observations.
^{b}R_{cryst} = Σ||F_{obs}| − |F_{cacl}||/Σ|F_{obs}|. Where F_{obs} and F_{calc} are the structure factor amplitudes from the data and the model, respectively. R_{free} is R_{cryst} with 10% of the structure factors.

Crystallization, Data Collection, and Structure Determination of the Full Length DIG-177.

Full-length DIG-177 protein was concentrated to 15 mg/ml using Amicon centrifugal filter with a 10 kDa molecular weight cut-off (Millipore) in 10 mM HEPES buffer, pH 7.5, and 25 mM NaCl. Initial crystallization screens were performed using commercially available Classics, Classics Lite, Classics II, PEG's, PEG's II, PhClear and PACT screens (Hampton Research, Aliso Viejo, Calif.) by the sitting drop method in 96-round bottom well crystallization plates (Greiner Bio-One, GmbH, Germany) using a Mosquito Robotic System (TTP LabTech, Hertfordshire, U.K.). Diffraction quality DIG-177 protein crystals were grown at 291 K from sitting drops containing 3 μL of the protein sample and 1.5 μL of reservoir solution (0.1 M citric acid, pH 4.6, 4% PEG 6,000). SDS-PAGE analysis of protein samples obtained by dissolving the crystals in SDS-buffer did not reveal any degradation products and confirmed the presence of only full-length DIG-177 protein in the 3s used for the data collection.

For data collection, crystals were harvested with 20% (v/v) glycerol in the reservoir solution. Diffraction data were collected at 100 K from a single crystal on a Mar CCD-300 detector at LS-CAT (Advanced Proton Sources, Argonne National Laboratory). Data were indexed and processed with HKL-2000 (Z. Otwinowski and W. Minor, 1997). The crystals belonged to orthorhombic space group P21212 and contained one molecule of full-length DIG-177 per asymmetric unit.

The structure of full-length DIG-177 was solved by molecular replacement using PHASER (McCoy, A. J. J. Appl. Cryst. (2007)) with the structure of the truncated form of DIG-177 as a search model. The final model of full-length DIG-177 toxin was obtained by carrying out several cycles consisting of manual model building using COOT (Winn, M. D. et al., 2011), followed by structure refinement with REFMAC (Murshudov et, al., 1997).

TABLE 20
Data collection and refinement statistics for full
length DIG-177 (PDB: Ronda to check submission)

| Wavelength (Å) | 0.9876 | |
|---|---|---|
| Resolution range (Å) | 50-2.7 | (2.8-2.7) |
| Space group | P 21 21 2 | |
| Unit cell (α, β, γ, a, b, c) | 50.4, 71.7, 143, 90, 90, 90 | |
| Total reflections | 97894 | |
| Unique reflections | 14755 | |
| Multiplicity | 6.6 | (7.1) |
| Completeness (%) | 99.50 | (100.00) |
| I/sigma(I) | 10.98 | (2.88) |
| Wilson B-factor | 55.48 | |
| R-sym | 0.16 | (0.907) |

| | |
|---|---|
| R-work^{a} (%) | 28.35 |
| R-cryst^{b} (%) | 34.40 |
| Number of atoms | 3,038 |
| Protein residues | 393 |
| Water molecules | 43 |
| RMS(bonds) | 0.014 |
| RMS(angles) | 1.62 |
| Ramachandran favored (%) | 97 |
| Ramachandran outliers (%) | 0 |
| Average B-factor | 82.30 |

^{a}R_{merge} = 100Σ(h)Σ(i)|I(i) − <I>|/Σ(h)Σ(i)I(i) where I(i) is the ith intensity measurement of reflection h, and <I> is the average intensity from multiple observations.
^{b}R_{cryst} = Σ||F_{obs}| − |F_{calc}||/Σ|F_{obs}|. Where F_{obs} and F_{calc} are the structure factor amplitudes from the data and the model, respectively. R_{free} is R_{cryst} with 10% of the structure factors.

The Molecular Structure of Trypsin Treated DIG-177 and Full-Length DIG-177.

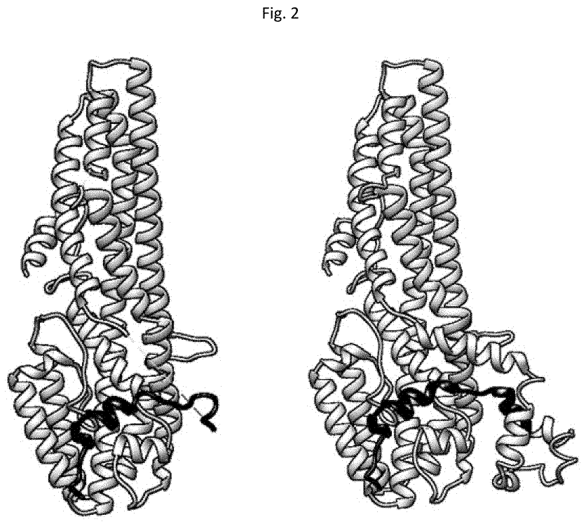

The ribbon diagram of the molecular structure of trypsin treated Cry6Aa (DIG-177) shown in FIG. 2 consists of an alpha helical bundle core with an alpha helical hairpin structure folded up onto the bundle. Structurally DIG-177 was recognized as an alpha helical hemolysin and shares structural similarity to Escherichia coli hemolysin E (1QOY; Wallace 2000) and the B component of hemolysin BL from Bacillus cereus (2NRJ; Madegowda et al 2008).

The molecular structure of full-length DIG-177 was nearly superimposable with the trypsin treated structure; the residues between 125-128 and 387-451 were not resolved; the residues between 387-452 were modeled. The structures are shown in FIG. 2.

### Example 9

### Construction of Proteolytically Stable DIG-177 Variants

Cry6Aa (DIG-177) has been shown to be a crystal protein from Bacillus thuringiensis which has insecticidal activity against western corn rootworm (Diabrotica virgifera virgifera) in diet bioassays. Proteolysis in the region approximately between residues 390-451, leads to a reduction of insecticidal activity. To limit proteolytic susceptibility of DIG-177, the 3D molecular structure was used to design replacement linkers for this region. The segment replaced with the linkers used several endpoints between residues 381 and 457. Some of the linkers were modeled using the loop modeler function of the MOE (Molecular Operating Environment) software from the Chemical Computing Group (Montreal, Quebec, Canada).

The new designs were expressed in Pseudomonas, purified, and tested for insecticidal activity and relative proteinase K resistance as described in Examples 4, and 6. This work demonstrated that several variants had both insecticidal activity and increased resistance to proteinase K than the parent protein DIG-177.

TABLE 21
DIG-177 variants tested to provide increased protease resistance

| | | | Insecticidal | | Relative |
|---|---|---|---|---|---|
| SEQ ID | | | Activity | | Proteinase K |
| NO | Protein | Linker Sequence | % Mortality | | Resistance |
| 2 | DIG-177 | TLN/AYSTNSRQNLPINVISDSCN | 100 | 100 | 0 |
| | | CSTTNMTSNQYSNPTTNMTSNQYM | | | |
| | | ISHEYTSLPNNFMLSRNSNLEYKC | | | |
| | | PENNF/MIY | | | |
| 116 | DIG-1000 | TLNAYS/VATITSG/--ENNFMIY | 85 | 95 | + |
| 118 | DIG-1049 | TLNAYS/VATITSGE/----FMIY | 100 | 100 | + |
| 120 | DIG-1052 | TLNAY-/ATITSG/---ENNFMIY | 100 | 100 | + |
| 122 | DIG-1038 | TLN---/WVIYNEFV/-----MIY | 16 | 20 | ND |
| 124 | DIG-1055 | TLNAYS/WVIYNEFV/--NNFMIY | 35 | 15 | + |
| 126 | DIG-1039 | TLN---/GWVIYNEFVG/---MIY | 10 | 15 | + |
| 128 | DIG-1056 | TLNAY-/GWVIYNEFVG/-NFMIY | 70 | 60 | ND |
| 130 | DIG-1040 | TLN---/GDSSIKKDG/---FMIY | 35 | 20 | ND |
| 132 | DIG-1057 | TLNAY-/GDSSIKKDG/-NNFMIY | 86 | 90 | ND |
| 134 | DIG-1041 | TLN---/GDPSIKKDG/---FMIY | 0 | 20 | ND |
| 136 | DIG-1058 | TLNAY-/GDPSIKKDG/-NNFMIY | 35 | 30 | + |

The linker sequence is shown between the slash marks.
Insecticidal activity against western corn rootworm is shown as % mortality and relative protease K resistance were determined using the proteinase K assay described in Example 6 (0 =similar proteinase K susceptibility to DIG-177;
+ = increased proteinase K resistance over DIG-177).
-- are deletions within the DIG-177 protein.

### Example 10

### Characterization of DIG-1000

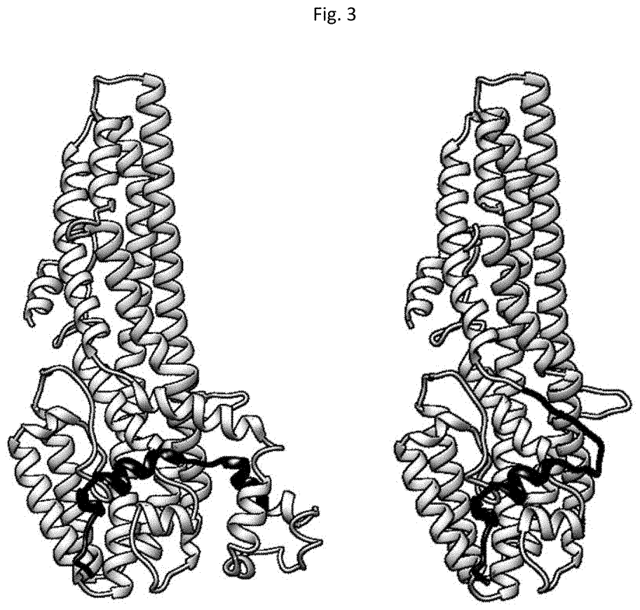

DIG-1000 (SEQ ID NO:116), a new variant of Cry6Aa that has replaced residues threonine 387 to proline 452 with the 7 residue linker: VATITSG, was prepared. The linker region was selected using the 3D crystal structure for the DIG-177 trypsin core and the loop modeler function of the MOE (Molecular Operating Environment) software from the Chemical Computing Group (Montreal, Quebec, Canada). The linker was designed to limit proteolysis by replacing the larger susceptible loop with a shorter less susceptible segment (see FIG. 3).

DIG-1000 was expressed in Pseudomonas, purified, and bioassayed as described in Example 3. DIG-1000 was shown to have insecticidal activity against western corn rootworm.

TABLE 22
Insecticidal activity of DIG-177 and DIG-
1000 against western corn rootworm

| | | % Mortality |
|---|---|---|
| | Dose | Average of 4 |
| Sample | Micrograms/cm2 | Replicates |
| DIG-177 | 100 | 99 |
| DIG-177 | 33 | 88 |
| DIG-177 | 11 | 18 |
| DIG-1000 | 100 | 85 |
| DIG-1000 | 33 | 28 |
| DIG-1000 | 11 | 6 |
| Buffer | 0 | 8 |
| Cry1F | 350 | 6 |

Proteinase K Resistance.

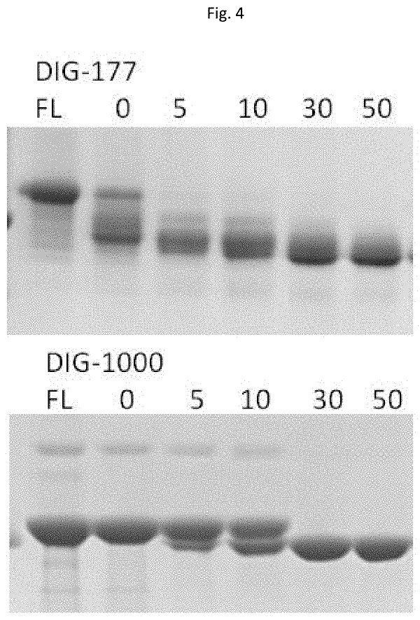

DIG-177 and DIG-1000 were expressed and purified as described in Example 3. The proteins were tested for susceptibility to proteinase K resistance (FIG. 4) as in Example 6. DIG-177 (54.2 kDa) showed substantial partial degradation at the T=0 time point (proteinase added, sample immediately withdrawn). The degradation continued until a proteolytically stable core was observed at 90 minutes. In contrast, DIG-1000 (47.3 kDa) did not show degradation at T=0, some partial degradation was observed at T=5 minutes, approximately 50 percent of the full length protein was converted at 10 minutes. Conversion to a proteolytically stable core was complete at 50 minutes. These data confirmed that DIG-1000 is substantially more resistant to proteinase K in vitro.

### Example 11

### Transient Maize Expression of DIG-1000

The transient expression of DIG-177 and DIG-1000 was tested using particle bombardment of immature maize (B104) embryos harvested 10-12 days post pollination (WO 2014/028295 A; US 2012/0060238 A1). The coding regions of DIG-177 (SEQ ID NO:1) and DIG-1000 (SEQ ID NO:115) were rebuilt, as described in Example 1, to reflect a maize codon bias for transient testing in maize cells resulting in SEQ ID NO:3 and SEQ ID NO:137 respectively. A transit peptide (TraP), to direct the expressed proteins to the chloroplast compartment, was also tested on DIG-177 and DIG-1000. The modified coding regions are shown in SEQ ID NO:32 and SEQ ID NO:139 resulting in polypeptides SEQ ID NO:33 and SEQ ID NO:140 respectively.

Expression was directed from a pUC-based plasmid containing the maize ubiquitin promoter, the coding region of interest, and the maize peroxidase 5 3′ untranslated region as shown in Table 23. Yellow fluorescent protein and PAT (phosphinothricin acetyl transferase) expressing plasmids were used as expression controls.

TABLE 23
Plasmids used for maize embryo transient expression

| | Description (promoter/CDS/3′ | |
|---|---|---|
| Plasmid | Untranslated Region) | Details |
| pDAB112771 | ZmUbi1/DIG-177 Zm/ZmPer5 | DIG-177 |
| DASDNA522 | ZmUbi1 v2/DIG-952/ZmPer5 | DIG-177 + |
| | | TraP8 |
| pDAB122665 | ZmUbi1 promoter/DIG-1000/ZmPer5 | DIG-1000 |
| pDAB122666 | ZmUbi1 promoter/TraP8 | DIG-1000 + |
| | DIG-1000/ZmPer5 | TraP8 |
| pDAB8393 | ZmUbi/YFP::OsAct/PAT | Yellow |
| | | Fluorescent |
| | | Protein |
| pDAB112364 | OsUbi3 promoter v3/PAT v6/ZmLip | phosphinothricin |
| | | acetyl |
| | | transferase |
| pDAB126939 | ZmUbi1 promoter/ | DIG-1036 + |
| | DIG-1036 + ERLS/ | ERLS |
| | ZmUbi1::ZCZ018::SCBV(MAM)/ | |
| | AAD-1 v3/ZmLip | |
| pDAB126940 | ZmUbi1/DIG- | DIG-1036 + |
| | 1036 + VLS/ | VLS |
| | ZmUbi1::ZCZ018::SCBV(MAM)/ | |
| | AAD-1 v3/ZmLip | |

A gold particle stock was prepared by weighing 50 mg of 0.6 μm or 1 μm gold macrocarriers (Bio-Rad, Hercules, Calif.) in a sterile 2.0 ml microfuge tube. The particles were washed three times with ethanol followed by three washes with sterile water, at each wash the material was collected by spinning in a microcentrifuge at 1500 g for 2 minutes. The particles were suspended in 500 μl sterile 50% glycerol and stored at −20° C.

Surface sterilized B104 immature ears were used for the isolation of embryos. Immature embryos (10-12 days post pollination; 1.8-2.4 mm) from 3-4 ears were isolated into 2 ml microfuge tubes containing 1.75 ml of liquid either 2.2-4.3 g/L MS salts (Murshige and Skoog, 1962) and 1 ml/l modified MS vitamin solution (1000×) or 4.3 LS media (Linsmaier and Skoog, 1965) and 1 ml/l Chu N6 vitamin solution (1000×), 68.4 g/l sucrose, 36 g/l glucose, 100-700 mg/l L. proline, and with or without 1.5 mg/l 2, 4 D (2,4-dichlorophenoxyacetic acid).

After embryo isolation, the liquid medium was removed and discarded. Embryos were then cultured onto petri plates containing a semi-solid media for osmotic treatment. This media consisted of 4.3 g/l MS salts, 1 ml/l modified MS vitamin solution (1000×), 500 mg/l MES, 100 mg/l myo-inositol, 100 mg/l casein enzymatic hydrolysate, either 120 g/l sucrose or 45 g/l of each sorbitol and mannitol, either with or without 3.3 mg/l dicamba, 15 mg/l silver nitrate, and 2.5 g/l gelzan (gelrite). The embryos were arranged in 5×8 square grids within the target area for particle bombardment. All plates were incubated for 24 hours prior to particle bombardment in a 24 hour, under 50 μM low light chamber at 27° C.

Prior to coating the gold particles, each of the DNA were mixed from constructs of interest with a control construct containing the standard gene PAT in a 1:1 ratio. In addition, DNA from a construct containing a YFP gene was used for transformation as a visual control. Each of the tubes containing 50 μl of gold particles stock from above was suspended into a sterile 2.0 ml tube. The following were added to each of the gold particles tubes: Test construct DNA (5 μg)/Control construct DNA (5 μg) of pDAB112364, 50 μl of 2.5 M CaCl₂ and 20 μl of 0.1 M Spermidine. The tubes were then vortexed at high speed for 10-15 minutes at room temperature. Followed by three washes with 200 μl of 100% ethanol and finally the coated gold particles were resuspended in 30 μl of 100% ethanol and all tubes were placed on ice.

Two macrocarriers for each of the constructs tested were labeled and 5 μl of the DNA/Gold mixture was spread evenly over the center of a macrocarrier and allowed to dry for 10 minutes. Rupture disks ranging between 650-1100 psi (Bio-Rad, Hercules, Calif.) were sterilized with 70% propanol and allowed to partially dry before bombardment. Two plates containing 40 embryos for each of the constructs were bombarded. Bombarded embryos were kept on the same media and incubated for 24 hours, under 50 μM low light conditions at 27° C. overnight.

After 24 hours of bombardment, transformed embryos with control construct pDAB100286 were observed for YFP expression. This control was used to monitor DNA/gold coating process as well as the particle bombardment process. After confirming YFP expression in control embryos, two plates from each of the constructs tested were sampled for protein analysis. Each sample contained 20 embryos allowing multiple technical replicates for protein analysis as well as for the transformation process. A total of four samples for each of the constructs were submitted for protein analysis.

After bombardment and incubations the samples were stored in a 96 well cluster tube rack at −80° C. until the day of analysis. Two Daisy™ steel BB's and 300 μl of extraction buffer (PBS solution containing 0.05% of Tween 20 and 5 μl/ml of Sigma protease inhibitors, catalog number 9599) was added to each tube. The samples were milled in a Kelco bead mill for 3 minutes, on maximum setting. Samples were centrifuged at 3,000×g for 5 minutes; 100 μl of the supernatant was transferred to an empty sample tube.

Conventional electrophoresis and blotting (Gallagher, S. et. al., 2008) methods were used with Invitrogen™ devices and basic reagents. A rabbit anti-Cry6a antibody was the primary antibody for the detection of Cry6a. All proteins were detected with a Cy3 fluorescence detection system and scanned using a GE Typhoon™ imaging system (GE Healthcare, Pittsburgh, Pa.).

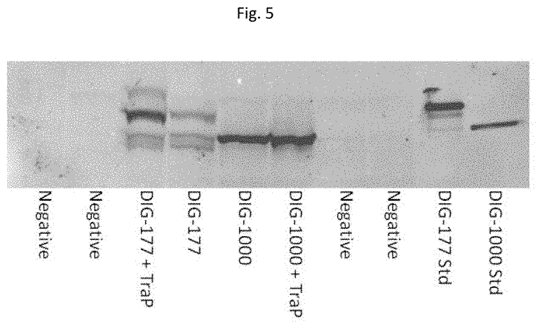

The results of the expression experiments are shown in FIG. 5. Western analysis shows no expression of Cry6Aa proteins in the negative controls, which included non-bombarded maize embryos, and those bombarded with YFP and PAT plasmids. The two far right lanes are protein standards of DIG-177, full length Cry6Aa (54.1 kDa) and DIG-1000 (47.3 kDa). The DIG-177+TraP lane contains a faint band above the standard, likely representing the precursor protein. Three other bands are present, one close to the DIG-177 standard in size while the others are substantially smaller, likely indicating partial degradation; the DIG-177 lane shows a similar pattern, however without the putative precursor protein. The DIG-1000 and DIG-1000+TraP look identical with single bands that appear to migrate with the DIG-1000 standard (accounting for some distortion of the end lanes of the gel). These data are consistent with the DIG-1000 coding sequence expressing a plant cell stable, insecticidal protein useful for western corn rootworm control.

### Example 12

### Stable Dicot Expression of DIG-1000 Insecticidal Toxin

Arabidopsis Transformation.

Arabidopsis thaliana Col-01 is transformed using the floral dip method (Weigel and Glazebrook, 2002). The selected Agrobacterium colony is used to inoculate 1 mL to 15 mL cultures of YEP broth containing appropriate antibiotics for selection. The culture is incubated overnight at 28° C. with constant agitation at 220 rpm. Each culture is used to inoculate two 500 mL cultures of YEP broth containing appropriate antibiotics for selection and the new cultures are incubated overnight at 28° C. with constant agitation. The cells are pelleted at approximately 8700×g for 10 minutes at room temperature, and the resulting supernatant is discarded. The cell pellet is gently resuspended in 500 mL of infiltration media containing: ½× Murashige and Skoog salts (Sigma-Aldrich)/Gamborg's B5 vitamins (Gold BioTechnology, St. Louis, Mo.), 10% (w/v) sucrose, 0.044 μM benzylaminopurine (10 μL/liter of 1 mg/mL stock in DMSO) and 300 μL/liter Silwet L-77. Plants approximately 1 month old are dipped into the media for 15 seconds, with care taken to assure submergence of the newest inflorescence. The plants are then laid on their sides and covered (transparent or opaque) for 24 hours, washed with water, and placed upright. The plants are grown at 22° C., with a 16-hour light/8-hour dark photoperiod. Approximately 4 weeks after dipping, the seeds are harvested.

Arabidopsis Growth and Selection.

Freshly harvested T1 seed is allowed to dry for at least 7 days at room temperature in the presence of desiccant. Seed is suspended in a 0.1% agar/water (Sigma-Aldrich) solution and then stratified at 4° C. for 2 days. To prepare for planting, Sunshine Mix LP5 (Sun Gro Horticulture Inc., Bellevue, Wash.) in 10.5 inch×21 inch germination trays (T.O. Plastics Inc., Clearwater, Minn.) is covered with fine vermiculite, sub-irrigated with Hoagland's solution (Hoagland and Arnon, 1950) until wet, then allowed to drain for 24 hours. Stratified seed is sown onto the vermiculite and covered with humidity domes (KORD Products, Bramalea, Ontario, Canada) for 7 days. Seeds are germinated and plants are grown in a Conviron™ growth chamber (Models CMP4030 or CMP3244; Controlled Environments Limited, Winnipeg, Manitoba, Canada) under long day conditions (16 hours light/8 hours dark) at a light intensity of 120-150 μmol/m² sec under constant temperature (22° C.) and humidity (40-50%). Plants are initially watered with Hoagland's solution and subsequently with deionized water to keep the soil moist but not wet.

The domes are removed 5-6 days post sowing and plants are sprayed with a chemical selection agent to kill plants germinated from nontransformed seeds. For example, if the plant expressible selectable marker gene provided by the binary plant transformation vector is a pat or bar gene (Wehrmann et al., 1996), transformed plants may be selected by spraying with a 1000× solution of Finale (5.78% glufosinate ammonium, Farnam Companies Inc., Phoenix, Ariz.). Two subsequent sprays are performed at 5-7 day intervals. Survivors (plants actively growing) are identified 7-10 days after the final spraying and transplanted into pots prepared with Sunshine Mix LP5. Transplanted plants are covered with a humidity dome for 3-4 days and placed in a Conviron™ growth chamber under the above-mentioned growth conditions.

Those skilled in the art of dicot plant transformation will understand that other methods of selection of transformed plants are available when other plant expressible selectable marker genes (e.g. herbicide tolerance genes) are used.

Insect Bioassays of Transgenic Arabidopsis.

Transgenic Arabidopsis lines expressing DIG-1000 insecticidal toxin proteins are demonstrated to be active against sensitive insect species in artificial diet overlay assays. Protein extracted from transgenic and non-transgenic Arabidopsis lines is quantified by appropriate methods and sample volumes are adjusted to normalize protein concentration. Bioassays are conducted on artificial diet as described above. Non-transgenic Arabidopsis and/or buffer and water are included in assays as background check treatments.

### Example 13

### Stable Maize Expression of DIG-1000 Insecticidal Toxin

Agrobacterium-Mediated Transformation of Maize.

Seeds from a High II F₁ cross (Armstrong et al., 1991) are planted into 5-gallon-pots containing a mixture of 95% Metro-Mix 360 soilless growing medium (Sun Gro Horticulture, Bellevue, Wash.) and 5% clay/loam soil. The plants are grown in a greenhouse using a combination of high pressure sodium and metal halide lamps with a 16:8 hour Light:Dark photoperiod. For obtaining immature F₂ embryos for transformation, controlled sib-pollinations are performed. Immature embryos are isolated at 8-10 days post-pollination when embryos are approximately 1.0 to 2.0 mm in size.

Infection and Co-Cultivation.

Maize ears are surface sterilized by scrubbing with liquid soap, immersing in 70% ethanol for 2 minutes, and then immersing in 20% commercial bleach (0.1% sodium hypochlorite) for 30 minutes before being rinsed with sterile water. A suspension Agrobacterium cells containing a superbinary vector is prepared by transferring 1-2 loops of bacteria grown on YEP solid medium containing 100 mg/L spectinomycin, 10 mg/L tetracycline, and 250 mg/L streptomycin at 28° C. for 2-3 days into 5 mL of liquid infection medium (LS Basal Medium (Linsmaier and Skoog, 1965), N6 vitamins (Chu et al., 1975), 1.5 mg/L 2,4-Dichlorophenoxyacetic acid (2,4-D), 68.5 gm/L sucrose, 36.0 gm/L glucose, 6 mM L-proline, pH 5.2) containing 100 μM acetosyringone. The solution is vortexed until a uniform suspension is achieved, and the concentration is adjusted to a final density of 200 Klett units, using a Klett-Summerson colorimeter with a purple filter, or an equivalent optical density measured at 600 nm (0D600). Immature embryos are isolated directly into a micro centrifuge tube containing 2 mL of the infection medium. The medium is removed and replaced with 1 mL of the Agrobacterium solution with a density of 200 Klett units or equivalent OD₆₀₀, and the Agrobacterium and embryo solution is incubated for 5 minutes at room temperature and then transferred to co-cultivation medium (LS Basal Medium, N6 vitamins, 1.5 mg/L 2,4-D, 30.0 gm/L sucrose, 6 mM L-proline, 0.85 mg/L AgNO₃, 100 μM acetosyringone, 3.0 gm/L Gellan gum (PhytoTechnology Laboratories., Lenexa, Kans.), pH 5.8) for 5 days at 25° C. under dark conditions.

After co-cultivation, the embryos are transferred to selective medium after which transformed isolates are obtained over the course of approximately 8 weeks. For selection of maize tissues transformed with a superbinary plasmid containing a plant expressible pat or bar selectable marker gene, an LS based medium (LS Basal medium, N6 vitamins, 1.5 mg/L 2,4-D, 0.5 gm/L MES (2-(N-morpholino)ethanesulfonic acid monohydrate; PhytoTechnologies Labr.), 30.0 gm/L sucrose, 6 mM L-proline, 1.0 mg/L AgNO₃, 250 mg/L cefotaxime, 2.5 gm/L Gellan gum, pH 5.7) is used with Bialaphos (Gold BioTechnology). The embryos are transferred to selection media containing 3 mg/L Bialaphos until embryogenic isolates are obtained. Recovered isolates are bulked up by transferring to fresh selection medium at 2-week intervals for regeneration and further analysis.

Those skilled in the art of maize transformation will understand that other methods of selection of transformed plants are available when other plant expressible selectable marker genes (e.g. herbicide tolerance genes) are used.

Regeneration and Seed Production.

For regeneration, the cultures are transferred to “28” induction medium (MS salts and vitamins, 30 gm/L sucrose, 5 mg/L Benzylaminopurine, 0.25 mg/L 2, 4-D, 3 mg/L Bialaphos, 250 mg/L cefotaxime, 2.5 gm/L Gellan gum, pH 5.7) for 1 week under low-light conditions (14 μEm⁻²s⁻¹) then 1 week under high-light conditions (approximately 89 μEm⁻²s⁻¹). Tissues are subsequently transferred to “36” regeneration medium (same as induction medium except lacking plant growth regulators). When plantlets grow to 3-5 cm in length, they are transferred to glass culture tubes containing SHGA medium (Schenk and Hildebrandt (1972) salts and vitamins); PhytoTechnologies Labr.), 1.0 gm/L myo-inositol, 10 gm/L sucrose and 2.0 gm/L Gellan gum, pH 5.8) to allow for further growth and development of the shoot and roots. Plants are transplanted to the same soil mixture as described earlier herein and grown to flowering in the greenhouse. Controlled pollinations for seed production are conducted.

### Example 14

### Bioassay of Transgenic Maize

Bioactivity of the stably transformed plants expressing insecticidal toxins of the invention produced in plant cells is demonstrated by conventional bioassay methods (see, for example Huang et al., 2006). One is able to demonstrate efficacy, for example, by feeding various plant tissues or tissue pieces derived from a plant producing an engineered Cry6Aa insecticidal toxin to target insects in a controlled feeding environment. Alternatively, protein extracts may be prepared from various plant tissues derived from a plant producing the engineered Cry6Aa insecticidal toxin and the extracted proteins incorporated into artificial diet bioassays as previously described herein. It is to be understood that the results of such feeding assays are to be compared to similarly conducted bioassays that employ appropriate control tissues from host plants that do not produce an engineered Cry6Aa insecticidal toxin, or to other control samples.

### REFERENCES

Alistair J. Wallace, Timothy J. Stillman, Angela Atkins, Stuart J. Jamieson, Per A. Bullough, Jeffrey Green, and Peter J. Artymiuk (2000). “E. coli Hemolysin E (HlyE, ClyA, SheA): X-Ray Crystal Structure of the Toxin and Observation of Membrane Pores by Electron Microscopy”. Cell, Vol. 100: 265-276, January
Altschul, S. F., Gish, W., Miller, W., Myers, E. W., Lipman, D. J. (1990) Basic local alignment search tool. J. Mol. Biol. 215:403-410.
Altschul, S. F., Madden, T. L., Schaffer, A. A., Zhang, J., Zhang, Z., Miller, W., Lipman, D. J. (1997) Gapped BLAST and PSI-BLAST: a new generation of protein database search programs. Nucl. Acids Res. 25:3389-3402.
An, G., Watson, B. D., Stachel, S., Gordon, M. P., Nester, E. W. (1985) New cloning vehicles for transformation of higher plants. EMBO J. 4:277-284.
Armstrong, C. L., Green, C. E., Phillips, R. L. (1991) Development and availability of germplasm with high TypeII culture formation response. Maize Genet. Coop. Newslett. 65:92-93.
Aronson, A. I., Han, E.-S., McGaughey, W., Johnson, D. (1991) The solubility of inclusion proteins from Bacillus thuringiensis is dependent upon protoxin composition and is a factor in toxicity to insects. Appl. Environ. Microbiol. 57:981-986.
Aronson, A. I., Geng, C., Wu. L. (1999) Aggregation of Bacillus thuringiensis Cry1A toxins upon binding to target insect larval midgut vesicles. Appl. Environ. Microbiol. 65:2503-2507.
Arvidson, H., Dunn, P. E., Strand, S., Aronson, A. I. (1989) Specificity of Bacillus thuringiensis for lepidopteran larvae: factors involved in vivo and in the structure of a purified toxin. Molec. Microbiol. 3:1533-1543.
Ausubel et al., eds. (1995) Current Protocols in Molecular Biology, Chapter 2 (Greene Publishing and Wiley-Interscience, New York).
Bailey, J. M., Shenov, N. R., Ronk, M., and Shively, J. E., (1992) Automated carboxy-terminal sequence analysis of peptides. Protein Sci. 1:68-80.
Baum J A, Bogaert T, Clinton W, Heck G R, Feldmann P, Ilagan O, Johnson S, Plaetinck G, Munyikwa T, Pleau M, Vaughn T, Roberts J., (2007) Control of coleopteran insect pests through RNA interference. Nat Biotechnol. November; 25(11):1322-6. Epub 2007 Nov. 4.
Beltz, G. A., Jacobs, K. A., Eickbush, T. H., Cherbas, P. T., Kafatos, F. C. (1983) Isolation of multigene families and determination of homologies by filter hybridization methods. In Wu, R., Grossman, L., Moldave, K. (eds.) Methods of Enzymology, Vol. 100 Academic Press, New York pp. 266-285.
Benchabane, M., Goulet, C., Rivard, D., Faye, L., Gomord, V., Michaud, D., (2008). “Preventing Unintended Proteolysis in Plant Protein Biofactories”. Plant Biotechnology Journal 6: 633-648.
Bown, D. P., Wilkinson, H. S., Jongsma, M. A., Gatehouse, J. A. (2004) Characterization of cysteine proteinases responsible for digestive proteolysis in guts of larval western corn rootworm (Diabrotica virgifera) by expression in the yeast Pichia pastoris. Insect Biochem. Molec. Biol. 34, 305-320.
Bravo, A., Gill, S. S., Soberon, M. (2007) Mode of action of Bacillus thuringiensis Cry and Cyt toxins and their potential for insect control. Toxicon 49:423-435.
Caruthers, M. H., Kierzek, R., Tang, J. Y. (1987) Synthesis of oligonucleotides using the phosphoramidite method. Bioactive Molecules (Biophosphates Their Analogues) 3:3-21.
Cervelli, M., Tavladoraki, P., Agostino, S., Angelini, R., Rodolfo, F., and Mariottini, P. (2000). “Isolation and characterization of three polyamine oxidase genes from Zea mays”. Plant Physiol. Biochem. 38:667-677.
Christeller, J. T., Laing, W. A., Markwick, N. P., Burgess, E. P. J. (1992) Midgut protease activities in 12 phytophagous lepidopteran larvae: dietary and protease inhibitor interactions. Insect Biochem. Molec. Biol. 22:735-746.
Chu, C. C., Wand, C. C., Sun, C. S., Hsu, C., Yin, K. C., Chu, C. Y., Bi, F. Y. (1975) Establishment of an efficient medium for anther culture of rice through comparative experiments on the nitrogen sources. Scientia Sinica 18:659-668.
Crameri, A., Cwirla, S., Stemmer, W. P. C. (1996a) Construction and evolution of antibody-phage libraries by DNA shuffling. Nat. Med. 2:100-103.
Crameri, A., Whitehom, E. A., Tate, E., Stemmer, W. P. C. (1996b) Improved green fluorescent protein by molecular evolution using DNA shuffling. Nat. Biotech. 14:315-319.
Crameri, A., Dawes, G., Rodriguez, E., Silver, S., Stemmer, W. P. C. (1997) Molecular evolution of an arsenate detoxification pathway by DNA shuffling. Nat. Biotech. 15:436-438.
Crickmore N., Zeigler, D. R., Feitelson J., Schnepf, E., Van Rie J., Lereclus D., Baum J., and Dean D. H. (1998) Revision of the Nomenclature for the Bacillus thuringiensis Pesticidal Crystal Proteins Microbiol. Mol. Biol. Reviews 62:807-813.
de Maagd, R. A., Kwa, M. S., van der Klei, H., Yamamoto, T., Schipper, B., Vlak, J. M., Stiekema, W. J., Bosch, D. (1996) Domain III substitution in Bacillus thuringiensis delta-endotoxin CryIA(b) results in superior toxicity for Spodoptera exigua and altered membrane protein recognition. Appl. Environ. Microbiol. 62:1537-1543.
de Maagd, R. A., Bravo, A., Berry, C., Crickmore, N., Schnepf, E. (2003) Structure, diversity, and evolution of protein toxins from spore-forming entomopathogenic bacteria. Annu. Rev. Genet. 37:409-433.
Diaz-Mendoza, M., Farinos, G. P., Castanera, P., Hernandez-Crespo, P., Ortego, F. (2007) Proteolytic processing of native Cry1Ab toxin by midgut extracts and purified trypsins from the Mediterranean corn borer Sesamia nonagrioide. J. Insect Physiol. 53:428-435.
Ellis, R. T., Stockhoff, B. A., Stamp, L., Schnepf, H. E., Schwab, G. E., Knuth, M., Russell, J., Cardineau, G. A., Narva, K. E. (2002) Novel Bacillus thuringiensis binary insecticidal crystal proteins active on western corn rootworm, Diabrotica virgifera virgifera LeConte. Appl. Environ. Microbiol. 68:1137-1145.
Emsley, P., Bernhard Lohkamp, William G. Scott, and Kevin Cowtan. (2010). “Features and Development of Coot.” Acta Cryst D66: 486-501.
Englemann, F., Geraerts, W. P. M., (1980) The proteases and the protease inhibitor in the midgut of Leucophaea maderae. J. Insect Physiol. 261:703-710.
Fallahi, M., Crosthwait, J., Calixte, S., and Bonen, L., (2005). “Fate of Mitochondrially Located S19 Ribosomal Protein Genes after Transfer of a Functional Copy to the Nucleus in Cereals” Mol Gen Genomics 273: 76-83.
Fraley, R. T., Rogers, S. G., Horsch, R. B. (1986) Genetic transformation in higher plants. Crit. Rev. Plant Sci. 4:1-46.
Frankenhuyzen, K., (2009) Insecticidal activity of Bacillus thuringiensis crystal proteins. Journal of Invertebrate Pathology, Vol: 101 (1): 1-16.
Gallagher, S., Winston, S., Fuller, S., Hurrell, J. (2008) Immunoblotting and Immunodetection. Current Protocols in immunology 8.10.1-8.10.28.
Gazit, E., La Rocca, P., Sansom, M. S. P., Shai, Y. (1998) The structure and organization within the membrane of the helices composing the pore-forming domain of Bacillus thuringiensis delta-endotoxin are consistent with an “umbrella-like” structure of the pore. Proc. Nat. Acad. Sci. USA 95:12289-12294.
Ge, A., Rivers, D., Milne, R., Dean, D. H. (1991) Functional domains of Bacillus thuringiensis insecticidal crystal proteins. Refinement of Heliothis virescens and Trichoplusia ni specificity domains on CryIA(c). J. Biol. Chem. 266:17954-17958.
Gillikin, J. W., Bevilacqua, S., Graham, J. S. (1992) Partial characterization of digestive tract proteinases from western corn rootworm larvae, Diabrotica virgifera. Arch. Insect Biochem. Physiol. 19:285-298.
Gnanasambandam, A., Anderson, D. J., Mills, E., and Brumbley, S. M. (2012). “Heterologous C-terminal Signals Effectively Target Fluorescent Fusion Proteins to Leaf Peroxisomes in Diverse Plant Species” Journal of Plant Physiology 169: 830-833.
Gomez, I., Sanchez, J., Miranda, R., Bravo, A., Soberon, M. (2002) Cadherin-like receptor binding facilitates proteolytic cleavage of helix alpha-1 in domain I and oligomer pre-pore formation of Bacillus thuringiensis Cry1Ab toxin. FEBS Lett. 513:242-246.
Hahn, J. J., Eschenlauer, A. C., Sleyter, U. B., Somers, D. A. and Srienc, F., (1999) “Peroxisomes as Sites for Synthesis of Polyhydroxyalkanoates in Transgenic Plants” Biotechnol. Prog. 15:1053-1057.
Haider, M. Z., Knowles, B. H., Ellar, D. J. (1986) Specificity of Bacillus thuringiensis var. colmeri insecticidal δ-endotoxin is determined by differential proteolytic processing of the protoxin by larval gut proteases. Eur. J. Biochem. 156:531-540.
Heckel, D. G., Gahan, L. J., Baxter, S. W., Zhao, J-Z., Shelton, A. M., Gould, F., Tabashnik, B. E. (2007) The diversity of Bt resistance genes in species of Lepidoptera. J. Invert. Pathol. 95:192-197.
Hepburn, A. G., White, J., Pearson, L., Maunders, M. J., Clarke, L. E., Prescott, A. G. Blundy, K. S. (1985) The use of pNJ5000 as an intermediate vector for the genetic manipulation of Agrobacterium Ti-plasmids. J. Gen. Microbiol. 131:2961-2969.
Hoagland, D. R., Anion, D. I. (1950) The water-culture method of growing plants without soil. Calif. Agr. Expt. Sta. Circ. 347.
Hofte, H., de Greve, H., Seurinck, J., Jansens, S., Mahillon, J., Ampe, C., Vandekerckhove, J., Vanderbruggen, H., van Montagu, M., Zabeau, M., Vaeck, M. (1986) Structural and functional analysis of a cloned delta endotoxin of Bacillus thuringiensis berliner 1715. Eur. J. Biochem. 161:273-280.
Holwerda, B., Padgett, H. and Rogers, J. (1992). “Proaleurain Vacuolar Targeting Is Mediated by Short Contiguous Peptide interactions”. The Plant Cell 4: 307-318.
Honée, G., Convents, D., Van Rie, J., Jansens, S., Peferoen, M., Visser, B. (1991) The C-terminal domain of the toxic fragment of a Bacillus thuringiensis crystal protein determines receptor binding. Mol. Microbiol. 5:2799-2806
Hood, E. E., Love, R., Lane, J., Bray, J., Clough, R., Pappu, K., Drees, C., Hood, K. R., Yoon, S., Ahmad, A., and Howard, J. A. (2007). “Subcellular Targeting is a Key Condition for High-Level Accumulation of Cellulase Protein in Transgenic Maize Seed”. Plant Biotechnology Journal 5:709-719.
Horton, R. M., Hunt, H. D., Ho, S. N., Pullen, J. K., Pease, L. R. (1989) Engineering hybrid genes without the use of restriction enzymes: gene splicing by overlap extension. Gene 77:61-68.
Huang, F., Rogers, L. B., Rhett, G. H. (2006) Comparative susceptibility of European corn borer, southwestern corn borer, and sugarcane borer (Lepidoptera: Crambidae) to Cry1Ab protein in a commercial Bacillus thuringiensis corn hybrid. J. Econ. Entomol. 99:194-202.
Huang, K-X., Badger, M., Haney, K., Evans, S. L. (2007) Large scale production of Bacillus thuringiensis PS149B1 insecticidal proteins Cry34Ab1 and Cry35Ab1 from Pseudomonas fluorescens. Prot. Express. Purific. 53:325-330.
Hyunjong, B., Lee, D-S. and Hwang, I. (2006). “Dual Targeting of Xylanase to Chloroplasts and Peroxisomes as a Means to Increase Protein Accumulation in Plant Cells” J. Exp. Bot. 57: 161-169.
Janmaat, A. F., Myers, A. H. (2003) Rapid evolution and the cost of resistance to Bacillus thuringiensis in greenhouse populations of cabbage loopers, Trichoplusia ni. Proc. Royal Soc. London. Ser. B, Biolog. Sci. 270:2263-2270.
Janmaat, A. F., Myers, A. H. (2005) The cost of resistance to Bacillus thuringiensis varies with the host plant of Trichoplusia ni. Proc. Royal Soc. London. Ser. B, Biolog. Sci. 272:1031-1038.
Karlin, S., Altschul, S. F. (1990) Methods for assessing the statistical significance of molecular sequence features by using general scoring schemes. Proc. Natl. Acad. Sci. USA 87:2264-2268.
Karlin, S., Altschul, S. F. (1993) Applications and statistics for multiple high-scoring segments in molecular sequences. Proc. Natl. Acad. Sci. USA 90:5873-5877.
Keller, G. H., Manak, M. M. (1993) DNA Probes, Background, Applications, Procedures. Stockton Press, New York, N.Y.
Knight, J. S., Broadwell, A. H., Grant, W. N., Shoemaker, C. B. (2004) A Strategy for Shuffling Numerous Bacillus thuringiensis Crystal Protein Domains. J. Econ. Entomol. 97:1805-1813.
Koiwa, H., Shade, R. E., Zhu-Salzman, K., D'Urzo, M. P., Murdock, L. L., Bressan, R. A., Hasegawa, P. M. (2000) A plant defensive cystatin (soyacystatin) targets cathepsin L-like digestive cysteine proteinases (DvCALs) in the larval midgut of western corn rootworm Diabrotica virgifera virgifera. FEBS Letters 471:67-70.
Larson, S. M., England, J. L., Desjarlais, J. R., Pande, V. S. (2002) Thoroughly sampling sequence space: Large-scale protein design of structural ensembles. Protein Sci. 11:2804-2813.
Lee, L.-Y., Gelvin, S. B. (2008) T-DNA binary vectors and systems. Plant Physiol. 146: 325-332.
Li, H., Olson, M., Lin, G., Hey, T., Tan, S. Y. and Narva, K. (2013). “Bacillus thuringiensis Cry34Ab1/Cry35Ab1 Interactions with Western Corn Rootworm Midgut Membrane Binding Sites”. PLoS One 8: e53079.
Linsmaier, E. M., Skoog, F. (1965) Organic growth factor requirements of tobacco tissue. Physiologia Plant 18:100-127.
Littlefield, J. W. (1964) Selection of hybrids from matings of fibroblasts in vitro and their presumed recombinants. Science 145:709-710.
Mahendra Madegowda, Subramaniam Eswaramoorthy, Stephen K. Burley, and Subramanyam Swaminathan (2008). “X-ray crystal structure of the B component of Hemolysin BL from Bacillus cereus” Proteins. 2008 May 1; 71(2): 534-540.
Mano, S., Nakamori, C., Hayashi, M., Kato, A., Kondo, M., Nishimura, M. (2002). “Distribution and Characterization of Peroxisomes in Arabdopsis by Visualization with GFP: Dynamic Morphology and Actin-Dependent Movement”. Plant Cell Physiol. 43: 331-341.
McCoy, A. J., Grosse-Kunstleve, R. W., Adams, P. D., Winn, M. D., Storoni, L. C., & Read, R. J. (2007). “Phaser crystallographic software.” J. Appl. Cryst. 40: 658-674.
Meinkoth, J., Wahl, G. (1984) Hybridization of nucleic acids immobilized on solid supports. Anal. Biochem. 138:267-284.
Metcalf, R. L. (1986) The ecology of insecticides and the chemical control of insects. pp. 251-297. In (Marcos Kogan (ed.)) Ecological theory and integrated pest management practice. John Wiley & Sons, N. Y. 362 pp.
Miao, Y., Yan P. K., Kim, H., Hwang, I., and Jiang, L. (2006). “Localization of Green Fluorescent Protein Fusions with the Seven Arabidopsis Vacuolar Sorting Receptors to Pre-vacuolar Compartments in Tobacco BY-2 Cells”. Plant Physiol. 142:945-962.
Moellenbeck, D. J., Peters, M. L., Bing, J. W., Rouse, J. R., Higgins, L. S., Sims, L., Nevshemal, T., Marshall, L., Ellis, R. T., Bystrak, P. G., Lang, B. A., Stewart, J. L., Kouba, K., Sondag, V., Gustafson, V., Nour, K., Xu, D., Swenson, J., Zhang, J., Czapla, T., Schwab, G., Jayne, S., Stockhoff, B. A., Narva, K., Schnepf, H. E., Stelman, S. J., Poutre, C., Koziel, M., Duck, N. (2001) Insecticidal proteins from Bacillus thuringiensis protect corn from corn rootworms. Nat. Biotech. 19:668-672.
Mueller, Marcus, Ulla Grauschopf, Timm Maier, Rudi Glockshuber and Nenad Ban (2009). “The structure of a cytolytic a-helical toxin pore reveals its assembly mechanism”. Nature Vol 459: 4 Jun. 2009: 726.
Murashige, T. and Skoog, F. (1962). A revised medium for rapid growth and bioassays with tobacco tissue cultures. Physiol. Plant 15: 473-497.
Murshudov, G. N., A. A. Vagin and E. J. Dodson, (1997). “Refinement of Macromolecular Structures by the Maximum-Likelihood method.” Acta Cryst. D53: 240-255.
Myers, E., Miller, W. (1988) Optimal alignments in linear space. CABIOS 4:11-17.
Naimov, S., Weemen-Hendriks, M., Dukiandjiev, S., de Maagd, R. A. (2001) Bacillus thuringiensis delta-endotoxin Cry1 hybrid proteins with increased activity against the Colorado potato beetle. Appl. Environ. Microbiol. 11:5328-5330.
Needleman, S. B., Wunsch, C. D. (1970) A general method applicable to the search for similarities in the amino acid sequence of two proteins. J. Mol. Biol. 48:443-453.
Nora Eifler, Michael Vetsch, Marco Gregorini, Philippe Ringler, MohamedChami, Ansgar Philippsen, Andrea Fritz, Shirley A Muller, Rudi Glockshuber, Andreas Engel, and Ulla Grauschopf (2006). “Cytotoxin ClyA from Escherichia coli assembles to a 13-meric pore independent of its redox-state” The EMBO Journal 25: 2652-2661
Nunez-Valdez, M.-E., Sanchez, J., Lina, L., Guereca, L., Bravo, A. (2001) Structural and functional studies of alpha-helix 5 region from Bacillus thuringiensis Cry lAb delta-endotoxin. Biochim Biophys. Acta, Prot. Struc. Molec. Enzymol. 1546:122-131.
Ochoa-Campuzano, C., Real, M. D., Martinez-Ramirez, A. C., Bravo, A., Rausell, C. (2007) An ADAM metalloprotease is a Cry3Aa Bacillus thuringiensis toxin receptor. Biochem. Biophys. Res. Commun. 362:437-442.
Oleson J D¹, Park Y L, Nowatzki T M, Tollefson J J. (2005). “Node-injury scale to evaluate root injury by corn rootworms (Coleoptera: Chrysomelidae)” J Econ Entomol. 2005 February; 98(1):1-8.
Otwinowski, Z. and W. Minor, “Processing of X-ray Diffraction Data Collected in Oscillation Mode”, Methods in Enzymology, Volume 276: Macromolecular Crystallography, part A, p. 307-326,1997, C. W. Carter, Jr. & R. M. Sweet, Eds., Academic Press (New York).
Pigott, C. R., Ellar, D. J. (2007) Role of receptors in Bacillus thuringiensis crystal toxin activity. Microbiol. Molec. Biol. Rev. 71:255-281.
Prichard, R. K. et al. [1980] “The problem of anthelmintic resistance in nematodes,” Austr. Vet. J. 56:239-251; Coles, G. C. [1986] “Anthelmintic resistance in sheep,” In Veterinary Clinics of North America: Food Animal Practice, Vol 2:423-432 [Herd, R. P., eds.] W. B. Saunders, New York
Rang, C., Vachon, V., de Maagd, R. A., Villalon, M., Schwartz, J.-L., Bosch, D., Frutos, R., Laprade R. (1999) Interaction between functional domains of Bacillus thuringiensis insecticidal crystal proteins. Appl. Environ. Microbiol. 65:2918-2925.
Rokov-Plavec, Dulic, M., Duchene, A-M., Weygand-Durasevic, I. (2008). “Dual Targeting of Organellar Seryl-tRNA Synthetase to Maize Mitochondria and Chloroplasts” Plant Cell Rep 27: 1157-1168.
Sambrook, J., Fritsch, E. F., Maniatis, T. (1989) Molecular Cloning: A Laboratory Manual (2nd ed., Cold Spring Harbor Laboratory Press, Plainview, N.Y.)
Schenk, R. U., Hildebrandt, A. C. (1972) Medium and techniques for induction and growth of monocotyledonous and dicotyledonous plant cell cultures. Can. J. Bot. 50:199-204
Schnepf, H. E., Tomczak, K., Ortega, J. P., Whiteley, H. R. (1990) Specificity-determining regions of a Lepidopteran-specific insecticidal protein produced by Bacillus thuringiensis. J. Biol. Chem. 265:20923-20930.
Soberon, M., Pardo-Lopez, L., Lopez, I., Gomez, I., Tabashnik, B. E., Bravo, A. (2007) Engineering modified Bt toxins to counter insect resistance. Science 318:1640-1642.
Squires, C. H., Retallack, D. M., Chew, L. C., Ramseier, T. M., Schneider, J. C., Talbot, H. W. (2004) Heterologous protein production in P. fluorescens. Bioprocess Intern. 2:54-59.
Stemmer, W. P. C. (1994a) DNA shuffling by random fragmentation and reassembly: in vitro recombination for molecular evolution. Proc. Natl. Acad. Sci. USA 91:10747-10751
Stemmer, W. P. C. (1994b) Rapid evolution of a protein in vitro by DNA shuffling. Nature 370: 389-391.
Stemmer, W. P. C. (1995) Searching sequence space. Bio/Technology 13:549-553.
Stewart, L. (2007) Gene synthesis for protein production. Encyclopedia of Life Sciences. John Wiley and Sons, Ltd.
Stewart, L., Burgin, A. B., (2005) Whole gene synthesis: a gene-o-matic future. Frontiers in Drug Design and Discovery 1:297-341.
Suggs, S. V., Miyake, T., Kawashime, E. H., Johnson, M. J., Itakura, K., R. B. Wallace, R. B. (1981) ICN-UCLA Symposium. Dev. Biol. Using Purified Genes, D. D. Brown (ed.), Academic Press, New York, 23:683-69
Tabashnik, B. E., Finson, N., Groeters, F. R., Moar, W. J., Johnson, M. W., Luo, K., Adang, M. J. (1994) Reversal of resistance to Bacillus thuringiensis in Plutella xylostella. Proc. Nat. Acad. Sci. USA 91:4120-4124.
Tabashnik, B. E., Gassmann, A. J., Crowder, D. W., Carriere, T. (2008) Insect resistance to Bt crops: evidence versus theory. Nat. Biotech. 26:199-202.
Taggart, R. T., Samloff, I. M. (1983) Stable antibody-producing murine hybridomas. Science 219:1228-1230.
Terry R. Wright, Guomin Shana, Terence A. Walsh, Justin M. Lira, Cory Cui, Ping Song, Meibao Zhuang, Nicole L. Arnold, Gaofeng Lin, Kerrm Yau, Sean M. Russell, Robert M. Cicchillo, Mark A. Peterson, David M. Simpson, Ning Zhou, Jayakumar Ponsamuel, and Zhanyuan Zhang. (2010) “Robust crop resistance to broadleaf and grass herbicides provided by aryloxyalkanoate dioxygenase transgenes”. 20240-20245 I PNAS I November 23,2010 I vol. 107 I no. 47.
Thie, N. M. R., Houseman J G. (1990) Identification of cathepsin B, D and H in the larval midgut of Colorado potato beetle, Leptinotarsa decemlineata say (Coleoptera: Chrysomelidae) Insect Biochem. 20:313-318.
Thompson, J. D., Higgins, D. G., Gibson, T. J. (1994) CLUSTAL W: improving the sensitivity of progressive multiple sequence alignment through sequence weighting, position-specific gap penalties and weight matrix choice. Nucl. Acids Res. 22:4673-4680.
Tijssen, P. (1993) Laboratory Techniques in Biochemistry and Molecular Biology Hybridization with Nucleic Acid Probes, Part I, Chapter 2. P. C. van der Vliet (ed.), (Elsevier, N.Y.)
Tzokov, S. B., Wyborn, N. R., Stillman, T. J., Jamieson, S., Czudnochowski, N., Artymuik, P. J., Green, J., Bullough, P. A. (2006). “Structure of the Hemolysin E (HlyE, ClyA and SheA) Channel in Its Membrane-bound Form”. J. Biol. Chem. 2006, 281:23042-23049.
Varagona, M., and Raikhel, N. (1994). “The Basic Domain in the bZIP Regulatory Protein Opaque2 Serves Two Independent Functions: DNA Binding and Nuclear Localization”. The Plant Journal 5:207-214.
Varshaysky, A. (1997) The N-end rule pathway of protein degradation. Genes to Cells 2:13-28.
Vaughn, T., Cavato, T., Brar, G., Coombe, T., DeGooyer, T., Ford, S., Groth, M., Howe, A., Johnson, S., Kolacz, K., Pilcher, C., Prucell, J., Romano, C., English, L., Pershing, J. (2005) A method of controlling corn rootworm feeding using a Bacillus thuringiensis protein expressed in transgenic maize. Crop. Sci. 45:931-938.
Walters, F. S., Slatin, S. L., Kulesza, C. A., English, L. H. (1993) Ion channel activity of N-terminal fragments from CryIA(c) delta-endotoxin. Biochem. Biophys. Res. Commun. 196:921-926.
Walters, F. S., Stacy, C. M., Lee, M. K., Palekar, N., Chen, J. S. (2008) An engineered chymotrypsin/cathepsin G site in domain I renders Bacillus thuringiensis Cry3A active against western corn rootworm larvae. Appl. Environ. Microbiol. 74:367-374.
Wehrmann, A., Van Vliet, A., Opsomer, C., Botterman, J., Schulz, A. (1996) The similarities of bar and pat gene products make them equally applicable for plant engineers. Nat. Biotechnol. 14:1274-1278.
Weigel, D., Glazebrook, J. (eds.) (2002) Arabidopsis: A Laboratory Manual. Cold Spring Harbor Press, Cold Spring Harbor, N.Y., 354 pages.
Wei, J-Z., Hale, K., Carta, L., Platzer, E., Wong, C., Fang, S-C., Aroian, R. (2003). “Bacillus thuringiensis crystal proteins that target nematodes”. PNAS 100: 2760-2765.
White, J. A., and Scandalios, J. G. (1989). “Deletion Analysis of the Maize Mitochondrial Superoxide Dismutase Transit Peptide” PNAS 86:3534-3538.
Winn, M. D. et al. (2011). “Overview of the CCP4 suite and current developments.” Acta. Cryst. D67: 235-242.
Witkowski, J. F., Wedberg, J. L., Steffey, K. L., Sloderbeck, P. E., Siegfried, B. D., Rice, M. E., Pilcher, C. D., Onstad, D. W., Mason, C. E., Lewis, L. C., Landis, D. A., Keaster, A. J., Huang, F., Higgins, R. A., Haas, M. J., Gray, M. E., Giles, K. L., Foster, J. E., Davis, P. M., Calvin, D. D., Buschman, L. L., Bolin, P. C., Barry, B. D., Andow, D. A., Alstad, D. N. (2002) Bt corn and European Corn Borer (Ostlie, K. R., Hutchison, W. D., Hellmich, R. L. (eds)). University of Minnesota Extension Service. Publ. WW-07055.
Wolfson, J. L., Murdock, L. L. (1990) Diversity in digestive proteinase activity among insects. J. Chem. Ecol. 16:1089-1102.
Worley, C. K., Ling, R., Callis, J. (1998) Engineering in vivo instability of firefly luciferase and Escherichia coli β-glucuronidase in higher plants using recognition elements from the ubiquitin pathway. Plant Molec. Biol. 37:337-347.

We claim:

1. A modified Cry6Aa insecticidal protein comprising modifications chosen from the group consisting of a modified proteolysis-susceptible region, increased affinity of the carboxy terminal peptide (CTP) for the core protein, and addition of sub-cellular transit peptides.

2. A modified Cry6Aa insecticidal protein of claim 1 chosen from the group consisting of SEQ ID NO:35, SEQ ID NO:37, SEQ ID NO:39, SEQ ID NO:41, SEQ ID NO:43, SEQ ID NO:45, SEQ ID NO:47, SEQ ID NO:49, SEQ ID NO:64, SEQ ID NO:66, SEQ ID NO:68, SEQ ID NO:70, SEQ ID NO:72, SEQ ID NO:74, SEQ ID NO:76, SEQ ID NO:78, SEQ ID NO:80, SEQ ID NO:82, SEQ ID NO:84, SEQ ID NO:86, SEQ ID NO:88, SEQ ID NO:90, SEQ ID NO:92, SEQ ID NO:94, SEQ ID NO:96, SEQ ID NO:98, SEQ ID NO:100, SEQ ID NO:102, SEQ ID NO:104, SEQ ID NO:106, SEQ ID NO:108, SEQ ID NO:110, SEQ ID NO:112, SEQ ID NO:114, SEQ ID NO:116, SEQ ID NO:118, SEQ ID NO:120, SEQ ID NO:132, SEQ ID NO:136, SEQ ID NO:138, SEQ ID NO:140, and SEQ ID NO:144.

3. A modified Cry6Aa insecticidal protein of claim 1 chosen from the group consisting of SEQ ID NO:110, SEQ ID NO:112, SEQ ID NO:114, SEQ ID NO:116, SEQ ID NO:118, SEQ ID NO:120, SEQ ID NO:128, SEQ ID NO:132, SEQ ID NO:140, and SEQ ID NO:144.

4. A modified Cry6Aa insecticidal protein of claim 1 chosen from the group consisting of SEQ ID NO:116, SEQ ID NO:118, SEQ ID NO:120, SEQ ID NO:140, SEQ ID NO:144.

5. A modified Cry6Aa insecticidal protein of claim 1 that is SEQ ID NO:116.

6. A nucleic acid sequence encoding a modified Cry6Aa insecticidal protein of claim 1.

7. A nucleic acid sequence encoding a modified Cry6Aa insecticidal protein of claim 2.

8. A nucleic acid sequence encoding a modified Cry6Aa insecticidal protein of claim 3.

9. A nucleic acid sequence encoding a modified Cry6Aa insecticidal protein of claim 4.

10. A nucleic acid sequence encoding a modified Cry6Aa insecticidal protein of claim 5.

11. A DNA construct comprising a nucleic acid sequence of claim 6 operably linked to a promoter that is capable of driving expression in a plant.

12. A transgenic plant or plant part that comprises a nucleic acid sequence of claim 6.

13. A transgenic plant or plant part that comprises a nucleic acid sequence of claim 8.

14. A method of controlling insect pest damage to plants which comprises delivering an insecticidally effective amount of an insecticidal protein of claim 1 such that the insect pest ingests said insecticidal protein.

15. The method of claim 14 wherein the insect pest damage is cause by insects of the order Coleoptera.

16. The method of claim 15 wherein the insect pest damage is caused by western corn rootworms, Diabrotica virgifera virgifera LeConte.

17. A method of controlling insect pest damage to plants which comprises preparing a transgenic plant of claim 12 and presenting said plant to an insect pest population.

18. A method of controlling insect pest damage to plants which comprises preparing a transgenic plant of claim 13 and presenting said plant to an insect pest population.

19. The method of claim 18 wherein the insect pest damage is cause by insects of the order Coleoptera.

20. The method of claim 18 wherein the insect pest damage is caused by western corn rootworms, Diabrotica virgifera virgifera LeConte.


SEQUENCE LISTING (144 sequences)

SEQ ID NO: 1 - DNA, 1428 bp, Bacillus thuringiensis
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattaa

SEQ ID NO: 2 - protein, 475 aa, Bacillus thuringiensis
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 3 - DNA, 1428 bp, Artificial Sequence
  synthesized maize optimized coding region
atgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 4 - skipped

SEQ ID NO: 5 - protein, 529 aa, Artificial Sequence
  translated from synthesized maize optimized coding region
MAIGSLIASTFARSSHALPAAAASAISQAPRSQHTASPLLSGLGAAARAFSSRALIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 6 - DNA, 1518 bp, Artificial Sequence
  synthesized maize optimized coding region
atggcccttaggaccttagcgagcaagaaggtgctgagcttcccgttcggcggagcgggcagaccgttagcagcagcggcctcagctaggggcatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 7 - protein, 505 aa, Artificial Sequence
  translated from synthesized maize optimized coding region
MALRTLASKKVLSFPFGGAGRPLAAAASARGIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 8 - DNA, 1665 bp, Artificial Sequence
  synthesized maize optimized coding region
atgctgacctgcggaaggttcatcagctccagcgcggccaccagcaccgcctccttcttcccgtttaggaccctgacaaggagcctggtgaggagaccggccccgcacctgctcagctccgcgtcagctgccgccgccacagcggtggagctggacaccaacggagacggctcagcgggcggcggagccggcgtggtgaggcctcagtggaaggcggcaatcgacttcaagtggatcaggatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 9 - protein, 554 aa, Artificial Sequence
  translated from synthesized maize optimized coding region
MLTCGRFISSSAATSTASFFPFRTLTRSLVRRPAPHLLSSASAAAATAVELDTNGDGSAGGGAGVVRPQWKAAIDFKWIRIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 10 - DNA, 1446 bp, Artificial Sequence
  synthesized maize optimized coding region
atgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaacagggcagtggcgaggctgtga

SEQ ID NO: 11 - protein, 481 aa, Artificial Sequence
  translated from synthesized maize optimized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNNRAVARL

SEQ ID NO: 12 - DNA, 1464 bp, Artificial Sequence
  synthesized maize optimized coding region
atgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaacgacctgaaggctctggagctgccagtgagcaagctgtga

SEQ ID NO: 13 - protein, 487 aa, Artificial Sequence
  translated from synthesized maize optimized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNNDLKALELPVSKL

SEQ ID NO: 14 - DNA, 1575 bp, Artificial Sequence
  synthesized maize optimized coding region
atgccgaccgacatggagctgtccccgtccaacgtggcgaggcacagactggcagttctggcggcgcacctgtcagccgcgagcctggagcctccggtgatggcgagcagcctggaggcccactgcgttagcgctcagacaatgggcggcatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 15 - protein, 524 aa, Artificial Sequence
  translated from synthesized maize optimized coding region
MPTDMELSPSNVARHRLAVLAAHLSAASLEPPVMASSLEAHCVSAQTMGGIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 16 - DNA, 1554 bp, Artificial Sequence
  synthesized maize optimized coding region
atggctcacgctagggtgctgttgcttgcgctggcggtgctggcaacagcagccgtggcggtggcgtcaagctccagcttcgcggacagcaacccgattaggcctgtgaccgacagggccgcctcaaccatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 17 - protein, 517 aa, Artificial Sequence
  translated from synthesized maize optimized coding region
MAHARVLLLALAVLATAAVAVASSSSFADSNPIRPVTDRAASTIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 18 - DNA, 1524 bp, Artificial Sequence
  synthesized maize optimized coding region
atgagtagctcaccgtcctttggcctgctggcggttgcggccctgcttctggcgcttagcctggcgcaacacggcatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaacgacgagctgaaggctgaggccaagtga

SEQ ID NO: 19 - protein, 507 aa, Artificial Sequence
  translated from synthesized maize optimized coding region
MSSSPSFGLLAVAALLLALSLAQHGIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNNDELKAEAK

SEQ ID NO: 20 - DNA, 1707 bp, Artificial Sequence
  synthesized maize optimized coding region
atggcgaacaagcacctgagcctgtccctgttcctggtgctgcttggcctgagcgcatccctggcatccggaatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactctaagaccgcagtgcaagccaaggcagcgtgggctgccgtgtggggaatcctgatcgtggtggcagtggtggctgctggcagctacgtggtgtacaagtataggctgaggagctacatggactcagagatcagagcgatcatggcacagtacatgcctctggacaaccaaggtgaggtgccgaaccacacccacgacgaggaccggagctga

SEQ ID NO: 21 - protein, 568 aa, Artificial Sequence
  translated from synthesized maize optimized coding region
MANKHLSLSLFLVLLGLSASLASGIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNNSKTAVQAKAAWAAVWGILIVVAVVAAGSYVVYKYRLRSYMDSEIRAIMAQYMPLDNQGEVPNHTHDEDRS

SEQ ID NO: 22 - DNA, 1497 bp, Artificial Sequence
  synthesized maize optimized coding region
atggcgaacaagcacctgagcctgtccctgttcctggtgctgcttggcctgagcgcatccctggcatccggaatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 23 - protein, 498 aa, Artificial Sequence
  translated from synthesized maize optimized coding region
MANKHLSLSLFLVLLGLSASLASGIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 24 - DNA, 1515 bp, Artificial Sequence
  synthesized maize optimized coding region
atggcgaacaagcacctgagcctgtccctgttcctggtgctgcttggcctgagcgcatccctggcatccggaatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaacagcgagaaggacgagctgtga

SEQ ID NO: 25 - protein, 504 aa, Artificial Sequence
  translated from synthesized maize optimized coding region
MANKHLSLSLFLVLLGLSASLASGIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNNSEKDEL

SEQ ID NO: 26 - DNA, 1488 bp, Artificial Sequence
  synthesized maize optimized coding region
atggcaccgagaaagaggaaggagagcaatagggagtcagcgaggaggagcagatacagaaagatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 27 - protein, 495 aa, Artificial Sequence
  translated from synthesized maize optimized coding region
MAPRKRKESNRESARRSRYRKIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 28 - DNA, 1482 bp, Artificial Sequence
  synthesized maize optimized coding region
atgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaacagaaagaggaaggagagcaatagggagtcagcgaggaggagcagatacagaaagtga

SEQ ID NO: 29 - protein, 493 aa, Artificial Sequence
  translated from synthesized maize optimized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNNRKRKESNRESARRSRYRK

SEQ ID NO: 30 - DNA, 1641 bp, Artificial Sequence
  synthesized maize optimized coding region
atgttggctcgccaaggaggatcactgagagcctctcagtgtaacgctggcctcgcgagacgcgtggaggtgggagcgttggttgttccgagacccataagcgtcaacgacgtggttccccatgtctattcggctcctctgagcgtcgcgaggaggtcgtgctccaagtcatccatccgctcgactcgcagacttcagacaaccgtctgctccatgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 31 - protein, 546 aa, Artificial Sequence
  translated from synthesized maize optimized coding region
MLARQGGSLRASQCNAGLARRVEVGALVVPRPISVNDVVPHVYSAPLSVARRSCSKSSIRSTRRLQTTVCSMIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 32 - DNA, 1626 bp, Artificial Sequence
  synthesized maize optimized coding region
atggctcaatctagcagaatctgccacggtgtgcagaacccatgtgtgatcatttccaatctctccaaatccaaccagaacaaatctcctttctcagtcagcctcaagactcaccagcagcagcgtcgtgcttaccagatatctagctggggattgaagaagtcaaacaacgggtccgtgattcgtccggttaaggcaatgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcgtacagcaccaactcccgtcagaacctgccgatcaacgtgatcagcgacagctgcaactgctccaccaccaacatgaccagcaaccagtactccaacccgaccaccaacatgaccagcaaccagtacatgatctcccacgagtacaccagcctgccgaacaacttcatgctgtcccgcaactctaacctggagtacaagtgcccggagaacaacttcatgatctactggtacaacaactccgactggtacaacaactcagactggtacaacaactga

SEQ ID NO: 33 - protein, 541 aa, Artificial Sequence
  translated from synthesized maize optimized coding region
MAQSSRICHGVQNPCVIISNLSKSNQNKSPFSVSLKTHQQQRRAYQISSWGLKKSNNGSVIRPVKAMIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 34 - DNA, 1428 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttatgcttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 35 - protein, 475 aa, Artificial Sequence
  synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYASDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 36 - DNA, 1428 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattcttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 37 - protein, 475 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYSSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 38 - DNA, 1428 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgagctggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 39 - protein, 475 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARAGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 40 - DNA, 1428 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatctggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 41 - protein, 475 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARSGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKCPENNFMIYWYNNSDWYNNSDWYNN

SEQ ID NO: 42 - DNA, 1428 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaagctcctgaaaataattttatgatatattggtataataattcggattggtataataattcggattggtataataattga

SEQ ID NO: 43 - protein, 475 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKAPENNFMIYWYNNSDWYNNSDWYNN

SEQ ID NO: 44 - DNA, 1428 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatctcctgaaaataattttatgatatattggtataataattcggattggtataataattcggattggtataataattga

SEQ ID NO: 45 - protein, 475 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKSPENNFMIYWYNNSDWYNNSDWYNN

SEQ ID NO: 46 - DNA, 1428 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttatagttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaaagtcctgaaaataattttatgatatattggtataataattcggattggtataataattcggattggtataataattga

SEQ ID NO: 47 - protein, 475 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYSSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKSPENNFMIYWYNNSDWYNNSDWYNN

SEQ ID NO: 48 - DNA, 1428 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttatgcttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaagctcctgaaaataattttatgatatattggtataataattcggattggtataataattcggattggtataataattga

SEQ ID NO: 49 - protein, 475 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYASDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSRNSNLEYKAPENNFMIYWYNNSDWYNNSDWYNN

SEQ ID NO: 50 - protein, 379 aa, Artificial Sequence
  protease generated fragment
HSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSR

SEQ ID NO: 51 - protein, 32 aa, Artificial Sequence
  protease generated fragment
NSNLEYKCPENNFMIYWYNNSDWYNNSDWYNN

SEQ ID NO: 52 - protein, 25 aa, Artificial Sequence
  protease generated fragment
CPENNFMIYWYNNSDWYNNSDWYNN

SEQ ID NO: 53 - DNA, 1332 bp, Artificial Sequence
  synthesized coding region
atgattattgatagtaaaacgactttacctagacattcacttattcatacaattaaattaaattctaataagaaatatggtcctggtgatatgactaatggaaatcaatttattatttcaaaacaagaatgggctacgattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagatag

SEQ ID NO: 54 - protein, 443 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMLSR

SEQ ID NO: 55 - DNA, 1296 bp, Artificial Sequence
  synthesized coding region
atgattattgatagtaaaacgactttacctagacattcacttattcatacaattaaattaaattctaataagaaatatggtcctggtgatatgactaatggaaatcaatttattatttcaaaacaagaatgggctacgattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatag

SEQ ID NO: 56 - protein, 431 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHE

SEQ ID NO: 57 - DNA, 1236 bp, Artificial Sequence
  synthesized coding region
atgattattgatagtaaaacgactttacctagacattcacttattcatacaattaaattaaattctaataagaaatatggtcctggtgatatgactaatggaaatcaatttattatttcaaaacaagaatgggctacgattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcatag

SEQ ID NO: 58 - protein, 411 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTS

SEQ ID NO: 59 - DNA, 1203 bp, Artificial Sequence
  synthesized coding region
atgattattgatagtaaaacgactttacctagacattcacttattcatacaattaaattaaattctaataagaaatatggtcctggtgatatgactaatggaaatcaatttattatttcaaaacaagaatgggctacgattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattag

SEQ ID NO: 60 - protein, 400 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISD

SEQ ID NO: 61 - DNA, 1173 bp, Artificial Sequence
  synthesized coding region
atgattattgatagtaaaacgactttacctagacattcacttattcatacaattaaattaaattctaataagaaatatggtcctggtgatatgactaatggaaatcaatttattatttcaaaacaagaatgggctacgattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagatag

SEQ ID NO: 62 - protein, 390 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSR

SEQ ID NO: 63 - DNA, 1413 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagaaatgttatatcagattcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 64 - protein, 470 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRNVISDSCNCSTTNMTSNQYSNPTTNMTSNQYMISHEYTSLPNNFMLSRNSNLEYKCPENNFMIYWYNNSDWYNNSDWYNN

SEQ ID NO: 65 - DNA, 1413 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgatttcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 66 - protein, 470 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPISCNCSTTNMTSNQYSNPTTNMTSNQYMISHEYTSLPNNFMLSRNSNLEYKCPENNFMIYWYNNSDWYNNSDWYNN

SEQ ID NO: 67 - DNA, 1413 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagatacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 68 - protein, 470 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDTTNMTSNQYSNPTTNMTSNQYMISHEYTSLPNNFMLSRNSNLEYKCPENNFMIYWYNNSDWYNNSDWYNN

SEQ ID NO: 69 - DNA, 1413 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 70 - protein, 470 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSSNQYSNPTTNMTSNQYMISHEYTSLPNNFMLSRNSNLEYKCPENNFMIYWYNNSDWYNNSDWYNN

SEQ ID NO: 71 - DNA, 1413 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacaaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 72 - protein, 470 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTNPTTNMTSNQYMISHEYTSLPNNFMLSRNSNLEYKCPENNFMIYWYNNSDWYNNSDWYNN

SEQ ID NO: 73 - DNA, 1413 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 74 - protein, 470 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSMTSNQYMISHEYTSLPNNFMLSRNSNLEYKCPENNFMIYWYNNSDWYNNSDWYNN

SEQ ID NO: 75 - DNA, 1340 bp, Artificial Sequence
  synthesized coding region
aatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaattatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 76 - protein, 470 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNYMISHEYTSLPNNFMLSRNSNLEYKCPENNFMIYWYNNSDWYNNSDWYNN

SEQ ID NO: 77 - DNA, 1413 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatgaatatacaagtttaccaaataattttatgaatttagaatataaatgtcctgaaaataattttatgatatattggtataataattcggattggtataataattcggattggtataataattga

SEQ ID NO: 78 - protein, 470 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHEYTSLPNNFMNLEYKCPENNFMIYWYNNSDWYNNSDWYNN

SEQ ID NO: 79 - DNA, 1398 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagatcatgtaattgttcaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 80 - protein, 465 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRSCNCSTTNMTSNQYSNPTTNMTSNQYMISHEYTSLPNNFMLSRNSNLEYKCPENNFMIYWYNNSDWYNNSDWYNN

SEQ ID NO: 81 - DNA, 1398 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 82 - protein, 465 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSNQYSNPTTNMTSNQYMISHEYTSLPNNFMLSRNSNLEYKCPENNFMIYWYNNSDWYNNSDWYNN

SEQ ID NO: 83 - DNA, 1398 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacaatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 84 - protein, 465 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTMTSNQYMISHEYTSLPNNFMLSRNSNLEYKCPENNFMIYWYNNSDWYNNSDWYNN

SEQ ID NO: 85 - DNA, 1398 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatgaatatacaagtttaccaaataattttatgttatcaagaaatagtaatttagaatataaatgtcctgaaaataattttatgatatattggtataataattcggattggtataataattcggattggtataataattga

SEQ ID NO: 86 - protein, 465 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNEYTSLPNNFMLSRNSNLEYKCPENNFMIYWYNNSDWYNNSDWYNN

SEQ ID NO: 87 - DNA, 1398 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgatttcacatttatcaagaaatagtaatttagaatataaatgtcctgaaaataattttatgatatattggtataataattcggattggtataataattcggattggtataataattga

SEQ ID NO: 88 - protein, 465 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMISHLSRNSNLEYKCPENNFMIYWYNNSDWYNNSDWYNN

SEQ ID NO: 89 - DNA, 1383 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagaacaacaaatatgacatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 90 - protein, 460 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRTTNMTSNQYSNPTTNMTSNQYMISHEYTSLPNNFMLSRNSNLEYKCPENNFMIYWYNNSDWYNNSDWYNN

SEQ ID NO: 91 - DNA, 1383 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 92 - protein, 460 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSMTSNQYMISHEYTSLPNNFMLSRNSNLEYKCPENNFMIYWYNNSDWYNNSDWYNN

SEQ ID NO: 93 - DNA, 1383 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatccaaataattttatgttatcaagaaatagtaatttagaatataaatgtcctgaaaataattttatgatatattggtataataattcggattggtataataattcggattggtataataattga

SEQ ID NO: 94 - protein, 460 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNPNNFMLSRNSNLEYKCPENNFMIYWYNNSDWYNNSDWYNN

SEQ ID NO: 95 - DNA, 1383 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatcaatatatgattaatagtaatttagaatataaatgtcctgaaaataattttatgatatattggtataataattcggattggtataataattcggattggtataataattga

SEQ ID NO: 96 - protein, 460 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNQYMINSNLEYKCPENNFMIYWYNNSDWYNNSDWYNN

SEQ ID NO: 97 - DNA, 1368 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagatcaaatcaatacagtaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 98 - protein, 455 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRSNQYSNPTTNMTSNQYMISHEYTSLPNNFMLSRNSNLEYKCPENNFMIYWYNNSDWYNNSDWYNN

SEQ ID NO: 99 - DNA, 1368 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacagaatatacaagtttaccaaataattttatgttatcaagaaatagtaatttagaatataaatgtcctgaaaataattttatgatatattggtataataattcggattggtataataattcggattggtataataattga

SEQ ID NO: 100 - protein, 455 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTEYTSLPNNFMLSRNSNLEYKCPENNFMIYWYNNSDWYNNSDWYNN

SEQ ID NO: 101 - DNA, 1368 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaacaaatatgacatcaaatagtaatttagaatataaatgtcctgaaaataattttatgatatattggtataataattcggattggtataataattcggattggtataataattga

SEQ ID NO: 102 - protein, 455 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTTNMTSNSNLEYKCPENNFMIYWYNNSDWYNNSDWYNN

SEQ ID NO: 103 - DNA, 1353 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagaaatccaacaacaaatatgacatcaaatcaatatatgatttcacatgaatatacaagtttaccaaataattttatgttatcaagaaatagtaatttagaatataaatgtcctgaaaataattttatgatatattggtataataattcggattggtataataattcggattggtataataattga

SEQ ID NO: 104 - protein, 450 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRNPTTNMTSNQYMISHEYTSLPNNFMLSRNSNLEYKCPENNFMIYWYNNSDWYNNSDWYNN

SEQ ID NO: 105 - DNA, 1353 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtttatcaagaaatagtaatttagaatataaatgtcctgaaaataattttatgatatattggtataataattcggattggtataataattcggattggtataataattga

SEQ ID NO: 106 - protein, 450 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSLSRNSNLEYKCPENNFMIYWYNNSDWYNNSDWYNN

SEQ ID NO: 107 - DNA, 1353 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagattcatgtaattgttcaacaacaaatatgacatcaaatcaatacagtaatccaacaaatagtaatttagaatataaatgtcctgaaaataattttatgatatattggtataataattcggattggtataataattcggattggtataataattga

SEQ ID NO: 108 - protein, 450 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDSCNCSTTNMTSNQYSNPTNSNLEYKCPENNFMIYWYNNSDWYNNSDWYNN

SEQ ID NO: 109 - DNA, 1299 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagacaaaatttaccgattaatgttatatcagataatagtaatttagaatataaatgtcctgaaaataattttatgatatattggtataataattcggattggtataataattcggattggtataataattga

SEQ ID NO: 110 - protein, 432 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRQNLPINVISDNSNLEYKCPENNFMIYWYNNSDWYNNSDWYNN

SEQ ID NO: 111 - DNA, 1299 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagaagtttaccaaataattttatgttatcaagaaatagtaatttagaatataaatgtcctgaaaataattttatgatatattggtataataattcggattggtataataattcggattggtataataattga

SEQ ID NO: 112 - protein, 432 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRSLPNNFMLSRNSNLEYKCPENNFMIYWYNNSDWYNNSDWYNN

SEQ ID NO: 113 - DNA, 1299 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcaactaatagtagaagtaatccaacaacaaatatgacatcaaataatagtaatttagaatataaatgtcctgaaaataattttatgatatattggtataataattcggattggtataataattcggattggtataataattga

SEQ ID NO: 114 - protein, 432 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSTNSRSNPTTNMTSNNSNLEYKCPENNFMIYWYNNSDWYNNSDWYNN

SEQ ID NO: 115 - DNA, 1251 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcagttgctacaattacatctggtgaaaataattttatgatatattggtataataattcggattggtataataattcggattggtataataattga

SEQ ID NO: 116 - protein, 416 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSVATITSGENNFMIYWYNNSDWYNNSDWYNN

SEQ ID NO: 117 - DNA, 1245 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcagttgctacaattacatctggtgaatttatgatatattggtataataattcggattggtataataattcggattggtataataattga

SEQ ID NO: 118 - protein, 414 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSVATITSGEFMIYWYNNSDWYNNSDWYNN

SEQ ID NO: 119 - DNA, 1245 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttatgctacaattacatctggtgaaaataattttatgatatattggtataataattcggattggtataataattcggattggtataataattga

SEQ ID NO: 120 - protein, 414 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYATITSGENNFMIYWYNNSDWYNNSDWYNN

SEQ ID NO: 121 - DNA, 1233 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaattgggttatatataatgaatttgttatgatatattggtataataattcggattggtataataattcggattggtataataattga

SEQ ID NO: 122 - protein, 410 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNWVIYNEFVMIYWYNNSDWYNNSDWYNN

SEQ ID NO: 123 - DNA, 1251 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttattcatgggttatatataatgaatttgttaataattttatgatatattggtataataattcggattggtataataattcggattggtataataattga

SEQ ID NO: 124 - protein, 416 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSWVIYNEFVNNFMIYWYNNSDWYNNSDWYNN

SEQ ID NO: 125 - DNA, 1239 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatggatgggttatatataatgaatttgttggtatgatatattggtataataattcggattggtataataattcggattggtataataattga

SEQ ID NO: 126 - protein, 412 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNGWVIYNEFVGMIYWYNNSDWYNNSDWYNN

SEQ ID NO: 127 - DNA, 1251 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttatggatgggttatatataatgaatttgttggtaattttatgatatattggtataataattcggattggtataataattcggattggtataataattga

SEQ ID NO: 128 - protein, 416 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYGWVIYNEFVGNFMIYWYNNSDWYNNSDWYNN

SEQ ID NO: 129 - DNA, 1239 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatggagattctagtattaaaaaagatggttttatgatatattggtataataattcggattggtataataattcggattggtataataattga

SEQ ID NO: 130 - protein, 412 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNGDSSIKKDGFMIYWYNNSDWYNNSDWYNN

SEQ ID NO: 131 - DNA, 1251 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttatggagattctagtattaaaaaagatggtaataattttatgatatattggtataataattcggattggtataataattcggattggtataataattga

SEQ ID NO: 132 - protein, 416 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYGDSSIKKDGNNFMIYWYNNSDWYNNSDWYNN

SEQ ID NO: 133 - DNA, 1239 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatggagatcctagtattaaaaaagatggttttatgatatattggtataataattcggattggtataataattcggattggtataataattga

SEQ ID NO: 134 - protein, 412 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNGDPSIKKDGFMIYWYNNSDWYNNSDWYNN

SEQ ID NO: 135 - DNA, 1251 bp, Artificial Sequence
  synthesized coding region
atgattattgattctaaaacaacattaccaagacattctttaattcatactataaaattaaattctaataagaaatatggtcctggtgatatgactaatggaaatcaatttattatttcaaaacaagaatgggctactattggagcatatattcagactggattaggtttaccagtaaatgaacaacaattaagaacacatgttaatttaagtcaggatatatcaatacctagtgatttttctcaattatatgatgtttattgttctgataaaacttcagcagaatggtggaataaaaatttatatcctttaattattaaatctgctaatgatattgcttcatatggttttaaagttgctggtgatccttctattaagaaagatggatattttaaaaaattgcaagatgaattagataatattgttgataataattccgatgatgatgcaatagctaaagctattaaagattttaaagcgcgatgtggtattttaattaaagaagctaaacaatatgaagaagctgcaaaaaatattgtaacatctttagatcaatttttacatggtgatcagaaaaaattagaaggtgttatcaatattcaaaaacgtttaaaagaagttcaaacagctcttaatcaagcccatggggaaagtagtccagctcataaagagttattagaaaaagtaaaaaatttaaaaacaacattagaaaggactattaaagctgaacaagatttagagaaaaaagtagaatatagttttctattaggaccattgttaggatttgttgtttatgaaattcttgaaaatactgctgttcagcatataaaaaatcaaattgatgagataaagaaacaattagattctgctcagcatgatttggatagagatgttaaaattataggaatgttaaatagtattaatacagatattgataatttatatagtcaaggacaagaagcaattaaagttttccaaaagttacaaggtatttgggctactattggagctcaaatagaaaatcttagaacaacgtcgttacaagaagttcaagattctgatgatgctgatgagatacaaattgaacttgaggacgcttctgatgcttggttagttgtggctcaagaagctcgtgattttacactaaatgcttatggagatcctagtattaaaaaagatggtaataattttatgatatattggtataataattcggattggtataataattcggattggtataataattga

SEQ ID NO: 136 - protein, 416 aa, Artificial Sequence
  translated from synthesized coding region
MIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYGDPSIKKDGNNFMIYWYNNSDWYNNSDWYNN

SEQ ID NO: 137 - DNA, 1251 bp, Artificial Sequence
  synthesized maize optimized coding region
atgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggctcaagaggcgagggacttcaccctgaacgcgtacagcgtggccaccatcaccagcggcgagaacaacttcatgatctactggtacaacaactccgactggtacaacaactcagactggtacaacaactga

SEQ ID NO: 138 - protein, 416 aa, Artificial Sequence; identical to SEQ ID NO: 116
  translated from synthesized maize optimized coding region

SEQ ID NO: 139 - DNA, 1449 bp, Artificial Sequence
  synthesized maize optimized coding region
atggctcaatctagcagaatctgccacggtgtgcagaacccatgtgtgatcatttccaatctctccaaatccaaccagaacaaatctcctttctcagtcagcctcaagactcaccagcagcagcgtcgtgcttaccagatatctagctggggattgaagaagtcaaacaacgggtccgtgattcgtccggttaaggcaatgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgaacctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggacaacaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggctcaagaggcgagggacttcaccctgaacgcgtacagcgtggccaccatcaccagcggcgagaacaacttcatgatctactggtacaacaactccgactggtacaacaactcagactggtacaacaactga

SEQ ID NO: 140 - protein, 482 aa, Artificial Sequence
  translated from synthesized maize optimized coding region
MAQSSRICHGVQNPCVIISNLSKSNQNKSPFSVSLKTHQQQRRAYQISSWGLKKSNNGSVIRPVKAMIIDSKTTLPRHSLIHTIKLNSNKKYGPGDMTNGNQFIISKQEWATIGAYIQTGLGLPVNEQQLRTHVNLSQDISIPSDFSQLYDVYCSDKTSAEWWNKNLYPLIIKSANDIASYGFKVAGDPSIKKDGYFKKLQDELDNIVDNNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSVATITSGENNFMIYWYNNSDWYNNSDWYNN

SEQ ID NO: 141 - DNA, 1251 bp, Artificial Sequence
  Maize codon bias version DIG-1036
atgatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgcagctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggaccagaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcctacagcgtggccaccatcaccagcggcgagaacaacttcatgatctactggtatcagaactccgactggtatcagaactcagactggtacaacaactga

SEQ ID NO: 142 - DNA, 1338 bp, Artificial Sequence
  Highest GC+ERLS maize highest GC version of DIG-1036 with ER Localization Sequence
atggcgaacaagcacctgagcctgtccctgttcctggtgctgcttggcctgagcgcatccctggcatccggaatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgcagctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggaccagaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcctacagcgtggccaccatcaccagcggcgagaacaacttcatgatctactggtatcagaactccgactggtatcagaactcagactggtacaacaacagcgagaaggacgagctgtga

SEQ ID NO: 143 - DNA, 1347 bp, Artificial Sequence
  Highest GC+VLS maize highest GC version of DIG-1036 with Vacuole Localization Sequence
atgagtagctcaccgtcctttggcctgctggcggttgcggccctgcttctggcgcttagcctggcgcaacacggcatcattgactccaagaccaccctgccgcgtcacagcctgatccacaccatcaagctgaactccaacaagaagtacggacctggcgacatgaccaacggcaaccagttcatcatctccaagcaagagtgggccaccatcggagcgtacatccagaccggcctgggcctgccggtgaacgagcagcagctgaggactcacgtgcagctgtcccaagacatcagcatcccgtccgacttctcccagctgtacgacgtgtattgcagcgacaagacctccgccgagtggtggaacaagaacctgtacccgctgatcatcaagagcgccaacgacatcgcctcctacggcttcaaggtggcgggcgacccgagcatcaagaaggacggctacttcaagaagctccaagacgagctggacaacatcgtggaccagaactccgacgacgacgccatcgccaaggcgatcaaggacttcaaggcgaggtgcggcatcctgatcaaggaggcgaagcagtacgaggaggcggcgaagaacatcgtgacctccctggaccagttcctgcacggcgaccagaagaagctggagggcgtgatcaacatccagaagaggctgaaggaggtgcagaccgccctgaatcaagcccacggcgagagcagcccggcgcacaaggagctgctggagaaggtgaagaacctcaagaccaccctggagaggaccatcaaggccgagcaagacctggagaagaaggtggagtactccttcctgctgggtccgctgctgggcttcgtggtgtacgagatcctggagaacaccgccgtgcagcacatcaagaatcagatcgacgagatcaagaagcagctggactccgcccagcacgacctggaccgcgacgtgaagatcatcgggatgctgaacagcatcaacaccgacatcgacaacctgtacagccaaggccaagaggccatcaaggtgttccagaagctccaaggcatctgggcgaccatcggcgcgcagatcgagaacctgaggaccaccagcctccaagaggtccaagacagcgacgacgccgacgagatccagatcgagctggaggacgccagcgacgcgtggctggtggtggcccaagaggcgagggacttcaccctgaacgcctacagcgtggccaccatcaccagcggcgagaacaacttcatgatctactggtatcagaactccgactggtatcagaactcagactggtacaacaacgacgagctgaaggctgaggccaagtga

SEQ ID NO: 144 - protein, 416 aa, Artificial Sequence
  The polypeptide encoded by DIG-1036 (DIG-1000 minus glycosylation sites: N69>Q; N144>Q; N403>Q; N409>Q)
MIIDSKTTLPRHSLIHTIKLNSNKKYGPGDMTNGNQFIISKQEWATIGAYIQTGLGLPVNEQQLRTHVQLSQDISIPSDFSQLYDVYCSDKTSAEWWNKNLYPLIIKSANDIASYGFKVAGDPSIKKDGYFKKLQDELDNIVDQNSDDDAIAKAIKDFKARCGILIKEAKQYEEAAKNIVTSLDQFLHGDQKKLEGVINIQKRLKEVQTALNQAHGESSPAHKELLEKVKNLKTTLERTIKAEQDLEKKVEYSFLLGPLLGFVVYEILENTAVQHIKNQIDEIKKQLDSAQHDLDRDVKIIGMLNSINTDIDNLYSQGQEAIKVFQKLQGIWATIGAQIENLRTTSLQEVQDSDDADEIQIELEDASDAWLVVAQEARDFTLNAYSVATITSGENNFMIYWYQNSDWYQNSDWYNN